(19) United States
(12) Patent Application Publication
(10) Pub. No.: US 2026/0128828 A1
(43) Pub. Date: May 7, 2026

(54) NON-PRIMARY CHANNEL ACCESS COORDINATION

(71) Applicant: QUALCOMM Incorporated, San Diego, CA (US)

(72) Inventors: Gaurang NAIK, San Diego, CA (US); Naveen Kumar KAKANI, Flower Mound, TX (US); Jinsung LEE, San Jose, CA (US); Abhishek Pramod PATIL, San Diego, CA (US); George CHERIAN, San Diego, CA (US); Srinivas KATAR, Fremont, CA (US); Alfred ASTERJADHI, San Diego, CA (US); Sai Yiu Duncan HO, San Diego, CA (US); Sherief HELWA, San Diego, CA (US); Giovanni CHISCI, San Diego, CA (US); Sanket Sanjay KALAMKAR, San Diego, CA (US)

(21) Appl. No.: 19/371,463

(22) Filed: Oct. 28, 2025

Related U.S. Application Data
(60) Provisional application No. 63/717,223, filed on Nov. 6, 2024.
(60) Provisional application No. 63/722,992, filed on Nov. 20, 2024.

(51) Int. Cl. H04L 5/00; H04W 72/0446

(52) U.S. Cl. CPC H04L 5/0044; H04W 72/0446

(57) ABSTRACT

This disclosure provides methods, components, devices and systems for non-primary channel access (NPCA) coordination. Some aspects more specifically relate to coordination between one or more wireless communication devices regarding switching between a primary channel and a non-primary channel. After switching to a non-primary channel, a wireless communication device may implement one or more NPCA coordination techniques to improve communications via the non-primary and primary channels. A first wireless communication device may transmit or broadcast, via the non-primary channel, a frame indicating one or more NPCA parameters, which may include a duration parameter, a bandwidth parameter, and other NPCA parameters. A second wireless communication device may ignore the frame, respond using the NPCA parameters, or negotiate allowed NPCA parameters. The first wireless communication device may communicate with one or more other wireless communication devices via the non-primary channel based on the one or more NPCA parameters.

### CROSS REFERENCES

The present Application for Patent claims the benefit of U.S. Provisional Ser. No. 63/722,992 by NAIK et al., entitled “NON-PRIMARY CHANNEL ACCESS COORDINATION”filed Nov. 20, 2024, and U.S. Provisional Ser. No. 63/717,223 by NAIK et al., entitled “NON-PRIMARY CHANNEL ACCESS COORDINATION” filed Nov. 6, 2024, each of which is assigned to the assignee hereof, and each of which is expressly incorporated by reference in its entirety herein.

### TECHNICAL FIELD

This disclosure relates generally to wireless communication and, more specifically, to non-primary channel access (NPCA) coordination.

### DESCRIPTION OF THE RELATED TECHNOLOGY

Wireless communication networks may include various types of wireless communication devices including network entities (such as wireless access points (AP) or base stations (BS)), client devices (such as wireless stations (STAs) or user equipment (UEs)), and other wireless nodes. These wireless communication devices may communicate with one another via a variety of technologies and wireless communication protocols, including wireless local area network (WLAN) or Wi-Fi-based protocols or cellular (such as 4G, 5G, or 6G)-based protocols. The wireless communication networks may be capable of supporting communication with multiple users by sharing the available system resources (such as time, frequency, and spatial resources). To enable features or provide improved performance, the wireless communication devices may employ technologies such as orthogonal frequency divisional multiple access (OFDMA), multi-user Multiple-Input Multiple-Output (MU-MIMO), spatial multiplexing, and beamforming. For greater inter-operability, the wireless communication networks may support backwards compatibility (such as supporting legacy wireless communication devices) as well as forward compatibility (such as supporting communication with wireless communication devices compatible with next-generation wireless communication standards).

Some wireless communication networks may include multiple channels for communications between wireless communication devices. For example, a wireless communication system may include a primary channel and one or more non-primary channels. In some examples, if a first wireless communication device detects that the primary channel is busy for a duration, the first wireless communication device may switch to a non-primary channel for the duration, attempt to communication with a second wireless communication device via the non-primary channel, and switch back to the primary channel after the duration. In some examples, however, the detection of whether a primary channel is busy may not be consistent for both the first wireless communication device and the second wireless communication device. For example, different wireless communication devices may detect different durations in which the primary channel is busy, or one wireless communication device may detect that the primary channel is busy while another wireless communication device may not detect that the primary channel is busy.

### SUMMARY

The systems, methods, and devices of this disclosure each have several innovative aspects, no single one of which is solely responsible for the desirable attributes disclosed herein.

One innovative aspect of the subject matter described in this disclosure can be implemented in a first wireless communication device. The first wireless communication device may include a processing system that includes processor circuitry and memory circuitry that stores code. The processing system may be configured to cause the first wireless communication device to switch operation of the first wireless communication device from a first channel to a second channel in response to detection of one or more PPDUs via the first channel, the first wireless communication device being associated with a first BSS, the one or more PPDUs being associated with a second BSS different than the first BSS, transmit, via the second channel and after the operation of the first wireless communication device is switched from the first channel to the second channel, an indication that the first wireless communication device will switch from the second channel to the first channel, and switch the operation of the first wireless communication device from the second channel to the first channel in accordance with the indication.

In some examples of the method, first wireless communication devices, and non-transitory computer-readable medium described herein, the indication may be included in a non-primary channel access (NPCA) announcement frame.

Some examples of the method, first wireless communication devices, and non-transitory computer-readable medium described herein may further include operations, features, means, or instructions for transmitting, while operating via the second channel, one or more frames to a second wireless communication device, where at least one frame of the one or more frames includes the indication.

Another innovative aspect of the subject matter described in this disclosure can be implemented in a method for wireless communication by a first wireless communication device. The method may include switching operation of the first wireless communication device from a first channel to a second channel in response to detection of one or more physical layer (PHY) protocol data units (PPDUs) via the first channel, the first wireless communication device being associated with a first basic service set (BSS), the one or more PPDUs being associated with a second BSS different than the first BSS, transmitting, via the second channel and after the operation of the first wireless communication device is switched from the first channel to the second channel, an indication that the first wireless communication device will switch from the second channel to the first channel, and switching the operation of the first wireless communication device from the second channel to the first channel in accordance with the indication.

Another innovative aspect of the subject matter described in this disclosure can be implemented in a first wireless communication device for wireless communication. The first wireless communication device may include means for switching operation of the first wireless communication device from a first channel to a second channel in response to detection of one or more PPDUs via the first channel, the first wireless communication device being associated with a first BSS, the one or more PPDUs being associated with a second BSS different than the first BSS, means for transmitting, via the second channel and after the operation of the first wireless communication device is switched from the first channel to the second channel, an indication that the first wireless communication device will switch from the second channel to the first channel, and means for switching the operation of the first wireless communication device from the second channel to the first channel in accordance with the indication.

Another innovative aspect of the subject matter described in this disclosure can be implemented in a non-transitory computer-readable medium storing code for wireless communication. The code may include instructions executable by one or more processors to switch operation of the first wireless communication device from a first channel to a second channel in response to detection of one or more PPDUs via the first channel, the first wireless communication device being associated with a first BSS, the one or more PPDUs being associated with a second BSS different than the first BSS, transmit, via the second channel and after the operation of the first wireless communication device is switched from the first channel to the second channel, an indication that the first wireless communication device will switch from the second channel to the first channel, and switch the operation of the first wireless communication device from the second channel to the first channel in accordance with the indication.

Another innovative aspect of the subject matter described in this disclosure can be implemented in a second wireless communication device for wireless communication. The second wireless communication device may include a processing system that includes processor circuitry and memory circuitry that stores code. The processing system may be configured to cause the second wireless communication device to switch operation of the second wireless communication device from a first channel to a second channel in response to detection of one or more PPDUs via the first channel, the second wireless communication device being associated with a first BSS, the one or more PPDUs being associated with a second BSS different than the first BSS, receive, via the second channel and from a first wireless communication device, an indication that the first wireless communication device will switch from the second channel to the first channel, and switch the operation of the second wireless communication device from the second channel to the first channel in accordance with the indication.

Some examples of the method, second wireless communication devices, and non-transitory computer-readable medium described herein may further include operations, features, means, or instructions for receiving one or more messages from the first wireless communication device via the second channel, where the second wireless communication device maintains the operation via the second channel at least until the indication may be received and in accordance with receiving the one or more messages.

In some examples of the method, second wireless communication devices, and non-transitory computer-readable medium described herein, the one or more messages may be intended for the second wireless communication device, intended for a third wireless communication device of the first BSS, or both.

Some examples of the method, second wireless communication devices, and non-transitory computer-readable medium described herein may further include operations, features, means, or instructions for transmitting a message including a response to the indication and switching the operation of the second wireless communication device from the second channel to the first channel in accordance with a duration starting at an end of the message.

Another innovative aspect of the subject matter described in this disclosure can be implemented in a method for wireless communication by a second wireless communication device. The method may include switching operation of the second wireless communication device from a first channel to a second channel in response to detection of one or more PPDUs via the first channel, the second wireless communication device being associated with a first BSS, the one or more PPDUs being associated with a second BSS different than the first BSS, receiving, via the second channel and from a first wireless communication device, an indication that the first wireless communication device will switch from the second channel to the first channel, and switching the operation of the second wireless communication device from the second channel to the first channel in accordance with the indication.

Another innovative aspect of the subject matter described in this disclosure can be implemented in a second wireless communication device for wireless communication. The second wireless communication device may include means for switching operation of the second wireless communication device from a first channel to a second channel in response to detection of one or more PPDUs via the first channel, the second wireless communication device being associated with a first BSS, the one or more PPDUs being associated with a second BSS different than the first BSS, means for receiving, via the second channel and from a first wireless communication device, an indication that the first wireless communication device will switch from the second channel to the first channel, and means for switching the operation of the second wireless communication device from the second channel to the first channel in accordance with the indication.

Another innovative aspect of the subject matter described in this disclosure can be implemented in a non-transitory computer-readable medium storing code for wireless communication. The code may include instructions executable by one or more processors to switch operation of the second wireless communication device from a first channel to a second channel in response to detection of one or more PPDUs via the first channel, the second wireless communication device being associated with a first BSS, the one or more PPDUs being associated with a second BSS different than the first BSS, receive, via the second channel and from a first wireless communication device, an indication that the first wireless communication device will switch from the second channel to the first channel, and switch the operation of the second wireless communication device from the second channel to the first channel in accordance with the indication.

Another innovative aspect of the subject matter described in this disclosure can be implemented in a first wireless communication device for wireless communication. The first wireless communication device may include a processing system that includes processor circuitry and memory circuitry that stores code. The processing system may be configured to cause the first wireless communication device to switch operation of the first wireless communication device from a first channel to a second channel in response to detection of one or more PPDUs via the first channel, the first wireless communication device being associated with a first BSS, the one or more PPDUs being associated with a second BSS different than the first BSS, transmit, via the second channel and after the operation of the first wireless communication device is switched from the first channel to the second channel, one or more frames indicating a time at which the first wireless communication device will switch from the second channel to the first channel, and switch the operation of the first wireless communication device from the second channel to the first channel in accordance with the time indicated by the one or more frames.

In some examples of the method, first wireless communication devices, and non-transitory computer-readable medium described herein, the one or more frames include an initial control frame or an initial control response transmitted via the second channel.

In some examples of the method, first wireless communication devices, and non-transitory computer-readable medium described herein, the one or more frames include each frame transmitted by the first wireless communication device via the second channel after the operation of the first wireless communication device is switched from the first channel to the second channel.

In some examples of the method, first wireless communication devices, and non-transitory computer-readable medium described herein, the one or more frames each indicate the time via a value associated with a time synchronization function.

In some examples of the method, first wireless communication devices, and non-transitory computer-readable medium described herein, the one or more frames each indicate the time as a remaining quantity of time from an end of a PPDU transmitted via the second channel in accordance with the operation of the first wireless communication device being switched from the first channel to the second channel.

Another innovative aspect of the subject matter described in this disclosure can be implemented in a method for wireless communication by a first wireless communication device. The method may include switching operation of the first wireless communication device from a first channel to a second channel in response to detection of one or more PPDUs via the first channel, the first wireless communication device being associated with a first BSS, the one or more PPDUs being associated with a second BSS different than the first BSS, transmitting, via the second channel and after the operation of the first wireless communication device is switched from the first channel to the second channel, one or more frames indicating a time at which the first wireless communication device will switch from the second channel to the first channel, and switching the operation of the first wireless communication device from the second channel to the first channel in accordance with the time indicated by the one or more frames.

Another innovative aspect of the subject matter described in this disclosure can be implemented in a first wireless communication device for wireless communication. The first wireless communication device may include means for switching operation of the first wireless communication device from a first channel to a second channel in response to detection of one or more PPDUs via the first channel, the first wireless communication device being associated with a first BSS, the one or more PPDUs being associated with a second BSS different than the first BSS, means for transmitting, via the second channel and after the operation of the first wireless communication device is switched from the first channel to the second channel, one or more frames indicating a time at which the first wireless communication device will switch from the second channel to the first channel, and means for switching the operation of the first wireless communication device from the second channel to the first channel in accordance with the time indicated by the one or more frames.

Another innovative aspect of the subject matter described in this disclosure can be implemented in a non-transitory computer-readable medium storing code for wireless communication. The code may include instructions executable by one or more processors to switch operation of the first wireless communication device from a first channel to a second channel in response to detection of one or more PPDUs via the first channel, the first wireless communication device being associated with a first BSS, the one or more PPDUs being associated with a second BSS different than the first BSS, transmit, via the second channel and after the operation of the first wireless communication device is switched from the first channel to the second channel, one or more frames indicating a time at which the first wireless communication device will switch from the second channel to the first channel, and switch the operation of the first wireless communication device from the second channel to the first channel in accordance with the time indicated by the one or more frames.

Another innovative aspect of the subject matter described in this disclosure can be implemented in a second wireless communication device for wireless communication. The second wireless communication device may include a processing system that includes processor circuitry and memory circuitry that stores code. The processing system may be configured to cause the second wireless communication device to switch operation of the second wireless communication device from a first channel to a second channel in response to detection of one or more PPDUs via the first channel, the second wireless communication device being associated with a first BSS, the one or more PPDUs being associated with a second BSS different than the first BSS, receive, via the second channel and from a first wireless communication device, one or more frames indicating a time at which the first wireless communication device will switch from the second channel to the first channel, and switch the operation of the second wireless communication device from the second channel to the first channel in accordance with the time indicated by the one or more frames.

In some examples of the method, second wireless communication devices, and non-transitory computer-readable medium described herein, the one or more frames include an initial control frame or an initial control response received via the second channel.

In some examples of the method, second wireless communication devices, and non-transitory computer-readable medium described herein, the one or more frames include each frame received from the first wireless communication device via the second channel after the operation of the second wireless communication device is switched from the first channel to the second channel.

In some examples of the method, second wireless communication devices, and non-transitory computer-readable medium described herein, the one or more frames each indicate the time via a value associated with a time synchronization function.

In some examples of the method, second wireless communication devices, and non-transitory computer-readable medium described herein, the one or more frames each indicate the time as a remaining quantity of time from an end of a PPDU received via the second channel in accordance with the operation of the second wireless communication device being switched from the first channel to the second channel.

Another innovative aspect of the subject matter described in this disclosure can be implemented in a method for wireless communication by a second wireless communication device. The method may include switching operation of the second wireless communication device from a first channel to a second channel in response to detection of one or more PPDUs via the first channel, the second wireless communication device being associated with a first BSS, the one or more PPDUs being associated with a second BSS different than the first BSS, receiving, via the second channel and from a first wireless communication device, one or more frames indicating a time at which the first wireless communication device will switch from the second channel to the first channel, and switching the operation of the second wireless communication device from the second channel to the first channel in accordance with the time indicated by the one or more frames.

Another innovative aspect of the subject matter described in this disclosure can be implemented in a second wireless communication device for wireless communication. The second wireless communication device may include means for switching operation of the second wireless communication device from a first channel to a second channel in response to detection of one or more PPDUs via the first channel, the second wireless communication device being associated with a first BSS, the one or more PPDUs being associated with a second BSS different than the first BSS, means for receiving, via the second channel and from a first wireless communication device, one or more frames indicating a time at which the first wireless communication device will switch from the second channel to the first channel, and means for switching the operation of the second wireless communication device from the second channel to the first channel in accordance with the time indicated by the one or more frames.

Another innovative aspect of the subject matter described in this disclosure can be implemented in a non-transitory computer-readable medium storing code for wireless communication. The code may include instructions executable by one or more processors to switch operation of the second wireless communication device from a first channel to a second channel in response to detection of one or more PPDUs via the first channel, the second wireless communication device being associated with a first BSS, the one or more PPDUs being associated with a second BSS different than the first BSS, receive, via the second channel and from a first wireless communication device, one or more frames indicating a time at which the first wireless communication device will switch from the second channel to the first channel, and switch the operation of the second wireless communication device from the second channel to the first channel in accordance with the time indicated by the one or more frames.

Another innovative aspect of the subject matter described in this disclosure can be implemented in a first wireless communication device for wireless communication. The first wireless communication device may include a processing system that includes processor circuitry and memory circuitry that stores code. The processing system may be configured to cause the first wireless communication device to switch operation of the first wireless communication device from a first channel to a second channel in response to detection of one or more PPDUs via the first channel, the first wireless communication device being associated with a first BSS, the one or more PPDUs being associated with a second BSS different than the first BSS, transmit, to a second wireless communication device via the second channel and in accordance with a threshold quantity of attempts, one or more NPCA control frames that each indicate a transmission opportunity associated with the second channel, and switch the operation of the first wireless communication device from the second channel to the first channel in accordance with an absence of a response to the one or more NPCA control frames and in accordance with a quantity of the one or more NPCA control frames satisfying the threshold quantity of attempts.

In some examples of the method, first wireless communication devices, and non-transitory computer-readable medium described herein, the one or more NPCA control frames include a first NPCA control frame and the method, apparatuses, and non-transitory computer-readable medium may include further operations, features, means, or instructions for increasing a contention window associated with a second NPCA control frame of the one or more NPCA control frames in accordance with an absence of a response to the first NPCA control frame and transmitting the second NPCA control frame in accordance with the contention window being increased.

Some examples of the method, first wireless communication devices, and non-transitory computer-readable medium described herein may further include operations, features, means, or instructions for transmitting, to a third wireless communication device via the second channel and in accordance with a second threshold quantity of attempts, one or more additional NPCA control frames that each indicate a second transmission opportunity associated with the second channel, where the operation of the first wireless communication device may be switched from the second channel to the first channel further in accordance with an absence of a response to the one or more additional NPCA control frames and in accordance with a quantity of the one or more additional NPCA control frames satisfying the second threshold quantity of attempts.

Another innovative aspect of the subject matter described in this disclosure can be implemented in a method for wireless communication by a first wireless communication device. The method may include switching operation of the first wireless communication device from a first channel to a second channel in response to detection of one or more PPDUs via the first channel, the first wireless communication device being associated with a first BSS, the one or more PPDUs being associated with a second BSS different than the first BSS, transmitting, to a second wireless communication device via the second channel and in accordance with a threshold quantity of attempts, one or more NPCA control frames that each indicate a transmission opportunity associated with the second channel, and switching the operation of the first wireless communication device from the second channel to the first channel in accordance with an absence of a response to the one or more NPCA control frames and in accordance with a quantity of the one or more NPCA control frames satisfying the threshold quantity of attempts.

Another innovative aspect of the subject matter described in this disclosure can be implemented in a first wireless communication device for wireless communication. The first wireless communication device may include means for switching operation of the first wireless communication device from a first channel to a second channel in response to detection of one or more PPDUs via the first channel, the first wireless communication device being associated with a first BSS, the one or more PPDUs being associated with a second BSS different than the first BSS, means for transmitting, to a second wireless communication device via the second channel and in accordance with a threshold quantity of attempts, one or more NPCA control frames that each indicate a transmission opportunity associated with the second channel, and means for switching the operation of the first wireless communication device from the second channel to the first channel in accordance with an absence of a response to the one or more NPCA control frames and in accordance with a quantity of the one or more NPCA control frames satisfying the threshold quantity of attempts.

Another innovative aspect of the subject matter described in this disclosure can be implemented in a non-transitory computer-readable medium storing code for wireless communication. The code may include instructions executable by one or more processors to switch operation of the first wireless communication device from a first channel to a second channel in response to detection of one or more PPDUs via the first channel, the first wireless communication device being associated with a first BSS, the one or more PPDUs being associated with a second BSS different than the first BSS, transmit, to a second wireless communication device via the second channel and in accordance with a threshold quantity of attempts, one or more NPCA control frames that each indicate a transmission opportunity associated with the second channel, and switch the operation of the first wireless communication device from the second channel to the first channel in accordance with an absence of a response to the one or more NPCA control frames and in accordance with a quantity of the one or more NPCA control frames satisfying the threshold quantity of attempts.

Another innovative aspect of the subject matter described in this disclosure can be implemented in a first wireless communication device for wireless communication. The first wireless communication device may include a processing system that includes processor circuitry and memory circuitry that stores code. The processing system may be configured to cause the first wireless communication device to switch operation of the first wireless communication device from a first channel to a second channel in response to a detection of one or more PPDUs via the first channel, the first wireless communication device being associated with a first BSS, the one or more PPDUs being associated with a second BSS different than the first BSS, transmit, to a second wireless communication device via the second channel and in accordance with a timer, one or more NPCA control frames that each indicate a transmission opportunity associated with the second channel, and switch the operation of the first wireless communication device from the second channel to the first channel in response to an expiration of the timer and in accordance with an absence of a response to the one or more NPCA control frames before the expiration of the timer.

In some examples of the method, first wireless communication devices, and non-transitory computer-readable medium described herein, the one or more NPCA control frames may be further transmitted in accordance with a threshold quantity of attempts while the timer may be running and the operation of the first wireless communication device may be switched from the second channel to the first channel further in accordance with a quantity of the one or more NPCA control frames satisfying the threshold quantity of attempts.

In some examples of the method, first wireless communication devices, and non-transitory computer-readable medium described herein, the operation of the first wireless communication device may be switched from the second channel to the first channel further in accordance with an absence of receiving a non-primary channel access control frame from a third wireless communication device.

Another innovative aspect of the subject matter described in this disclosure can be implemented in a method for wireless communication by a first wireless communication device. The method may include switching operation of the first wireless communication device from a first channel to a second channel in response to a detection of one or more PPDUs via the first channel, the first wireless communication device being associated with a first BSS, the one or more PPDUs being associated with a second BSS different than the first BSS, transmitting, to a second wireless communication device via the second channel and in accordance with a timer, one or more NPCA control frames that each indicate a transmission opportunity associated with the second channel, and switching the operation of the first wireless communication device from the second channel to the first channel in response to an expiration of the timer and in accordance with an absence of a response to the one or more NPCA control frames before the expiration of the timer.

Another innovative aspect of the subject matter described in this disclosure can be implemented in a first wireless communication device for wireless communication. The first wireless communication device may include means for switching operation of the first wireless communication device from a first channel to a second channel in response to a detection of one or more PPDUs via the first channel, the first wireless communication device being associated with a first BSS, the one or more PPDUs being associated with a second BSS different than the first BSS, means for transmitting, to a second wireless communication device via the second channel and in accordance with a timer, one or more NPCA control frames that each indicate a transmission opportunity associated with the second channel, and means for switching the operation of the first wireless communication device from the second channel to the first channel in response to an expiration of the timer and in accordance with an absence of a response to the one or more NPCA control frames before the expiration of the timer.

Another innovative aspect of the subject matter described in this disclosure can be implemented in a non-transitory computer-readable medium storing code for wireless communication. The code may include instructions executable by one or more processors to switch operation of the first wireless communication device from a first channel to a second channel in response to a detection of one or more PPDUs via the first channel, the first wireless communication device being associated with a first BSS, the one or more PPDUs being associated with a second BSS different than the first BSS, transmit, to a second wireless communication device via the second channel and in accordance with a timer, one or more NPCA control frames that each indicate a transmission opportunity associated with the second channel, and switch the operation of the first wireless communication device from the second channel to the first channel in response to an expiration of the timer and in accordance with an absence of a response to the one or more NPCA control frames before the expiration of the timer.

Another innovative aspect of the subject matter described in this disclosure can be implemented in a first wireless communication device for wireless communication. The first wireless communication device may include a processing system that includes processor circuitry and memory circuitry that stores code. The processing system may be configured to cause the first wireless communication device to switch operation of the first wireless communication device from a first channel to a second channel in response to detection of a first set of one or more PPDUs via the first channel, the first wireless communication device being associated with a first BSS, the first set of one or more PPDUs associated with a second BSS different than the first BSS, detect, via the second channel, a second set of one or more PPDUs from a second wireless communication device of a third BSS different than the first BSS and the second BSS, the second set of one or more PPDUs indicating a second NAV associated with the second set of one or more PPDUs that extends past an expiration of a first NAV associated with the first set of one or more PPDUs, and switch the operation of the first wireless communication device from the second channel to the first channel prior to the expiration of the first NAV in accordance with the second NAV extending past the expiration of the first NAV.

Some examples of the method, first wireless communication devices, and non-transitory computer-readable medium described herein may further include operations, features, means, or instructions for entering a power saving mode until the expiration of the first NAV in accordance with the second NAV extending past the expiration of the first NAV.

Some examples of the method, first wireless communication devices, and non-transitory computer-readable medium described herein may further include operations, features, means, or instructions for transmitting a capability report indicating a capability of the first wireless communication device to switch the operation of the first wireless communication device from the second channel to the first channel in accordance with the second NAV associated with the second set of one or more PPDUs.

Some examples of the method, first wireless communication devices, and non-transitory computer-readable medium described herein may further include operations, features, means, or instructions for receiving a control message indicating an activation of switching the operation of the first wireless communication device in accordance with the second NAV, where the operation of the first wireless communication device may be switched from the second channel to the first channel in accordance with the control message.

Another innovative aspect of the subject matter described in this disclosure can be implemented in a method for wireless communication by a first wireless communication device. The method may include switching operation of the first wireless communication device from a first channel to a second channel in response to detection of a first set of one or more PPDUs via the first channel, the first wireless communication device being associated with a first BSS, the first set of one or more PPDUs associated with a second BSS different than the first BSS, detecting, via the second channel, a second set of one or more PPDUs from a second wireless communication device of a third BSS different than the first BSS and the second BSS, the second set of one or more PPDUs indicating a second NAV associated with the second set of one or more PPDUs that extends past an expiration of a first NAV associated with the first set of one or more PPDUs, and switching the operation of the first wireless communication device from the second channel to the first channel prior to the expiration of the first NAV in accordance with the second NAV extending past the expiration of the first NAV.

Another innovative aspect of the subject matter described in this disclosure can be implemented in a first wireless communication device for wireless communication. The first wireless communication device may include means for switching operation of the first wireless communication device from a first channel to a second channel in response to detection of a first set of one or more PPDUs via the first channel, the first wireless communication device being associated with a first BSS, the first set of one or more PPDUs associated with a second BSS different than the first BSS, means for detecting, via the second channel, a second set of one or more PPDUs from a second wireless communication device of a third BSS different than the first BSS and the second BSS, the second set of one or more PPDUs indicating a second NAV associated with the second set of one or more PPDUs that extends past an expiration of a first NAV associated with the first set of one or more PPDUs, and means for switching the operation of the first wireless communication device from the second channel to the first channel prior to the expiration of the first NAV in accordance with the second NAV extending past the expiration of the first NAV.

Another innovative aspect of the subject matter described in this disclosure can be implemented in a non-transitory computer-readable medium storing code for wireless communication. The code may include instructions executable by one or more processors to switch operation of the first wireless communication device from a first channel to a second channel in response to detection of a first set of one or more PPDUs via the first channel, the first wireless communication device being associated with a first BSS, the first set of one or more PPDUs associated with a second BSS different than the first BSS, detect, via the second channel, a second set of one or more PPDUs from a second wireless communication device of a third BSS different than the first BSS and the second BSS, the second set of one or more PPDUs indicating a second NAV associated with the second set of one or more PPDUs that extends past an expiration of a first NAV associated with the first set of one or more PPDUs, and switch the operation of the first wireless communication device from the second channel to the first channel prior to the expiration of the first NAV in accordance with the second NAV extending past the expiration of the first NAV.

Another innovative aspect of the subject matter described in this disclosure can be implemented in a first wireless communication device for wireless communication. The first wireless communication device may include a processing system that includes processor circuitry and memory circuitry that stores code. The processing system may be configured to cause the first wireless communication device to switch operation of the first wireless communication device from a first channel to a second channel in response to detection of one or more PPDUs via the first channel, the first wireless communication device being associated with a first BSS, the one or more PPDUs being associated with a second BSS different than the first BSS and broadcast, via the second channel and after the operation of the first wireless communication device is switched from the first channel to the second channel, a frame indicating one or more parameters associated with the first channel or associated with communication via the second channel, or both.

Some examples of the method, first wireless communication devices, and non-transitory computer-readable medium described herein may further include operations, features, means, or instructions for transmitting, while operating via the second channel, one or more frames to a second wireless communication device in accordance with the one or more parameters, where the one or more frames may be transmitted within a duration parameter of the one or more parameters and occupy a bandwidth that may be less than a bandwidth parameter of the one or more parameters.

Some examples of the method, first wireless communication devices, and non-transitory computer-readable medium described herein may further include operations, features, means, or instructions for receiving, while operating via the second channel, one or more frames from at least one wireless communication device, where each frame of the one or more frames may be received in accordance with a bandwidth parameter of the one or more parameters, and where the one or more frames may be received within a duration parameter of the one or more parameters.

Another innovative aspect of the subject matter described in this disclosure can be implemented in a method for wireless communication by a first wireless communication device. The method may include switching operation of the first wireless communication device from a first channel to a second channel in response to detection of one or more PPDUs via the first channel, the first wireless communication device being associated with a first BSS, the one or more PPDUs being associated with a second BSS different than the first BSS and broadcasting, via the second channel and after the operation of the first wireless communication device is switched from the first channel to the second channel, a frame indicating one or more parameters associated with the first channel or associated with communication via the second channel, or both.

Another innovative aspect of the subject matter described in this disclosure can be implemented in a first wireless communication device for wireless communication. The first wireless communication device may include means for switching operation of the first wireless communication device from a first channel to a second channel in response to detection of one or more PPDUs via the first channel, the first wireless communication device being associated with a first BSS, the one or more PPDUs being associated with a second BSS different than the first BSS and means for broadcasting, via the second channel and after the operation of the first wireless communication device is switched from the first channel to the second channel, a frame indicating one or more parameters associated with the first channel or associated with communication via the second channel, or both.

Another innovative aspect of the subject matter described in this disclosure can be implemented in a non-transitory computer-readable medium storing code for wireless communication. The code may include instructions executable by one or more processors to switch operation of the first wireless communication device from a first channel to a second channel in response to detection of one or more PPDUs via the first channel, the first wireless communication device being associated with a first BSS, the one or more PPDUs being associated with a second BSS different than the first BSS and broadcast, via the second channel and after the operation of the first wireless communication device is switched from the first channel to the second channel, a frame indicating one or more parameters associated with the first channel or associated with communication via the second channel, or both.

Another innovative aspect of the subject matter described in this disclosure can be implemented in a second wireless communication device for wireless communication. The second wireless communication device may include a processing system that includes processor circuitry and memory circuitry that stores code. The processing system may be configured to cause the second wireless communication device to switch operation of the second wireless communication device from a first channel to a second channel in response to detection of one or more PPDUs via the first channel, the second wireless communication device being associated with a first BSS, the one or more PPDUs being associated with a second BSS different than the first BSS and receive, via the second channel and from a first wireless communication device, a broadcast frame indicating one or more parameters associated with the first channel or associated with communication via the second channel, or both.

Some examples of the method, second wireless communication devices, and non-transitory computer-readable medium described herein may further include operations, features, means, or instructions for transmitting, while operating via the second channel, one or more frames to the first wireless communication device, where each frame of the one or more frames may be transmitted in accordance with the one or more parameters, and where the one or more frames may be transmitted within a duration parameter of the one or more parameters and occupy a bandwidth that may be less than a bandwidth parameter of the one or more parameters.

Some examples of the method, second wireless communication devices, and non-transitory computer-readable medium described herein may further include operations, features, means, or instructions for transmitting an ICF to the first wireless communication device via the second channel, where the ICF may be transmitted after a first ICF may be received from the first wireless communication device or after a timer expires, where the ICF includes an indication of one or more requested parameters for communication via the second channel.

Another innovative aspect of the subject matter described in this disclosure can be implemented in a method for wireless communication by a second wireless communication device. The method may include switching operation of the second wireless communication device from a first channel to a second channel in response to detection of one or more PPDUs via the first channel, the second wireless communication device being associated with a first BSS, the one or more PPDUs being associated with a second BSS different than the first BSS and receiving, via the second channel and from a first wireless communication device, a broadcast frame indicating one or more parameters associated with the first channel or associated with communication via the second channel, or both.

Another innovative aspect of the subject matter described in this disclosure can be implemented in a second wireless communication device for wireless communication. The second wireless communication device may include means for switching operation of the second wireless communication device from a first channel to a second channel in response to detection of one or more PPDUs via the first channel, the second wireless communication device being associated with a first BSS, the one or more PPDUs being associated with a second BSS different than the first BSS and means for receiving, via the second channel and from a first wireless communication device, a broadcast frame indicating one or more parameters associated with the first channel or associated with communication via the second channel, or both.

Another innovative aspect of the subject matter described in this disclosure can be implemented in a non-transitory computer-readable medium storing code for wireless communication. The code may include instructions executable by one or more processors to switch operation of the second wireless communication device from a first channel to a second channel in response to detection of one or more PPDUs via the first channel, the second wireless communication device being associated with a first BSS, the one or more PPDUs being associated with a second BSS different than the first BSS and receive, via the second channel and from a first wireless communication device, a broadcast frame indicating one or more parameters associated with the first channel or associated with communication via the second channel, or both.

Another innovative aspect of the subject matter described in this disclosure can be implemented in a first wireless communication device for wireless communication. The first wireless communication device may include a processing system that includes processor circuitry and memory circuitry that stores code. The processing system may be configured to cause the first wireless communication device to switch operation of the first wireless communication device from a first channel to a second channel in response to detection of one or more PPDUs via the first channel, the first wireless communication device being associated with a first BSS, the one or more PPDUs being associated with a second BSS different than the first BSS and receive, via the second channel and from a second wireless communication device, a frame indicating one or more requested parameters for communication via the second channel.

Some examples of the method, first wireless communication devices, and non-transitory computer-readable medium described herein may further include operations, features, means, or instructions for determining whether the one or more requested parameters may be accepted in accordance with a comparison between the one or more requested parameters and one or more parameters associated with the first channel or associated with communication via the second channel, or both.

Some examples of the method, first wireless communication devices, and non-transitory computer-readable medium described herein may further include operations, features, means, or instructions for transmitting, while operating via the second channel, a response frame to the second wireless communication device, where the response frame may be transmitted in accordance with the one or more requested parameters being accepted by the first wireless communication device.

Another innovative aspect of the subject matter described in this disclosure can be implemented in a method for wireless communication by a first wireless communication device. The method may include switching operation of the first wireless communication device from a first channel to a second channel in response to detection of one or more PPDUs via the first channel, the first wireless communication device being associated with a first BSS, the one or more PPDUs being associated with a second BSS different than the first BSS and receiving, via the second channel and from a second wireless communication device, a frame indicating one or more requested parameters for communication via the second channel.

Another innovative aspect of the subject matter described in this disclosure can be implemented in a first wireless communication device for wireless communication. The first wireless communication device may include means for switching operation of the first wireless communication device from a first channel to a second channel in response to detection of one or more PPDUs via the first channel, the first wireless communication device being associated with a first BSS, the one or more PPDUs being associated with a second BSS different than the first BSS and means for receiving, via the second channel and from a second wireless communication device, a frame indicating one or more requested parameters for communication via the second channel.

Another innovative aspect of the subject matter described in this disclosure can be implemented in a non-transitory computer-readable medium storing code for wireless communication. The code may include instructions executable by one or more processors to switch operation of the first wireless communication device from a first channel to a second channel in response to detection of one or more PPDUs via the first channel, the first wireless communication device being associated with a first BSS, the one or more PPDUs being associated with a second BSS different than the first BSS and receive, via the second channel and from a second wireless communication device, a frame indicating one or more requested parameters for communication via the second channel.

Another innovative aspect of the subject matter described in this disclosure can be implemented in a second wireless communication device for wireless communication. The second wireless communication device may include a processing system that includes processor circuitry and memory circuitry that stores code. The processing system may be configured to cause the second wireless communication device to switch operation of the second wireless communication device from a first channel to a second channel in response to detection of one or more PPDUs via the first channel, the second wireless communication device being associated with a first BSS, the one or more PPDUs being associated with a second BSS different than the first BSS and transmit, via the second channel and after the operation of the second wireless communication device is switched from the first channel to the second channel, a frame indicating one or more requested parameters for communication via the second channel.

Some examples of the method, second wireless communication devices, and non-transitory computer-readable medium described herein may further include operations, features, means, or instructions for receiving, while operating via the second channel, a response frame from a first wireless communication device, where the response frame may be received in accordance with the one or more requested parameters and transmitting at least one PPDU via the second channel to the first wireless communication device in accordance with the one or more requested parameters.

In some examples of the method, second wireless communication devices, and non-transitory computer-readable medium described herein, the one or more requested parameters include at least one of a requested TXOP duration or a bandwidth parameter.

Another innovative aspect of the subject matter described in this disclosure can be implemented in a method for wireless communication by a second wireless communication device. The method may include switching operation of the second wireless communication device from a first channel to a second channel in response to detection of one or more PPDUs via the first channel, the second wireless communication device being associated with a first BSS, the one or more PPDUs being associated with a second BSS different than the first BSS and transmitting, via the second channel and after the operation of the second wireless communication device is switched from the first channel to the second channel, a frame indicating one or more requested parameters for communication via the second channel.

Another innovative aspect of the subject matter described in this disclosure can be implemented in a second wireless communication device for wireless communication. The second wireless communication device may include means for switching operation of the second wireless communication device from a first channel to a second channel in response to detection of one or more PPDUs via the first channel, the second wireless communication device being associated with a first BSS, the one or more PPDUs being associated with a second BSS different than the first BSS and means for transmitting, via the second channel and after the operation of the second wireless communication device is switched from the first channel to the second channel, a frame indicating one or more requested parameters for communication via the second channel.

Another innovative aspect of the subject matter described in this disclosure can be implemented in a non-transitory computer-readable medium storing code for wireless communication. The code may include instructions executable by one or more processors to switch operation of the second wireless communication device from a first channel to a second channel in response to detection of one or more PPDUs via the first channel, the second wireless communication device being associated with a first BSS, the one or more PPDUs being associated with a second BSS different than the first BSS and transmit, via the second channel and after the operation of the second wireless communication device is switched from the first channel to the second channel, a frame indicating one or more requested parameters for communication via the second channel.

Another innovative aspect of the subject matter described in this disclosure can be implemented in a first wireless communication device for wireless communication. The first wireless communication device may include a processing system that includes processor circuitry and memory circuitry that stores code. The processing system may be configured to cause the first wireless communication device to switch operation of the first wireless communication device from a first channel to a second channel in response to detection of one or more PPDUs via the first channel, the first wireless communication device being associated with a first BSS, the one or more PPDUs being associated with a second BSS different than the first BSS, transmit, via the second channel and to a second wireless communication device is switched from the first channel to the second channel, a frame indicating one or more requested parameters for communication via the second channel, receive, via the second channel and from the second wireless communication device, a response frame indicating one or more allowed parameters for communication via the second channel, and transmit one or more frames to the second wireless communication device in accordance with the one or more allowed parameters.

Some examples of the method, first wireless communication devices, and non-transitory computer-readable medium described herein may further include operations, features, means, or instructions for modifying at least one of a communication bandwidth or a TXOP duration for transmitting the one or more frames in accordance with the one or more allowed parameters.

In some examples of the method, first wireless communication devices, and non-transitory computer-readable medium described herein, the one or more allowed parameters include at least one of an allowed TXOP duration or an allowed bandwidth parameter.

Another innovative aspect of the subject matter described in this disclosure can be implemented in a method for wireless communication by a first wireless communication device. The method may include switching operation of the first wireless communication device from a first channel to a second channel in response to detection of one or more PPDUs via the first channel, the first wireless communication device being associated with a first BSS, the one or more PPDUs being associated with a second BSS different than the first BSS, transmitting, via the second channel and to a second wireless communication device is switched from the first channel to the second channel, a frame indicating one or more requested parameters for communication via the second channel, receiving, via the second channel and from the second wireless communication device, a response frame indicating one or more allowed parameters for communication via the second channel, and transmitting one or more frames to the second wireless communication device in accordance with the one or more allowed parameters.

Another innovative aspect of the subject matter described in this disclosure can be implemented in a first wireless communication device for wireless communication. The first wireless communication device may include means for switching operation of the first wireless communication device from a first channel to a second channel in response to detection of one or more PPDUs via the first channel, the first wireless communication device being associated with a first BSS, the one or more PPDUs being associated with a second BSS different than the first BSS, means for transmitting, via the second channel and to a second wireless communication device is switched from the first channel to the second channel, a frame indicating one or more requested parameters for communication via the second channel, means for receiving, via the second channel and from the second wireless communication device, a response frame indicating one or more allowed parameters for communication via the second channel, and means for transmitting one or more frames to the second wireless communication device in accordance with the one or more allowed parameters.

Another innovative aspect of the subject matter described in this disclosure can be implemented in a non-transitory computer-readable medium storing code for wireless communication. The code may include instructions executable by one or more processors to switch operation of the first wireless communication device from a first channel to a second channel in response to detection of one or more PPDUs via the first channel, the first wireless communication device being associated with a first BSS, the one or more PPDUs being associated with a second BSS different than the first BSS, transmit, via the second channel and to a second wireless communication device is switched from the first channel to the second channel, a frame indicating one or more requested parameters for communication via the second channel, receive, via the second channel and from the second wireless communication device, a response frame indicating one or more allowed parameters for communication via the second channel, and transmit one or more frames to the second wireless communication device in accordance with the one or more allowed parameters.

Another innovative aspect of the subject matter described in this disclosure can be implemented in a second wireless communication device for wireless communication. The second wireless communication device may include a processing system that includes processor circuitry and memory circuitry that stores code. The processing system may be configured to cause the second wireless communication device to switch operation of the second wireless communication device from a first channel to a second channel in response to detection of one or more PPDUs via the first channel, the second wireless communication device being associated with a first BSS, the one or more PPDUs being associated with a second BSS different than the first BSS, receive, via the second channel and from a first wireless communication device, a frame indicating one or more requested parameters for communication via the second channel, transmit, via the second channel and to the first wireless communication device, a response frame indicating one or more allowed parameters for communication via the second channel, and receive one or more frames to the second wireless communication device in accordance with the one or more allowed parameters.

In some examples of the method, second wireless communication devices, and non-transitory computer-readable medium described herein, the one or more allowed parameters may be in accordance with the one or more PPDUs detected via the first channel by the second wireless communication device.

In some examples of the method, second wireless communication devices, and non-transitory computer-readable medium described herein, the one or more allowed parameters include at least one of an allowed TXOP duration or an allowed bandwidth parameter.

Another innovative aspect of the subject matter described in this disclosure can be implemented in a method for wireless communication by a second wireless communication device. The method may include switching operation of the second wireless communication device from a first channel to a second channel in response to detection of one or more PPDUs via the first channel, the second wireless communication device being associated with a first BSS, the one or more PPDUs being associated with a second BSS different than the first BSS, receiving, via the second channel and from a first wireless communication device, a frame indicating one or more requested parameters for communication via the second channel, transmitting, via the second channel and to the first wireless communication device, a response frame indicating one or more allowed parameters for communication via the second channel, and receiving one or more frames to the second wireless communication device in accordance with the one or more allowed parameters.

Another innovative aspect of the subject matter described in this disclosure can be implemented in a second wireless communication device for wireless communication. The second wireless communication device may include means for switching operation of the second wireless communication device from a first channel to a second channel in response to detection of one or more PPDUs via the first channel, the second wireless communication device being associated with a first BSS, the one or more PPDUs being associated with a second BSS different than the first BSS, means for receiving, via the second channel and from a first wireless communication device, a frame indicating one or more requested parameters for communication via the second channel, means for transmitting, via the second channel and to the first wireless communication device, a response frame indicating one or more allowed parameters for communication via the second channel, and means for receiving one or more frames to the second wireless communication device in accordance with the one or more allowed parameters.

Another innovative aspect of the subject matter described in this disclosure can be implemented in a non-transitory computer-readable medium storing code for wireless communication. The code may include instructions executable by one or more processors to switch operation of the second wireless communication device from a first channel to a second channel in response to detection of one or more PPDUs via the first channel, the second wireless communication device being associated with a first BSS, the one or more PPDUs being associated with a second BSS different than the first BSS, receive, via the second channel and from a first wireless communication device, a frame indicating one or more requested parameters for communication via the second channel, transmit, via the second channel and to the first wireless communication device, a response frame indicating one or more allowed parameters for communication via the second channel, and receive one or more frames to the second wireless communication device in accordance with the one or more allowed parameters.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows an example physical layer (PHY) protocol data unit (PPDU) usable for communications between a wireless AP and one or more wireless STAs.

FIG. 3 shows a hierarchical format of an example PPDU usable for communications between a wireless AP and one or more wireless STAs.

FIGS. 4A, 4B, 4C, 4D, and 4E show examples of communication flows that support non-primary channel access (NPCA) coordination.

FIGS. 5A, 5B, 5C, and 5D show examples of communication flows that support NPCA coordination.

FIGS. 6 and 7 show examples of frame formats that support NPCA coordination.

FIG. 8 shows an example wireless communication device that supports NPCA coordination.

FIG. 9 shows a flowchart illustrating an example process performable by or at a first wireless communication device that supports NPCA coordination.

FIG. 10 shows a flowchart illustrating an example process performable by or at a second wireless communication device that supports NPCA coordination.

FIG. 11 shows a flowchart illustrating an example process performable by or at a first wireless communication device that supports NPCA coordination.

FIG. 12 shows a flowchart illustrating an example process performable by or at a second wireless communication device that supports NPCA coordination.

FIG. 13-16 show flowcharts illustrating example processes performable by or at a first wireless communication device that supports NPCA coordination.

FIG. 17 shows a flowchart illustrating an example process performable by or at a second wireless communication device that supports NPCA coordination.

FIG. 18 shows a flowchart illustrating an example process performable by or at a first wireless communication device that supports NPCA coordination.

FIG. 19 shows a flowchart illustrating an example process performable by or at a second wireless communication device that supports NPCA coordination.

FIG. 20 shows a flowchart illustrating an example process performable by or at a first wireless communication device that supports NPCA coordination.

FIG. 21 shows a flowchart illustrating an example process performable by or at a second wireless communication device that supports NPCA coordination.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G, 5G (New Radio (NR)) or 6G standards promulgated by the 3rd Generation Partnership Project (3GPP), among others.

The described examples can be implemented in any suitable device, component, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), a non-terrestrial network (NTN), or an internet of things (IOT) network.

Some wireless communication networks (such as Wi-Fi networks, enhanced multi-link single radio (eMLSR) AP systems) may include multiple channels (multiple links in an eMLSR AP system) for communication between wireless communication devices (such as access points (APs) and/or non-AP wireless stations (STAs), or eMLSR APs and/or non-AP multi-link devices (MLDs)). For example, the wireless communication network may utilize one 20 megahertz (MHz) channel that is designated as a primary channel (primary link), while supporting a relatively large bandwidth (such as in extremely high throughput (EHT) implementations, which may support a bandwidth up to, for example, 320 MHz). The multiple channels may include the primary channel (which may be referred to as a main primary channel, M-primary channel, or other terminology) and one or more non-primary channels (non-primary links) that are utilized when the M-primary channel is in use by other wireless communication devices. Such techniques for switching operation to one or more non-primary channels may be referred to as non-primary channel access (NPCA), and the non-primary channels may include at least one opportunistic primary channel (which may be referred to as an O-primary channel, NPCA primary channel, temporary primary channel, or other terminology) for wireless communication devices to utilize in cases where the M-primary channel is busy. For example, a first wireless communication device may detect that the M-primary channel is busy based on receiving one or more physical layer (PHY) protocol data units (PPDUs) that are associated with a basic service set (BSS) (such as an overlapping BSS (OBSS)) that is different than a BSS of the first wireless communication device. The first wireless communication device may switch its operation to the O-primary channel for a duration corresponding to the one or more PPDUs (such as in accordance with a network allocation vector (NAV)) and attempt communication with the second wireless communication device via the O-primary channel. After the duration, the first wireless communication device may switch its operation back to the M-primary channel.

In some examples, however, different devices may not detect the same PPDUs and/or OBSS(s) that trigger a switch from a primary channel to another channel. As an example, if the second wireless communication device switches operation from the M-primary channel to the O-primary channel for a different duration than the first wireless communication device (due to different NAVs associated with different OBSSs), the respective devices may switch back to the M-primary channel at different times, leading to communication delays after switching operations back to the M-primary channel. In another example, the first wireless communication device may detect PPDUs associated with an OBSS and switch from the M-primary channel to the O-primary channel, while the second wireless communication device may not detect any PPDUs and may continue operating via the M-primary channel. In some examples, the first and second wireless communication devices may detect different PPDUs (associated with different OBSSs) at a same time (or approximately the same, within a decoding threshold time from each other), but the different PPDUs may be associated with different durations (such as busy durations), different bandwidths, or one or more other different NPCA parameters. In such cases, the channels (such as the frequencies or bandwidths, durations, or other parameters) via which each device operates may not be the same, leading to communication delays or other issues. An absence of coordination between the wireless communication devices when switching operation between respective channels may cause the devices to utilize (switch to and from) primary channels in an unsynchronized manner, which may reduce communication efficiency and increase signaling overhead.

Various aspects of this disclosure relate generally to NPCA coordination. Some aspects more specifically relate to coordination between wireless communication devices regarding switching between a non-primary channel (such as the O-primary channel) and a primary channel (such as the M-primary channel). In some examples, after switching to an O-primary channel (or other non-primary channel), a wireless communication device may implement the NPCA coordination techniques described herein. For instance, a first wireless communication device may transmit, to a second wireless communication device via the O-primary channel, an indication that the first wireless communication device will switch back to the M-primary channel, an indication of a time at which (a duration after which) the first wireless communication device will switch back to the M-primary channel, or both. Additionally, or alternatively, the first wireless communication device may switch back to the M-primary channel in response to an absence of one or more messages from the second wireless communication device, for example, after a threshold quantity of attempts to contend for and win a transmission opportunity (TXOP) on the O-primary channel or before an expiration of a timer. In some examples, the first wireless communication device (such as an AP) may attempt to contend for and win the TXOP to communicate with one or more other wireless communication devices via the O-primary channel after the threshold quantity of attempts and/or the expiration of the timer. Additionally, or alternatively, the first wireless communication device may switch back to the M-primary channel in response to detecting that the O-primary channel is busy for a relatively longer duration than the M-primary channel (such as based on relative NAVs associated with the O-primary and M-primary channels).

In some aspects, wireless communication devices may communicate (such as transmit, broadcast, receive) one or more NPCA parameters in response to switching from the M-primary channel to the O-primary channel to enhance NPCA coordination. For example, after switching to the O-primary channel based on detecting a first PPDU on the M-primary channel, a first wireless communication device (such as an AP, a STA) may broadcast an initial control frame (ICF) (such as a first frame, an announcement frame) that indicates one or more parameters (such as NPCA parameters). The one or more parameters may include a bandwidth parameter, a duration parameter, one or more other parameters, such as a modulation and coding scheme (MCS), number of spatial streams (NSS), threshold padding delay (such as a maximum padding delay), a puncturing pattern, or any combination thereof. The indication of the one or more parameters may indicate, to other wireless communication devices, an available bandwidth for communicating via the O-primary channel and/or how long the M-primary channel is busy, among other information. In some examples, after switching to the O-primary channel in response to detecting one or more PPDUs via the M-primary channel, a wireless communication device (such as an AP, a STA) may wait to contend for access to the O-primary channel until the ICF is received, until a timer expires, or a combination thereof. Additionally, or alternatively, a second wireless communication device may receive the ICF that includes one or more requested parameters (such as a requested TXOP duration, a requested bandwidth, a puncturing pattern, other requested parameters) for communication via the O-primary channel. The second wireless communication device may ignore (such as not respond to, refrain from responding to) the ICF from the first wireless communication device when at least one of the one or more requested parameters is not accepted by the second wireless communication device (such as based on local NPCA parameters at the second wireless communication device). Additionally, or alternatively, after switching to the O-primary channel, the first wireless communication device and the second wireless communication device may negotiate one or more allowed parameters via communication of ICFs and initial communication responses (ICRs), where the one or more allowed parameters may include at least an allowed duration parameters (such as a TXOP duration), an allowed bandwidth parameter, and/or an allowed puncturing pattern parameter.

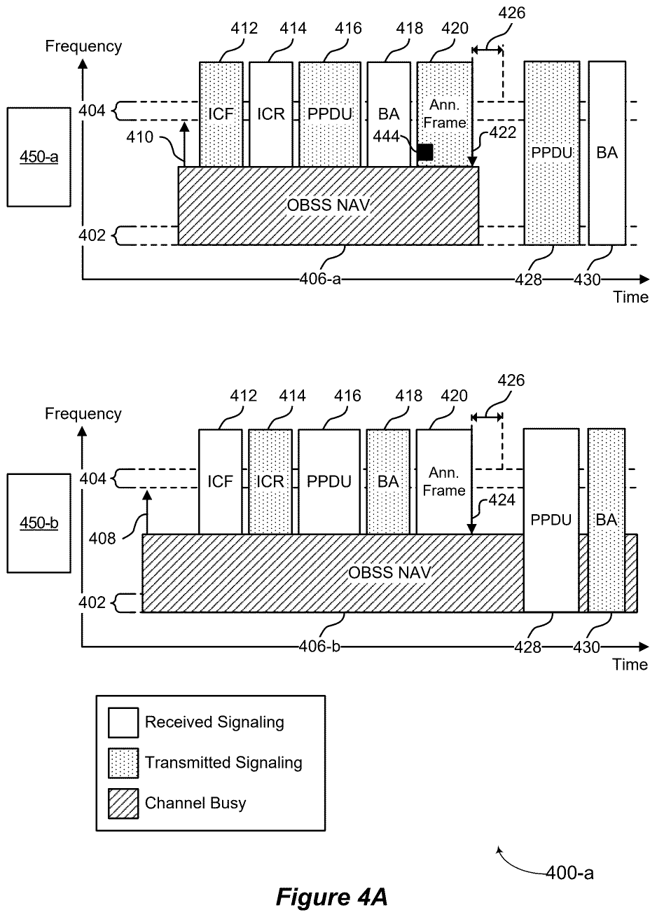

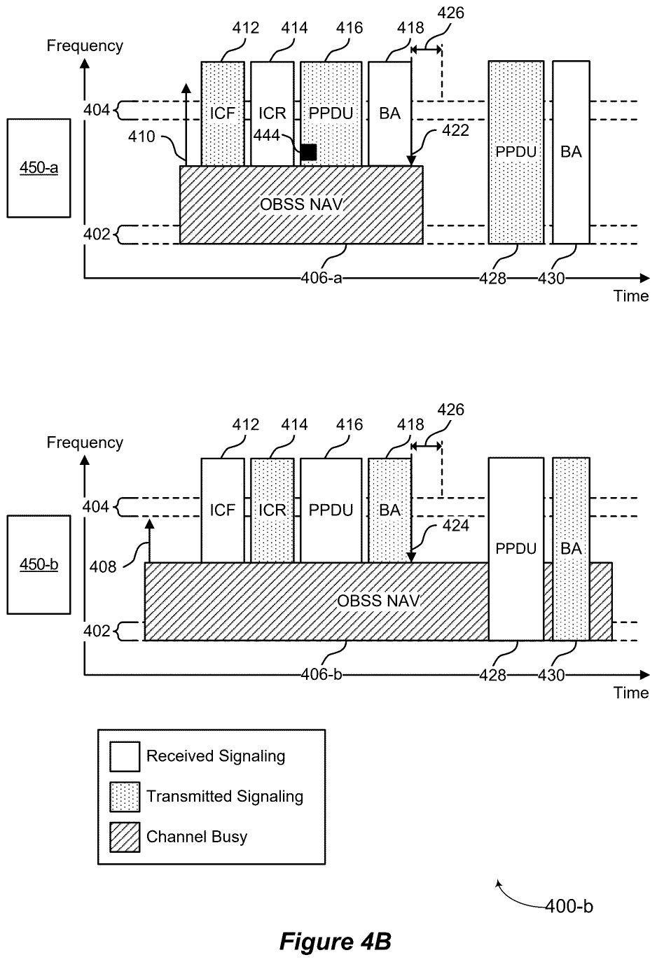

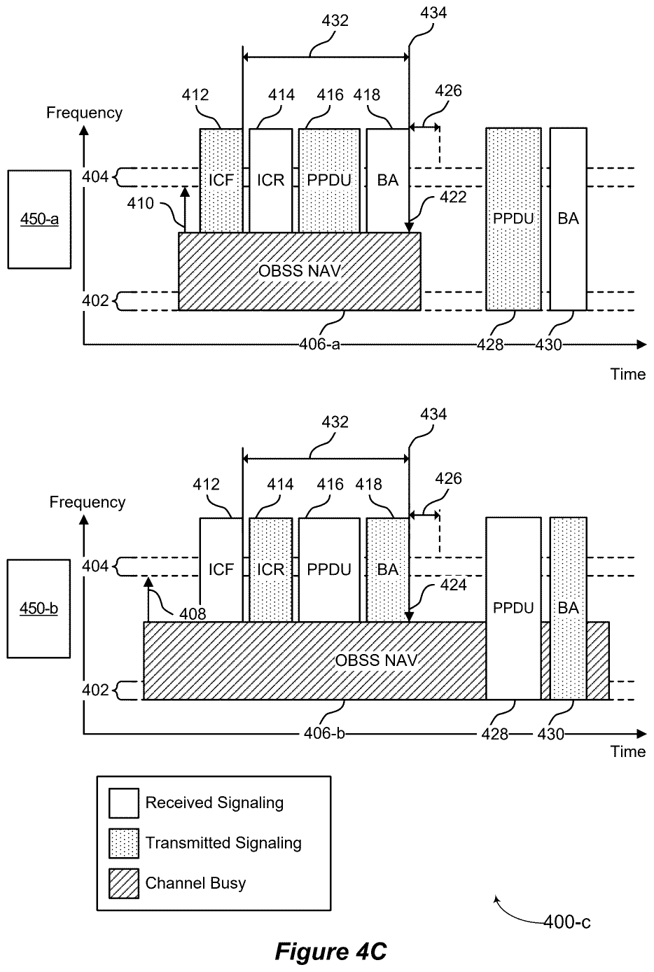

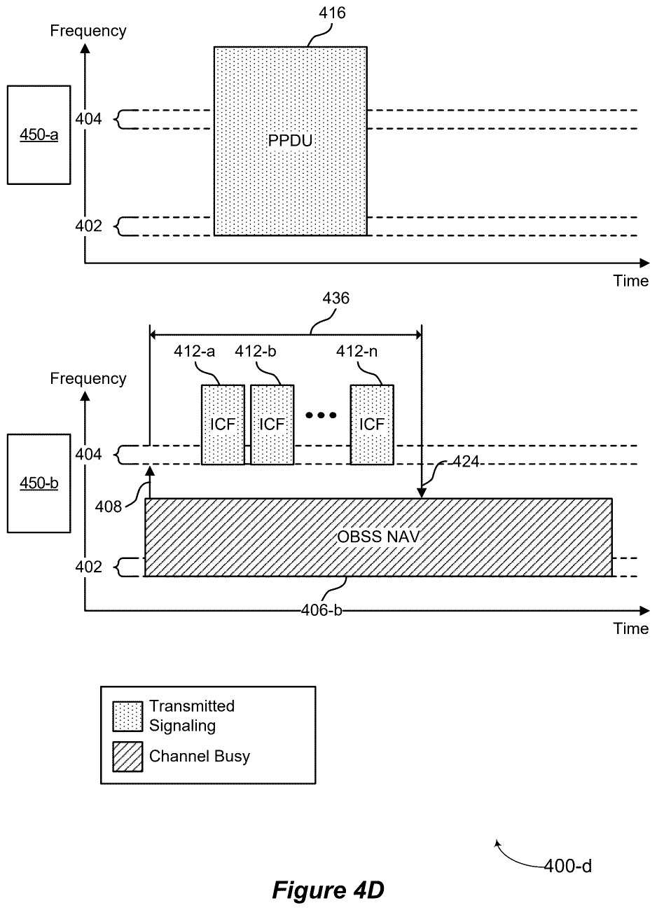

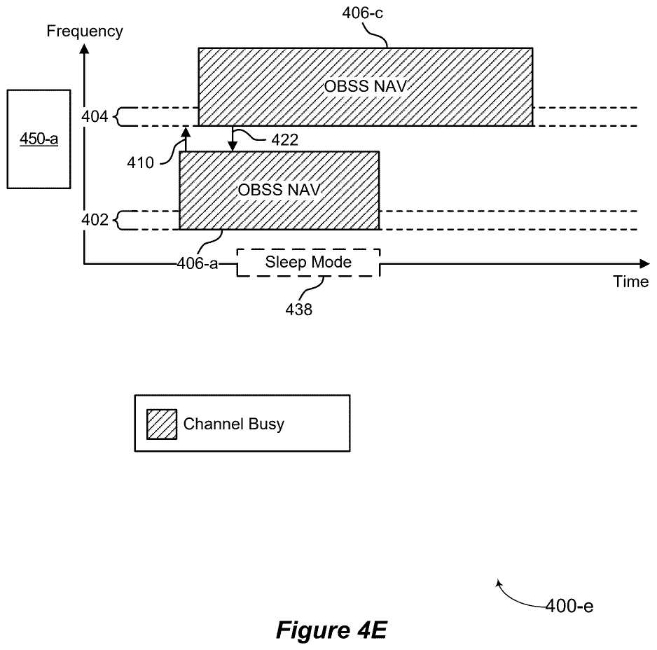

Although some aspects of the present disclosure are described in the context of NPCA and a wireless communication network that includes an M-Primary channel and one or more other primary channels (such as O-Primary channels), the concepts and techniques described herein may apply more broadly to any type of system with different types of channels or links used to contend for channel access. In some implementations, the techniques described herein may be applied in systems where the M-primary channel and the O-primary channel are sub channels within an operating bandwidth (such as in NPCA). Additionally, or alternatively, the techniques described herein may be applied where the M-primary channel and the O-primary channel are associated with different links in the same or different frequency bands (such as in enhanced multi-link single radio (eMLSR) AP systems). For example, the M-primary channel (such as a first channel, described with respect to FIG. 4A-4E) may be an example of a primary link in an eMLSR AP system, and the O-primary channel (such as a second channel, described with respect to FIG. 4A-4E) may be an example of a non-primary link in the eMLSR AP system. In such examples, a wireless communication device (such as an EMLSR AP, an associated non-AP MLD) may detect that there is an OBSS on a primary link, and the wireless communication device may switch to a nonprimary link and contend for channel access. Whichever device that won access to the medium may ensure that a transmission opportunity (TXOP) ends before the end of the OBSS TXOP on the primary link. The techniques described herein may be applicable to switching operation between the primary link and the nonprimary link, where a wireless communication device may transmit an indication indicating that it is switching operation back to a primary link in an eMLSR AP system.

Particular aspects of the subject matter described in this disclosure can be implemented to realize one or more of the following potential advantages. In some examples, enabling improved NPCA coordination between wireless communication devices may provide for more efficient utilization of communication resources between wireless communication devices and save power at the wireless communication devices. For example, an indication that a wireless communication device is switching operation back to a primary channel (such as an M-primary channel) or an indication of the time at which the wireless communication device will switch operation back to the M-primary channel, or both, may enable coordinated switching by respective devices. Such coordination may enable the wireless communication devices to communicate more effectively over the O-primary channel and/or the M-primary channel and reduce or otherwise prevent attempted communications on different channels. Additionally, or alternatively, by switching back to the M-primary channel after a threshold quantity of attempts or after an expiration of a timer, a wireless communication device may allow other wireless communication devices to use the O-primary channel, which may improve wireless communication resource utilization. In example where the O-primary channel is busy for relatively longer than an M-primary channel, the first wireless communication device may have an opportunity to enter into a low-power mode to reduce energy consumption until the M-primary channel is available, which may improve power consumption of the first wireless communication device.

Communicating one or more parameters in response to switching from the M-primary channel to the O-primary channel may improve inter-device coordination, which may improve resource utilization and communication quality. For example, by broadcasting an announcement indicating an available bandwidth and/or a busy duration, wireless communication devices may reduce interference associated with NPCA communications (such as when the wireless communication devices detected different PPDUs on the M-primary channel). Further, broadcasting the announcement including the duration indication may enable a first wireless communication device (such as an AP) to return to the primary channel as soon as a NAV corresponding to a detected PPDU ends (when a first OBSS NAV associated with the detected PPDU expires), even in cases where a second wireless communication device detects one or more PPDUs associated with a relatively longer NAV (a second OBSS NAV that expires after the first OBSS NAV). Such techniques may allow the first wireless communication device to receive and/or transmit traffic with an associated BSS via the M-primary channel relatively sooner and reduce communication failures or retransmissions.

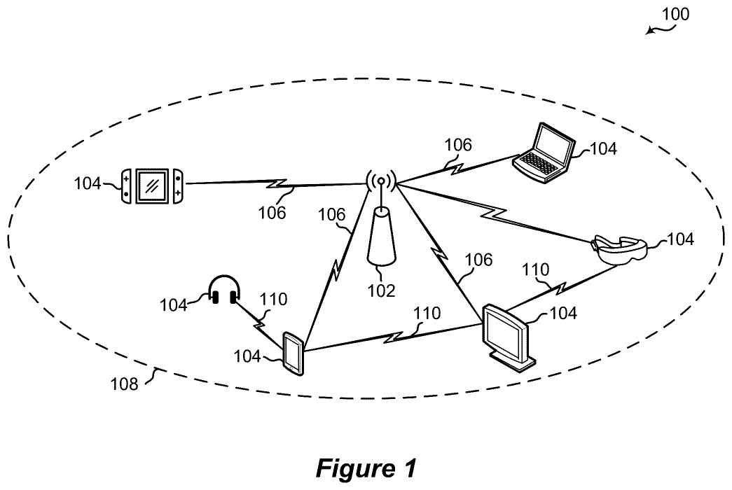

FIG. 1 shows a pictorial diagram of an example wireless communication network 100. According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards, such as defined by the IEEE 802.11-2020 specification or amendments thereof (including, but not limited to, 802.11ay, 802.11ax (also referred to as Wi-Fi 6), 802.11az, 802.11ba, 802.11bc, 802.11bd, 802.11be (also referred to as Wi-Fi 7), 802.11bf, and 802.11bn (also referred to as Wi-Fi 8)) or other WLAN or Wi-Fi standards, such as that associated with the Integrated Millimeter Wave (IMMW) study group. In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core. In some other examples, the wireless communication network 100 can include a WLAN that functions in an interoperable or converged manner with one or more personal area networks, such as a network implementing Bluetooth or other wireless technologies, to provide greater or enhanced network coverage or to provide or enable other capabilities, functionality, applications or services.

The wireless communication network 100 may include numerous wireless communication devices including an AP 102 and any number of STAs 104. While only one AP 102 is shown in FIG. 1, the wireless communication network 100 can include multiple APs 102 (such as in an extended service set (ESS) deployment, enterprise network or AP mesh network), or may not include any AP at all (such as in an independent basic service set (IBSS) such as a peer-to-peer (P2P) network or other ad hoc network). The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP MLD), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (such as TVs, computer monitors or video gaming consoles), video game controllers, navigation systems, music or other audio or stereo devices, remote control devices, printers, kitchen appliances (including smart refrigerators) or other household appliances, key fobs (such as for passive keyless entry and start (PKES) systems), Internet of Things (IoT) devices, and vehicles, among other examples.

A single AP 102 and an associated set of STAs 104 may be referred to as an infrastructure basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (such as the 2.4 GHz, 5 GHz, 6 GHz, 45 GHz, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an ESS including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some examples, STAs 104 may form networks without APs 102 or other equipment other than the STAs 104 themselves. One example of such a network is an ad hoc network (or wireless ad hoc network). Ad hoc networks may alternatively be referred to as mesh networks or P2P networks. In some examples, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct wireless communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the wireless communication network 100 may transmit PPDUs over an unlicensed spectrum, which may be a portion of spectrum that includes frequency bands traditionally used by Wi-Fi technology, such as the 2.4 GHz, 5 GHz, 6 GHz, 45 GHz, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHz-7.125 GHz), FR2 (24.25 GHz-52.6 GHz), FR3 (7.125 GHz-24.25 GHz), FR4a or FR4-1 (52.6 GHz-71 GHz), FR4 (52.6 GHz-114.25 GHz), and FR5 (114.25 GHz-300 GHz).

Each of the frequency bands may include multiple sub-bands and frequency channels (also referred to as subchannels). The terms “channel” and “subchannel” may be used interchangeably herein, as each may refer to a portion of frequency spectrum within a frequency band (such as a 20 MHz, 40 MHz, 80 MHz, or 160 MHz portion of frequency spectrum) via which communication between two or more wireless communication devices can occur. For example, PPDUs conforming to the IEEE 802.11n, 802.11ac, 802.11ax, 802.11be and 802.11bn standard amendments may be transmitted over one or more of the 2.4 GHz, 5 GHz, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHz, 240 MHz, 320 MHz, 480 MHz, or 640 MHz by bonding together multiple 20 MHz channels.

An AP 102 may determine or select an operating or operational bandwidth for the STAs 104 in its BSS and select a range of channels within a band to provide that operating bandwidth. For example, the AP 102 may select sixteen 20 MHz channels that collectively span an operating bandwidth of 320 MHz. Within the operating bandwidth, the AP 102 may typically select a single primary 20 MHz channel on which the AP 102 and the STAs 104 in its BSS monitor for contention-based access schemes. In some examples, the AP 102 or the STAs 104 may be capable of monitoring only a single primary 20 MHz channel for packet detection (such as for detecting preambles of PPDUs). Conventionally, any transmission by an AP 102 or a STA 104 within a BSS must involve transmission on the primary 20 MHz channel. As such, in conventional systems, the transmitting device must contend on and win a TXOP on the primary channel to transmit anything at all. However, some APs 102 and STAs 104 supporting ultra-high reliability (UHR) communications or communication according to the IEEE 802.11bn standard amendment can be configured to operate, monitor, contend and communicate using multiple primary 20 MHz channels. Such monitoring of multiple primary 20 MHz channels may be sequential such that responsive to determining, ascertaining or detecting that a first primary 20 MHz channel is not available, a wireless communication device may switch to monitoring and contending using a second primary 20 MHz channel. Additionally, or alternatively, a wireless communication device may be configured to monitor multiple primary 20 MHz and/or non-primary channels in parallel. In some examples, operation of a wireless communication device on a primary channel (such as the M-primary channel) may include communicating (such as transmitting, receiving, monitoring for) signaling via the primary channel and non-primary channel(s) associated with the M-primary channel (which may include the O-primary channel). Additionally, or alternatively, operation of a wireless communication device on a non-primary channel (such as the O-primary channel) may include communicating signaling on non-primary channels other than the O-primary channel (which may overlap in frequency resources with the non-primary channels associated with the M-primary channel). In some examples, a first primary 20 MHz channel may be referred to as an M-primary channel and one or more additional, second primary channels may each be referred to as an O-primary channel. For example, if a wireless communication device measures, identifies, ascertains, detects, or otherwise determines that the M-Primary channel is busy or occupied (such as due to an overlapping BSS (OBSS) transmission), the wireless communication device may switch to monitoring and contending on an O-Primary channel. In some examples, the M-Primary channel may be used for beaconing and serving legacy client devices and an O-Primary channel may be specifically used by non-legacy (such as UHR-or IEEE 802.11bn-compatible) devices for opportunistic access to spectrum that may be otherwise under-utilized.

The AP 102 and the STAs 104 of the wireless communication network 100 may implement technologies, protocols or procedures compliant with current and future generations of the IEEE 802.11 family of wireless communication protocol standards, such as Extremely High Throughput (EHT) operation defined by the IEEE 802.11be standard amendment and Ultra-High Reliability (UHR) operation defined by the IEEE 802.11bn standard amendments, to enable additional capabilities or features relative to previous generations, such as devices supporting only legacy operation such as Very High Throughput (VHT) operation defined by the 802.11ac standard amendment or High Efficiency (HE) operation defined by the IEEE 802.11ax standard amendment. For example, the IEEE 802.11be standard amendment introduced 320 MHz channels, which are twice as wide as those possible with the IEEE 802.11ax standard amendment. Accordingly, the AP 102 or the STAs 104 may use 320 MHz channels enabling double the throughput and network capacity, as well as providing rate versus range gains at high data rates due to linear bandwidth versus log SNR trade-off. EHT, UHR or other newer wireless communication protocols may support flexible operating bandwidth enhancements, such as broadened operating bandwidths relative to legacy operating bandwidths or more granular operation relative to legacy operation. For example, an EHT system may allow communications spanning operating bandwidths of 20 MHz, 40 MHz, 80 MHz, 160 MHz, 240 MHz, and 320 MHz while a UHR system may enable communications spanning even greater bandwidths, such as 480 MHz, 640 MHz or greater. EHT systems may, for example, support multiple bandwidth modes such as a contiguous 240 MHz bandwidth mode, a contiguous 320 MHz bandwidth mode, a noncontiguous 160+160 MHz bandwidth mode, or a noncontiguous 80+80+80+80 (or “4×80”) MHz bandwidth mode.

In some examples in which a wireless communication device (such as the AP 102 or the STA 104) operates in a contiguous 320 MHz bandwidth mode or a 160+160 MHz bandwidth mode, signals for transmission may be generated by two different transmit chains of the wireless communication device each having or associated with a bandwidth of 160 MHz (and each coupled to a different power amplifier). In some other examples, two transmit chains can be used to support a 240 MHz/160+80 MHz bandwidth mode by puncturing 320 MHz/160+160 MHz bandwidth modes with one or more 80 MHz subchannels. For example, signals for transmission may be generated by two different transmit chains of the wireless communication device each having a bandwidth of 160 MHz with one of the transmit chains outputting a signal having an 80 MHz subchannel punctured therein. In some other examples in which the wireless communication device may operate in a contiguous 240 MHz bandwidth mode, or a noncontiguous 160+80 MHz bandwidth mode, the signals for transmission may be generated by three different transmit chains of the wireless communication device, each having a bandwidth of 80 MHz. In some other examples, signals for transmission may be generated by four or more different transmit chains of the wireless communication device, each having a bandwidth of 80 MHz.

In noncontiguous examples, the operating bandwidth may span one or more disparate sub-channel sets. For example, the 320 MHz bandwidth may be contiguous and located in the same 6 GHz band or noncontiguous and located in different bands or regions within a band (such as partly in the 5 GHz band and partly in the 6 GHz band).

In some examples, the AP 102 or the STA 104 may benefit from operability enhancements associated with EHT, UHR and newer generations of the IEEE 802.11 family of wireless communication protocol standards. For example, the AP 102 or the STA 104 attempting to gain access to the wireless medium of the wireless communication network 100 may perform techniques (which may include modifications to existing rules, structure, or signaling implemented for legacy systems) such as clear channel assessment (CCA) operation based on EHT or UHR enhancements such as increased bandwidth, puncturing, or refinements to carrier sensing and signal reporting mechanisms.

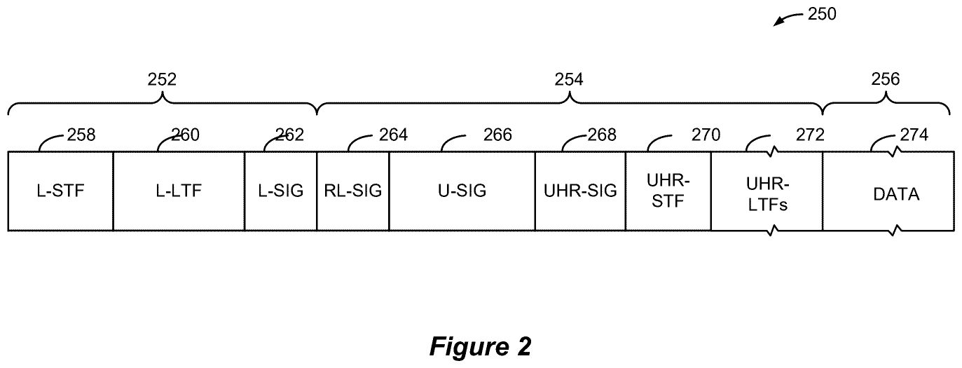

FIG. 2 shows an example physical layer (PHY) protocol data unit (PPDU) 250 usable for communications between a wireless AP and one or more wireless STAs. For example, the AP and STAs may be examples of the AP 102 and the STAs 104 described with reference to FIG. 1. As shown, the PPDU 250 includes a PHY preamble, that includes a legacy portion 252 and a non-legacy portion 254, and a payload 256 that includes a data field 274. The legacy portion 252 of the preamble includes an L-STF 258, an L-LTF 260, and an L-SIG 262. The non-legacy portion 254 of the preamble includes a repetition of L-SIG (RL-SIG) 264, a universal signal field 266 (referred to herein as “U-SIG 266”) and a UHR signal field 268 (referred to herein as “UHR-SIG 268”). The presence of RL-SIG 264 and U-SIG 266 may indicate to UHR or later version-compliant STAs 104 that the PPDU 250 is a UHR PPDU or a PPDU conforming to any later (post-UHR) version of a new wireless communication protocol conforming to a future IEEE 802.11 wireless communication protocol standard. One or both of U-SIG 266 and UHR-SIG 268 may be structured as, and carry version-dependent information for, other wireless communication protocol versions associated with amendments to the IEEE family of standards beyond UHR. For example, U-SIG 266 may be used by a receiving device (such as an AP 102 or a STA 104) to interpret bits in one or more of UHR-SIG 268 or the data field 274. U-SIG 266 may include one or more universal, version-independent fields and one or more version-dependent fields. Information in the universal fields may include, for example, a version identifier (starting from the IEEE 802.11be amendment and beyond) and channel occupancy and coexistence information (such as a punctured channel indication). The version-dependent fields may include format information fields used for interpreting other fields of U-SIG 266 and UHR-SIG 268 and additional information fields or single user (SU)-specific fields that may be useful to intended recipients. In some implementations, the version-dependent fields may include at least a PPDU format field to indicate a general PPDU format for the PPDU 250 (such as a trigger-based (TB), a single-user (SU), or a multi-user (MU) PPDU format). Like L-STF 258, L-LTF 260, and L-SIG 262, the information in U-SIG 266 and UHR-SIG 268 may be duplicated and transmitted in each of the component 20 MHz channels in instances involving the use of a bonded channel.

The non-legacy portion 254 further includes an additional short training field 270 (referred to herein as “UHR-STF 270,” although it may be structured as, and carry version-dependent information for, other wireless communication protocol versions beyond UHR) and one or more additional long training fields 272 (referred to herein as “UHR-LTFs 272,” although they may be structured as, and carry version-dependent information for, other wireless communication protocol versions beyond UHR). UHR-STF 270 may be used for timing and frequency tracking and AGC, and UHR-LTF 272 may be used for more refined channel estimation.

UHR-SIG 268 may be used by an AP 102 to identify and inform one or multiple STAs 104 that the AP 102 has scheduled uplink (UL) or downlink (DL) resources for them. UHR-SIG 268 may be decoded by each compatible STA 104 served by the AP 102. UHR-SIG 268 also may generally be used by the receiving device to interpret bits in the data field 274. For example, UHR-SIG 268 may include resource unit (RU) allocation information, spatial stream configuration information, and per-user (such as STA-specific) signaling information. Each UHR-SIG 268 may include a common field and at least one user-specific field. In the context of OFDMA, the common field can indicate RU distributions to multiple STAs 104, indicate the RU assignments in the frequency domain, indicate which RUs are allocated for MU-MIMO transmissions and which RUs correspond to OFDMA transmissions, and the number of users in allocations, among other examples. The user-specific fields are assigned to particular STAs 104 and carry STA-specific scheduling information such as user-specific MCS values and user-specific RU allocation information. Such information enables the respective STAs 104 to identify and decode corresponding RUs in the associated data field 274.

In some wireless communications systems, a STA 104 or an AP 102 may transmit the PPDU 250 over bandwidths larger than the 20 MHz, 40 MHz, 80 MHz, 160 MHz, and 320 MHz bandwidths supported by previous generations of IEEE-compliant wireless communication systems. For example, the PPDU 250 may support 480 MHz or 640 MHz bandwidth communications. By increasing the channel bandwidth of the PPDU 250 to 480 MHz or 640 MHz, more data may be transmitted because more or larger RUs are available based on the larger bandwidth, and accordingly, higher peak throughput or increased capacity may be achieved. Parameters for assembling and transmitting the 480 MHz or 640 MHz PPDUs may be defined to account for the larger bandwidths. For example, parameters or designs such as the tone plans, resource unit allocation indications, spatial reuse fields, UHR-STFs 270, UHR-LTFs 272, pilot signal locations, phase shifts, and spectral masks may be optimized or otherwise selected in accordance with the 480 MHz or 640 MHz bandwidths. In some examples, the spatial reuse fields may enable multiple BSSs to operate on the same 480 MHz or 640 MHz bandwidth channels.

In some examples, UHR-capable STAs 104 and APs 102 may support unequal modulation techniques (also referred to as unequal quadrature amplitude modulation (QAM)) with joint encoding across multiple streams for MIMO communications. For example, while different data streams may be transmitted using different spatial streams, or different resource units (RUs), or both, different spatial streams or RUs may be associated with different levels of quality (such as a different signal to noise ratios (SNRs)), and it may be advantageous to use different (unequal) MCSs for different spatial streams or RUs.

To support unequal modulation, an AP 102 may transmit signaling that indicates unequal MCSs across spatial streams or RUs to multiple STAs 104. For example, the AP 102 may transmit an MCS configuration message, which may be an example of a PHY preamble included in control signaling for PHY layer configuration, to indicate the unequal MCSs. In some examples, an MCS field of the MCS configuration message may include entries for unequal QAM schemes across multiple spatial streams, where the multiple spatial streams may be encoding with the same code rate.

In some wireless communication systems, wireless communication devices may support low density parity check (LDPC) coding for forward error correcting purposes to increase the likelihood of accurate data transmission. In some examples, UHR-capable STAs 104 and APs 102 may be capable of selecting among multiple LDPC codeword lengths, including 648 bits, 1296 bits and 1944 bits (defined in legacy IEEE 802.11 wireless communications protocol standards), as well as even longer (extended) codeword lengths, which may increase as operating bandwidths increase, higher modulation orders are introduced, or more spatial streams are available. Using longer LDPC codewords may achieve lower block error rates in some channels, such as channels associated with additive white Gaussian noise. Longer LDPC codewords also may enable more reliable communications in channels with lower SNRs. To facilitate the use of multiple LDPC codeword lengths, a STA 104 and an AP 102 may each include multiple LDPC encoders and multiple LDPC decoders. In some examples, such a STA 104 or AP 102 may connect, aggregate or otherwise utilize multiple encoders to implement a larger single encoder capable of encoding a longer codeword, or similarly, utilize multiple decoders to implement a larger single decoder capable of decoding a longer codeword, which may increase performance gains associated with larger block sizes without substantially increasing the hardware cost or complexity. In some examples, to generate an extended LDPC codeword, a STA 104 or an AP 102 may implement one or more lifting operations to extend a shorter codeword, with each lifting operation extending the previously lifted codeword. A “lifting” operation enables LDPC codes to be implemented using parallel encoding or decoding implementations while also reducing the complexity typically associated with large LDPC codewords. In some examples, a STA 104 or an AP 102 may use mixed codeword lengths for a given transmission. For example, the STA 104 or the AP 102 may encode input bits into one or more codewords having a first, longer codeword length (more than 1944 bits) and one or more codewords having a second, shorter codeword length (1944 bits or less). In such examples, the STA 104 or the AP 102 may perform shortening or puncturing on the codewords having the longer codeword length, or on the codewords having the shorter codeword length, or both.

To support increased range or rate-over-range, a STA 104 and an AP 102 may support extended long range (ELR) PPDU formats. The use of an ELR PPDU format can enable the achievement of a target data rate while maintaining an existing coverage range, reduce an uplink/downlink power imbalance (due to, for example, one or more regulations or hardware differences at the uplink and downlink devices), or extend a coverage range while maintaining a similar, or slightly lower, data rate as compared with other PPDU formats. In some examples, an ELR PPDU may be transmitted over a narrow bandwidth, which may have a lower noise floor and thus higher SNR, thereby extending the coverage range. The reliability of the transmission of an ELR PPDU also may be increased as a result of using various optimized coding rates, coded bit repetition schemes, or duplication schemes, which may provide for improved decodability and fewer retransmissions. In some examples, the U-SIG 266 of an ELR PPDU 250 may include a first indication (such as a codepoint of a PHY version identifier subfield within a version-independent portion of the U-SIG 266 or a value of an ELR subfield within a version-dependent portion of the U-SIG 266) that the PPDU 250 is associated with an ELR format. The U-SIG 266 of an ELR PPDU 250 may include a second indication (such as a STA identifier subfield within the version-dependent portion of the U-SIG 266) of an intended receiver of the PPDU. In some examples, an ELR PPDU 250 may include an ELR-signature (ELR-SIG) field that includes an uplink/downlink indicator subfield, a length subfield, a coding indicator subfield, and an MCS subfield.

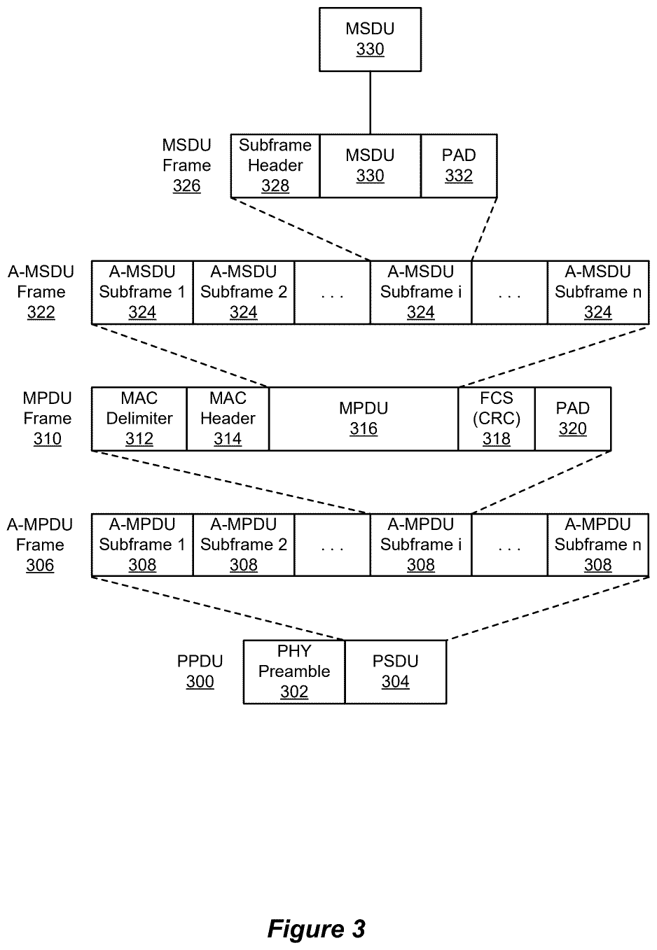

FIG. 3 shows a hierarchical format of an example PPDU usable for communications between a wireless AP and one or more wireless STAs. For example, the AP and STAs may be examples of the AP 102 and the STAs 104 described with reference to FIG. 1. As described, each PPDU 300 includes a PHY preamble 302 and a PSDU 304. Each PSDU 304 may represent (or “carry”) one or more MAC protocol data units (MPDUs) 316. For example, each PSDU 304 may carry an aggregated MPDU (A-MPDU) 306 that includes an aggregation of multiple A-MPDU subframes 308. Each A-MPDU subframe 308 may include an MPDU frame 310 that includes a MAC delimiter 312 and a MAC header 314 prior to the accompanying MPDU 316, which includes the data portion (“payload” or “frame body”) of the MPDU frame 310. Each MPDU frame 310 also may include a frame check sequence (FCS) field 318 for error detection (such as the FCS field 318 may include a cyclic redundancy check (CRC)) and padding bits 320. The MPDU 316 may carry one or more MAC service data units (MSDUs) 330. For example, the MPDU 316 may carry an aggregated MSDU (A-MSDU) 322 including multiple A-MSDU subframes 324. Each A-MSDU subframe 324 may be associated with an MSDU frame 326 and may contain a corresponding MSDU 330 preceded by a subframe header 328 and, in some examples, followed by padding bits 332.

Referring back to the MPDU frame 310, the MAC delimiter 312 may serve as a marker of the start of the associated MPDU 316 and indicate the length of the associated MPDU 316. The MAC header 314 may include multiple fields containing information that defines or indicates characteristics or attributes of data encapsulated within the frame body. The MAC header 314 includes a duration field indicating a duration extending from the end of the PPDU until at least the end of an acknowledgment (ACK) or Block ACK (BA) of the PPDU that is to be transmitted by the receiving wireless communication device. The use of the duration field serves to reserve the wireless medium for the indicated duration and enables the receiving device to establish its network allocation vector (NAV). The MAC header 314 also includes one or more fields indicating addresses for the data encapsulated within the frame body. For example, the MAC header 314 may include a combination of a source address, a transmitter address, a receiver address or a destination address. The MAC header 314 may further include a frame control field containing control information. The frame control field may specify a frame type, for example, a data frame, a control frame, or a management frame.

In some wireless communication systems, wireless communication between an AP 102 and an associated STA 104 can be secured. For example, either an AP 102 or a STA 104 may establish a security key for securing wireless communication between itself and the other device and may encrypt the contents of the data and management frames using the security key. In some examples, the control frame and fields within the MAC header of the data or management frames, or both, also may be secured either via encryption or via an integrity check (such as by generating a message integrity check (MIC) for one or more relevant fields.

Access to the shared wireless medium is generally governed by a distributed coordination function (DCF). With a DCF, there is generally no centralized master device allocating time and frequency resources of the shared wireless medium. On the contrary, before a wireless communication device, such as an AP 102 or a STA 104, is permitted to transmit data, it may wait for a particular time and contend for access to the wireless medium. The DCF is implemented through the use of time intervals (including the slot time (or “slot interval”) and the inter-frame space (IFS). IFS provides priority access for control frames used for proper network operation. Transmissions may begin at slot boundaries. Different varieties of IFS exist including the short IFS (SIFS), the distributed IFS (DIFS), the extended IFS (EIFS), and the arbitration IFS (AIFS). The values for the slot time and IFS may be provided by a suitable standard specification, such as one or more of the IEEE 802.11 family of wireless communication protocol standards.

In some examples, the wireless communication device (such as the AP 102 or the STA 104) may implement the DCF through the use of carrier sense multiple access (CSMA) with collision avoidance (CA) (CSMA/CA) techniques. According to such techniques, before transmitting data, the wireless communication device may perform a clear channel assessment (CCA) and may determine (such as identify, detect, ascertain, calculate, or compute) that the relevant wireless channel is idle. The CCA includes both physical (PHY-level) carrier sensing and virtual (MAC-level) carrier sensing. Physical carrier sensing is accomplished via a measurement of the received signal strength of a valid frame, which is compared to a threshold to determine (such as identify, detect, ascertain, calculate, or compute) whether the channel is busy. For example, if the received signal strength of a detected preamble is above a threshold, the medium is considered busy. Physical carrier sensing also includes energy detection. Energy detection involves measuring the total energy the wireless communication device receives regardless of whether the received signal represents a valid frame. If the total energy detected is above a threshold, the medium is considered busy.

Virtual carrier sensing is accomplished via the use of a network allocation vector (NAV), which effectively serves as a time duration that elapses before the wireless communication device may contend for access even in the absence of a detected symbol or even if the detected energy is below the relevant threshold. The NAV is reset each time a valid frame is received that is not addressed to the wireless communication device. When the NAV reaches 0, the wireless communication device performs the physical carrier sensing. If the channel remains idle for the appropriate IFS, the wireless communication device initiates a backoff timer, which represents a duration of time that the device senses the medium to be idle before it is permitted to transmit. If the channel remains idle until the backoff timer expires, the wireless communication device becomes the holder (or “owner”) of a TXOP and may begin transmitting. The TXOP is the duration of time the wireless communication device can transmit frames over the channel after it has “won” contention for the wireless medium. The TXOP duration may be indicated in the U-SIG field of a PPDU. If, on the other hand, one or more of the carrier sense mechanisms indicate that the channel is busy, a MAC controller within the wireless communication device will not permit transmission.

Each time the wireless communication device generates a new PPDU for transmission in a new TXOP, it randomly selects a new backoff timer duration. The available distribution of the numbers that may be randomly selected for the backoff timer is referred to as the contention window (CW). There are different CW and TXOP durations for each of the four access categories (ACs): voice (AC_VO), video (AC_VI), background (AC_BK), and best effort (AC_BE). This enables particular types of traffic to be prioritized in the network.

In some other examples, the wireless communication device (such as the AP 102 or the STA 104) may contend for access to the wireless medium of a WLAN in accordance with an enhanced distributed channel access (EDCA) procedure. A random channel access mechanism such as EDCA may afford high-priority traffic a greater likelihood of gaining medium access than low-priority traffic. The wireless communication device using EDCA may classify data into different access categories. Each AC may be associated with a different priority level and may be assigned a different range of random backoffs (RBOs) so that higher priority data is more likely to win a TXOP than lower priority data (such as by assigning lower RBOs to higher priority data and assigning higher RBOs to lower priority data). Although EDCA increases the likelihood that low-latency data traffic will gain access to a shared wireless medium during a given contention period, unpredictable outcomes of medium access contention operations may prevent low-latency applications from achieving certain levels of throughput or satisfying certain latency requirements.

Some APs and STAs (such as the AP 102 and the STAs 104 described with reference to FIG. 1) may implement spatial reuse techniques. For example, APs 102 and STAs 104 configured for communications using the protocols defined in the IEEE 802.11ax or 802.11be standard amendments may be configured with a BSS color. APs 102 associated with different BSSs may be associated with different BSS colors. A BSS color is a numerical identifier of an AP 102's respective BSS (such as a 6 bit field carried by the SIG field). Each STA 104 may learn its own BSS color upon association with the respective AP 102. BSS color information is communicated at both the PHY and MAC sublayers. If an AP 102 or a STA 104 detects, obtains, selects, or identifies, a wireless packet from another wireless communication device while contending for access, the AP 102 or the STA 104 may apply different contention parameters in accordance with whether the wireless packet is transmitted by, or transmitted to, another wireless communication device (such another AP 102 or STA 104) within its BSS or from a wireless communication device from an OBSS, as determined, identified, ascertained, or calculated by a BSS color indication in a preamble of the wireless packet. For example, if the BSS color associated with the wireless packet is the same as the BSS color of the AP 102 or STA 104, the AP 102 or STA 104 may use a first RSSI detection threshold when performing a CCA on the wireless channel. However, if the BSS color associated with the wireless packet is different than the BSS color of the AP 102 or STA 104, the AP 102 or STA 104 may use a second RSSI detection threshold in lieu of using the first RSSI detection threshold when performing the CCA on the wireless channel, the second RSSI detection threshold being greater than the first RSSI detection threshold. In this way, the criteria for winning contention are relaxed when interfering transmissions are associated with an OBSS.

Some APs and STAs (such as the AP 102 and the STAs 104 described with reference to FIG. 1) may implement techniques for spatial reuse that involve participation in a coordinated communication scheme. According to such techniques, an AP 102 may contend for access to a wireless medium to obtain control of the medium for a TXOP. The AP that wins the contention (hereinafter also referred to as a “sharing AP”) may select one or more other APs (hereinafter also referred to as “shared APs”) to share resources of the TXOP. The sharing and shared APs may be located in proximity to one another such that at least some of their wireless coverage areas at least partially overlap. Some examples may specifically involve coordinated AP TDMA or OFDMA techniques for sharing the time or frequency resources of a TXOP. To share its time or frequency resources, the sharing AP may partition the TXOP into multiple time segments or frequency segments each including respective time or frequency resources representing a portion of the TXOP. The sharing AP may allocate the time or frequency segments to itself or to one or more of the shared APs. For example, each shared AP may utilize a partial TXOP assigned by the sharing AP for its uplink or downlink communications with its associated STAs.

In some examples of such TDMA techniques, each portion of a plurality of portions of the TXOP includes a set of time resources that do not overlap with any time resources of any other portion of the plurality of portions of the TXOP. In such examples, the scheduling information may include an indication of time resources, of multiple time resources of the TXOP, associated with each portion of the TXOP. For example, the scheduling information may include an indication of a time segment of the TXOP such as an indication of one or more slots or sets of symbol periods associated with each portion of the TXOP such as for multi-user TDMA.

In some examples of OFDMA techniques, each portion of the plurality of portions of the TXOP includes a set of frequency resources that do not overlap with any frequency resources of any other portion of the plurality of portions. In such examples, the scheduling information may include an indication of frequency resources, of multiple frequency resources of the TXOP, associated with each portion of the TXOP. For example, the scheduling information may include an indication of a bandwidth portion of the wireless channel such as an indication of one or more subchannels or resource units associated with each portion of the TXOP such as for multi-user OFDMA.

In this manner, the sharing AP's acquisition of the TXOP enables communication between one or more additional shared APs and their respective BSSs, subject to appropriate power control and link adaptation. For example, the sharing AP may limit the transmit powers of the selected shared APs such that interference from the selected APs does not prevent STAs associated with the TXOP owner from successfully decoding packets transmitted by the sharing AP. Such techniques may be used to reduce latency because the other APs may not need to wait to win contention for a TXOP to be able to transmit and receive data according to conventional CSMA/CA or enhanced distributed channel access (EDCA) techniques. Additionally, by enabling a group of APs 102 associated with different BSSs to participate in a coordinated AP transmission session, during which the group of APs may share at least a portion of a single TXOP obtained by any one of the participating APs, such techniques may increase throughput across the BSSs associated with the participating APs and also may achieve improvements in throughput fairness. Furthermore, with appropriate selection of the shared APs and the scheduling of their respective time or frequency resources, medium utilization may be maximized or otherwise increased while packet loss resulting from OBSS interference is minimized or otherwise reduced. Various implementations may achieve these and other advantages without requiring that the sharing AP or the shared APs be aware of the STAs 104 associated with other BSSs, without requiring a preassigned or dedicated master AP or preassigned groups of APs, and without requiring backhaul coordination between the APs participating in the TXOP.

In some examples in which the signal strengths or levels of interference associated with the selected APs are relatively low (such as less than a given value), or when the decoding error rates of the selected APs are relatively low (such as less than a threshold), the start times of the communications among the different BSSs may be synchronous. Conversely, when the signal strengths or levels of interference associated with the selected APs are relatively high (such as greater than the given value), or when the decoding error rates of the selected APs are relatively high (such as greater than the threshold), the start times may be offset from one another by a time period associated with decoding the preamble of a wireless packet and determining, from the decoded preamble, whether the wireless packet is an intra-BSS packet or is an OBSS packet. For example, the time period between the transmission of an intra-BSS packet and the transmission of an OBSS packet may allow a respective AP (or its associated STAs) to decode the preamble of the wireless packet and obtain the BSS color value carried in the wireless packet to determine whether the wireless packet is an intra-BSS packet or an OBSS packet. In this manner, each of the participating APs and their associated STAs may be able to receive and decode intra-BSS packets in the presence of OBSS interference.

In some examples, the sharing AP may perform polling of a set of un-managed or non-co-managed APs that support coordinated reuse to identify candidates for future spatial reuse opportunities. For example, the sharing AP may transmit one or more spatial reuse poll frames as part of determining one or more spatial reuse criteria and selecting one or more other APs to be shared APs. According to the polling, the sharing AP may receive responses from one or more of the polled APs. In some specific examples, the sharing AP may transmit a coordinated AP TXOP indication (CTI) frame to other APs that indicates time and frequency of resources of the TXOP that can be shared. The sharing AP may select one or more candidate APs upon receiving a coordinated AP TXOP request (CTR) frame from a respective candidate AP that indicates a desire by the respective AP to participate in the TXOP. The poll responses or CTR frames may include a power indication, for example, a receive (RX) power or RSSI measured by the respective AP. In some other examples, the sharing AP may directly measure potential interference of a service supported (such as UL transmission) at one or more APs, and select the shared APs based on the measured potential interference. The sharing AP generally selects the APs to participate in coordinated spatial reuse such that it still protects its own transmissions (which may be referred to as primary transmissions) to and from the STAs in its BSS. The selected APs may be allocated resources during the TXOP as described above.

In some implementations, the AP 102 and STAs 104 can support various multi-user communications; that is, concurrent transmissions from one device to each of multiple devices (such as multiple simultaneous downlink communications from an AP 102 to corresponding STAs 104), or concurrent transmissions from multiple devices to a single device (such as multiple simultaneous uplink transmissions from corresponding STAs 104 to an AP 102). As an example, in addition to MU-MIMO, the AP 102 and STAs 104 may support OFDMA. OFDMA is in some aspects a multi-user version of OFDM.

In OFDMA schemes, the available frequency spectrum of the wireless channel may be divided into multiple resource units (RUs) each including multiple frequency subcarriers (also referred to as “tones”). Different RUs may be allocated or assigned by an AP 102 to different STAs 104 at particular times. The sizes and distributions of the RUs may be referred to as an RU allocation. In some examples, RUs may be allocated in 2 MHz intervals, and as such, the smallest RU may include 26 tones consisting of 24 data tones and 2 pilot tones. Consequently, in a 20 MHz channel, up to 9 RUs (such as 2 MHz, 26-tone RUs) may be allocated (because some tones are reserved for other purposes). Similarly, in a 160 MHz channel, up to 74 RUs may be allocated. Other tone RUs also may be allocated, such as 52 tone, 106 tone, 242 tone, 484 tone and 996 tone RUs. Adjacent RUs may be separated by a null subcarrier (such as a DC subcarrier), for example, to reduce interference between adjacent RUs, to reduce receiver DC offset, and to avoid transmit center frequency leakage.

For UL MU transmissions, an AP 102 can transmit a trigger frame to initiate and synchronize an UL OFDMA or UL MU-MIMO transmission from multiple STAs 104 to the AP 102. Such trigger frames may thus enable multiple STAs 104 to send UL traffic to the AP 102 concurrently in time. A trigger frame may address one or more STAs 104 through respective association identifiers (AIDs), and may assign each AID (and thus each STA 104) one or more RUs that can be used to send UL traffic to the AP 102. The AP also may designate one or more random access (RA) RUs that unscheduled STAs 104 may contend for.

In some environments, locations, or conditions, a regulatory body may impose a power spectral density (PSD) limit for one or more communication channels or for an entire band (such as the 6 GHz band). A PSD is a measure of transmit power as a function of a unit bandwidth (such as per 1 MHz). The total transmit power of a transmission is consequently the product of the PSD and the total bandwidth by which the transmission is sent. Unlike the 2.4 GHz and 5 GHz bands, the United States Federal Communications Commission (FCC) has established PSD limits for low power devices when operating in the 6 GHz band. The FCC has defined three power classes for operation in the 6 GHz band: standard power, low power indoor, and very low power. Some APs 102 and STAs 104 that operate in the 6 GHz band may conform to the low power indoor (LPI) power class, which limits the transmit power of APs 102 and STAs 104 to 5 decibel-milliwatts per megahertz (dBm/MHz) and −1 dBm/MHz, respectively. In other words, transmit power in the 6 GHz band is PSD-limited on a per-MHz basis.

Such PSD limits can undesirably reduce transmission ranges, reduce packet detection capabilities, and reduce channel estimation capabilities of APs 102 and STAs 104. In some examples in which transmissions are subject to a PSD limit, the AP 102 or the STAs 104 of a wireless communication network 100 may transmit over a greater transmission bandwidth to allow for an increase in the total transmit power, which may increase an SNR and extend coverage of the wireless communication devices. For example, to overcome or extend the PSD limit and improve SNR for low power devices operating in PSD-limited bands, 802.11be introduced a duplicate (DUP) mode for a transmission, by which data in a payload portion of a PPDU is modulated for transmission over a “base” frequency sub-band, such as a first RU of an OFDMA transmission, and copied over (such as duplicated) to another frequency sub-band, such as a second RU of the OFDMA transmission. In DUP mode, two copies of the data are to be transmitted, and, for each of the duplicate RUs, using dual carrier modulation (DCM), which also has the effect of copying the data such that two copies of the data are carried by each of the duplicate RUs, so that, for example, four copies of the data are transmitted. While the data rate for transmission of each copy of the user data using the DUP mode may be the same as a data rate for a transmission using a “normal” mode, the transmit power for the transmission using the DUP mode may be essentially multiplied by the number of copies of the data being transmitted, at the expense of requiring an increased bandwidth. As such, using the DUP mode may extend range but reduce spectrum efficiency.

In some other examples in which transmissions are subject to a PSD limit, a distributed tone mapping operation may be used to increase the bandwidth via which a STA 104 transmits an uplink communication to the AP 102. As used herein, the term “distributed transmission” refers to a PPDU transmission on noncontiguous tones (or subcarriers) of a wireless channel. In contrast, the term “contiguous transmission” refers to a PPDU transmission on contiguous tones. As used herein, a logical RU represents a number of tones or subcarriers that are allocated to a given STA 104 for transmission of a PPDU. As used herein, the term “regular RU” (or rRU) refers to any RU or MRU tone plan that is not distributed, such as a configuration supported by 802.11be or earlier versions of the IEEE 802.11 family of wireless communication protocol standards. As used herein, the term “distributed RU” (or dRU) refers to the tones distributed across a set of noncontiguous subcarrier indices to which a logical RU is mapped. The term “distributed tone plan” refers to the set of noncontiguous subcarrier indices associated with a dRU. The channel or portion of a channel within which the distributed tones are interspersed is referred to as a spreading bandwidth, which may be, for example, 40 MHz, 80 MHz or more. The use of dRUs may be limited to uplink communications because benefits to addressing PSD limits may only be present for uplink communications.

An example AI/ML model may include mathematical representations or define computing capabilities for making inferences from input data based on patterns or relationships identified in the input data. As used herein, the term “inferences” can include one or more of decisions, predictions, determinations, or values, which may represent outputs of the AI/ML model. The computing capabilities may be defined in terms of certain parameters of the AI/ML model, such as weights and biases. Weights may indicate relationships between certain input data and certain outputs of the AI/ML model, and biases are offsets that may indicate a starting point for outputs of the AI/ML model. An example AI/ML model operating on input data may start at an initial output based on the biases and then update the output based on a combination of the input data and the weights.

STAs or APs (such as a STA 104 or an AP 102) may exchange local observations with other wireless communication devices (such as other STAs or APs) or provide feedback related to the communication. This may significantly expand the types of input data that can be considered as input to an AI/ML model, as such information may not otherwise be available at the other wireless communication devices. For example, information received from other STAs or APs may include observed RSSI values, experienced packet success/failure/retry rates per client/AP, BSS/Quality of Service (QoS) load/requirements, or a history of bad/good AP link(s), which may be conveyed in terms of scores or rankings.

FIGS. 4A, 4B, 4C, 4D, and 4E show examples of communication flows 400 that support NPCA coordination. One or more aspects of the communication flows 400 may implement or be implemented by aspects of FIG. 1-3. For example, the communication flows 400 may include wireless communication devices 450 (such as a wireless communication device 450-a and a wireless communication device 450-b, examples of the APs 102, the STAs 104, eMLSR APs, non-AP MLDs, or any combination thereof), a first channel 402 (an example of the M-primary channel, a primary link in an eMLSR AP system), and a second channel 404 (an example of an O-primary channel or any other non-primary channel, a non-primary link in an eMLSR AP system). The communication flows 400 may illustrate the wireless communication devices 450 communicating or detecting signaling on the first channel 402 and the second channel 404. For example, the communication flows 400 may include transmitted signaling, received signaling, and channel busy times (such as OBSS NAVs 406, based on detected PPDUs from an OBSS indicating a NAV). Each of the FIG. 4A-4E may illustrate an exemplary technique for NPCA coordination, where the techniques described in any of the FIG. 4A-4E may be combined or utilized in combination with techniques describes in one or more other of the FIG. 4A-4E.

Some wireless communication networks may support relatively large frequency bandwidths. For example, a wireless communication network (such as an EHT network, an IEEE 802.11be network, a Wi-Fi 7 network, among other examples) may support a bandwidth up to 320 MHz. In some examples, a first channel 402 of the bandwidth may be designated as a primary channel (such as a main primary channel, M-primary channel), where the wireless communication devices 450 of the wireless communication network may contend for access on the first channel 402 (such as only on the first channel 402). For example, the first channel 402 may be a primary channel referred to as a main primary channel (such as an M-primary channel), and additional non-primary channels in the bandwidth (including the second channel 404) may be referred to as opportunistic primary channels (O-primary channels). In some examples, access to the additional NPCA channels may be contingent on access to the first channel 402. In some wireless communication networks, if a wireless communication device (such as a STA) from a second BSS (such as an OBSS) occupies the first channel 402 (indicated by an OBSS NAV 406), a wireless communication device 450 from a first BSS may not be able to utilize the non-primary channels, which may contribute to lower-throughput and longer latencies in the wireless communication network.

In some examples, the wireless communication network may include NPCA wireless communication devices (such as wireless communication devices capable of accessing non-primary channels when the primary channel is busy, such as the wireless communication devices 450). For example, the wireless communication devices 450 (such as a UHR device) may be capable of monitoring at least the second channel 404 (such as other channels, 20 MHz non-primary channels) within the bandwidth (such as an operating bandwidth) of the wireless communication network while the first channel 402 is busy (such as during the OBSS NAV 406).

Monitoring of the first channel 402 and the second channel 404 (and any other non-primary channels) may be sequential or in parallel. For example, (in sequential monitoring), a wireless communication device 450 may be capable of monitoring one channel at a time, and may default to monitoring (contending) on the first channel 402. When the wireless communication device 450 detects the OBSS NAV 406 for the first channel 402, the wireless communication device 450 may switch its operation to the second channel 404 and monitor (contend) on the second channel 404). Additionally, or alternatively, (in parallel monitoring), a wireless communication device 450 may monitor (contend on) the first channel 402 and the second channel 404 concurrently. For example, the wireless communication device may detect communications (such as monitor for PPDUs) on multiple channels concurrently, but may transmit or receive (fully decode) communication on one channel (such as either the first channel 402 or the second channel 404) a time.

A wireless communication device 450 may switch the operation of the wireless communication device 450 (its operation) from one channel (such as the first channel 402) to another channel (such as the second channel 404, or vice versa). For example, switching the operation of the wireless communication device 450 from one channel to another channel may include configuring or adjusting parameters of the wireless communication device 450 (such as antenna parameters, beamforming parameters for reception or transmission) to operate on, monitor, or communicate via the other channel. Software (such as code), hardware (such as an antenna array, decoders), or both, of the wireless communication device 450 may perform the switching of the operation of the wireless communication device 450 from one channel to another. Switching the operation of a wireless communication device 450 may be referred to herein simply as switching between channels, switching from a channel, switching to a channel, switching back to a channel, changing channels, returning to a channel, performing a switching operation, a switch 408, a switch 410, a switch 422, and/or a switch 424, among other examples. Additionally, a wireless communication device that is operating “on,” remaining “on,” or communicating “via” a channel may have the parameters adjusted or configured to monitor operate according to the channel.

In some examples, a wireless communication device 450 may switch back and forth between the first channel 402 and the second channel 404. For example, if the wireless communication device 450 detects that a wireless communication device of an OBSS is utilizing the first channel 402 (detects one or more PPDUs associated with the OBSS on the first channel 402, which may indicate an OBSS NAV 406 for the first channel 402), the wireless communication device 450 may switch to the second channel 404. In some examples, the wireless communication device 450 may remain on the second channel 404 for at least a portion of the OBSS NAV 406 (such as during OBSS activity on the first channel 402, which it determines from a duration of the OBSS NAV 406 or a PPDU that indicates the OBSS NAV 406). In some examples, the wireless communication device 450 may switch back to the first channel 402 within a defined period before the OBSS NAV 406 ends in order to utilize the first channel 402 when the first channel 402 becomes idle (such as when the OBSS NAV 406 ends). For example, if the wireless communication device 450 is an AP, the AP may switch from the second channel 404 to the first channel 402 before the end of the OBSS NAV 406 to be available to serve non-NPCA STAs (such as legacy STAs).

In some examples, whether a wireless communication device 450 switches channels may be based on local conditions. For example, each of the wireless communication devices 450 may have a localized view of OBSS activity on the first channel, second channel, or both, based on the location of the wireless communication device 450 and a proximity of the wireless communication device 450 to member-devices of OBSSs. The wireless communication device 450 may use the localized view to determine when to switch to and from (how long to stay on) the second channel 404.

In some examples, local conditions may vary for different wireless communication devices 450. For example, the wireless communication device 450-a and the wireless communication device 450-b may observe different OBSS NAVs 406 (such as an OBSS NAV 406-a and an OBSS NAV 406-b, respectively, based on detected PPDUs or TXOPs, an asymmetric view). Additionally, or alternatively, OBSS activity may be visible to one wireless communication device 450 and not to the other (such as described with respect to the communication flow 400-e, a hidden node). Because a duration during which the first channel 402 is determined to be busy (and a timing for switching to and from the second channel 404) may be different for the wireless communication device 450-a and the wireless communication device 450-b (a lack of NPCA coordination), the wireless communication device 450-a may return to the first channel 402 sooner than the wireless communication device 450-b, and the wireless communication device 450-a may attempt to communication with the wireless communication device 450-b via the first channel 402 while the wireless communication device 450-b is not on the first channel 402 (which may be known as a race condition).

Techniques of the present disclosure may improve NPCA coordination between the wireless communication devices 450 and reduce or remove such race conditions. In some examples (if the wireless communication device 450-a and the wireless communication device 450-b detect different OBSS NAVs 406 on the first channel 402, an asymmetric view issue), the wireless communication device 450-a may communicate its return to the first channel 402 (such as described with respect to the communication flows 400-a, 400-b, and 400-c). For example, the wireless communication device 450-a may send a switching indication 444 (an indication, either as an explicit frame or within another frame such as an ICF 412) that indicates that the wireless communication device 450-a is switching (imminently or at a predetermined time) to the first channel 402, or the wireless communication device 450-a may send an indication of a duration for which the wireless communication device 450-a will be on the second channel 404 (such as an indication of a time at which the wireless communication device 450-a will switch to the first channel 402). In some other examples (if the wireless communication device 450-b detects an OBSS NAV 406 on the first channel 402 and the wireless communication device 450-b does not, a hidden node issue), the wireless communication device 450-b may return to the first channel 402 after a predetermined condition (such as described with respect to communication flow 400-d). For example, after a threshold quantity of attempts to communicate with the wireless communication device 450-a using ICFs 412 (such as NPCA ICFs) or after expiration of a timer value (without receiving responses or attempts for communication), the wireless communication device 450-b may switch from the second channel 404 to the first channel 402. In yet other examples, a wireless communication device 450 may switch from the second channel 404 to the first channel 402 if the wireless communication device 450-a detects that an OBSS NAV 406-c associated with the second channel 404 is longer than the OBSS NAV 406-a associated with the first channel 402 (such as described with respect to communication flow 400-e).

Regarding the communication flows 400-a and 400-b, the wireless communication device 450-a (which may be an AP 102 is some examples) may send a switching indication 444 (such as an indication, an announcement frame 420, an indication within one or more other frames) to the wireless communication device 450-b via the second channel 404 before the wireless communication device 450-a switches back to the first channel 402. For example, the wireless communication device 450-a may switch 410 from the first channel 402 to the second channel 404 at a different time than the wireless communication device 450-b may switch 408 based on detecting different OBSS NAVs 406 (such as OBSS NAV 406-a and OBSS NAV 406-b, respectively). For example, the wireless communication device 450-b may detect the OBSS NAV 406-b before the wireless communication device 450-a detects the OBSS NAV 406-a (or vice versa) due to the OBSS NAVs 406 being associated with different OBSSs, different wireless communication devices, different PPDUs, or a combination thereof.

If the wireless communication device 450-b (which may be a STA in some examples) detects (receives) at least one frame transmitted from the wireless communication device 450-a via the second channel 404 after the switch 408, the wireless communication device 450-b may remain on the second channel 404 until the wireless communication device 450-b receives (such as hears, detects, or decodes) the switching indication 444 from the wireless communication device 450-a via the second channel 404. In some examples, the at least one frame detected on the second channel 404 may be a frame from the wireless communication device 450-a to initiate communications (such as the ICF 412), or a response frame from the wireless communication device 450-a (such as an ICR 414 transmitted by the wireless communication device 450-a). In some examples, the response frame may be directed to the wireless communication device 450-b or another wireless communication device in a same BSS as the wireless communication devices 450-a and 450-b.

The wireless communication devices 450-a and 450-b may communicate one or more frames via the second channel 404. For example, the wireless communication device 450-a may transmit (and the wireless communication device 450-b may receive) an ICF 412, and the wireless communication device 450-b may transmit (and the wireless communication device 450-a may receive) an ICR 414 in response to the ICF 412. The wireless communication device 450-a may transmit (and the wireless communication device 450-b may receive) a PPDU 416 in response to the ICR 414. In some examples, the PPDU 416 may solicit an immediate response (such as the BA 418), which the wireless communication device 450-b may transmit to the wireless communication device 450-a. In some examples, the switching indication 444 may be included in a frame that is unassociated with (may not solicit) a response from the wireless communication device 450-b.

Regarding the communication flow 400-a, the switching indication 444 from the wireless communication device 450-a may be an explicit indication. For example, the explicit indication may be an announcement frame 420 (such as an NPCA switch back announcement frame), in which the announcement frame 420 may be one or more different frames. For example, the announcement frame 420 may include a control frame (CF)-end frame that includes the switching indication 444, a clear-to-send (CTS)-to-self frame that includes the switching indication 444 (such as a Duration/ID field set to “0”), a multiple-STA BA that includes a Per AID transmission identifier (TID) field that includes the switching indication 444, a QoS null frame or a QoS Data frame that includes an aggregate-control (a-control) field in a MAC header that includes the switching indication 444 (such as by carrying a specified value), a null management frame that includes the switching indication 444, an action frame that includes the switching indication 444, and or a frame indicating an end of service period (EOSP) set to “1”(such as to include the switching indication 444).

In some examples, the announcement frame 420 (such as the explicit indication) may solicit an immediate response (not shown) from the wireless communication device 450-b. For example, the announcement frame 420 may be a trigger frame, a final QoS data frame, and/or a management frame in a TXOP. In some examples, if the announcement frame 420 solicits the response from the wireless communication device 450-b, the wireless communication device 450-b may transmit an acknowledgment (such as a BA, a PPDU, not shown) to the wireless communication device 450-a in response to receiving the announcement frame 420. Additionally, or alternatively, the announcement frame 420 may not solicit an immediate response from the wireless communication device 450-b.

Regarding the communication flow 400-b, the switching indication 444 may be included in one or more other frames transmitted from the wireless communication device 450-a via the second channel 404. For example, the indication may be included in the ICF 412 or the PPDU 416 (or the ICR 414 or the BA 418, if the wireless communication device 450-b transmits the indication to switch). In some examples, the switching indication 444 may be a set of one or more bits included in the one or more frames to indicate that the wireless communication device 450-a will switch from the second channel 404 to the first channel 402. The one or more frames including the indication (such as the PPDU 416) may solicit an immediate response from the wireless communication device 450-b (such as the BA 418), which the wireless communication device 450-b may transmit to the wireless communication device 450-a. In some examples, the immediate response may indicate that the wireless communication device 450-b received the indication and will switch to the first channel 402 with the wireless communication device 450-a,

In communication flows 400-a and 400-b, the wireless communication devices 450-a and 450-b may initiate a switch 422 and a switch 424, respectively, from the second channel 404 to the first channel 402 in response to transmitting or receiving the switching indication 444 (such as the announcement frame 420 or the one or more frames that include the switching indication 444), or in response to receiving or transmitting the immediate response to the indication. In some examples, the wireless communication devices 450-a and 450-b may be available to transmit or receive frames on the first channel 402 within a duration 426 (such as before the end of the duration 426), in which the duration 426 may be known as a switch back delay. In some examples, the duration 426 may start from the end of transmission or reception of the switching indication 444 (such as the announcement frame 420 or another frame carrying the indication) or the end of transmitting or receiving the immediate response to the indication (such as the BA 418). In some examples, a buffer period (such as a SlotTime, not shown) may be added to the duration 426 to allow time for the wireless communication device 450-b to process the switching indication 444.

Regarding the communication flow 400-c, the switches 408 and 410, the OBSS NAVs 406, and the one or more frames (such as the ICF 412, the ICR 414, the PPDU 416, the BA 418, the PPDU 428, and the BA 430), may be similar to such components of the communication flows 400-a and 400-b. In the communication flow 400-c, however, the wireless communication device 450-a may indicate, via the second channel 404 (within one or more frames), a time 434 at which the wireless communication device 450-a may switch from the second channel 404 to the first channel 402 (a duration 432 until which the wireless communication device 450-a may remain on the second channel 404, instead of or in addition to the switching indication 444). If the wireless communication device 450-b receives at least one frame from the wireless communication device 450-a on the second channel 404 after the switch 408, the wireless communication device 450-b may remain on the second channel 404 until the time 434 (such as through the duration 432) indicated by the wireless communication device 450-a. In some examples, the at least one frame may be a frame from the wireless communication device 450-a to initiate communications (such as the ICF 412), or a response frame from the wireless communication device 450-a (such as an ICR 414 transmitted by the wireless communication device 450-a). In some examples, the response frame may be directed to the wireless communication device 450-b or another wireless communication device in a same BSS as the wireless communication devices 450-a and 450-b.

In some aspects, the wireless communication device 450-a may include the indication of the time 434 (or the duration 432) in a subset of the one or more frames (such as in the ICF 412 or ICR 414 frames) or in all of the one or more frames transmitted via the second channel 404. For example, the indication may be in a Special User Info field of a trigger frame (such as in the ICF 412), an AID-TID field of a Multi-TID BA frame (such as the ICR 414), a Duration/ID field of one or more frames transmitted via the second channel 404, and/or an a-control field of a MAC header of the one or more frames. For example, the wireless communication device 450-a (that attempts to initiates a TXOP on the second channel 404 via the ICF 412) may use a multiple protection NAV setting to set a NAV value in all frames transmitted via the second channel 404 to indicate the time at which the device will switch back to the first channel 402.

In some examples, the wireless communication device 450-a may indicate the time 434 (or the duration 432) in one or more manners. For example, the time 434 may be indicates as a value associated with a time synchronization function (TSF) (such as an absolute time). In some examples, the TSF may be associated with a set of bits (such as 64 bits), and the indication of the time 434 may include a value for a quantity of least significant bits (a subset) of the set of bits (such as the 8 least significant bits of the TSF, the 16 least significant bits of the TSF) to reduce a size of the indication. Additionally, or alternatively, the time 434 (or the duration 432) may be indicates as a time remaining from the end of a frame that includes the indication of the time 434 (such as the ICF 412, similar to NAV signaling).

At the time 434 (such as at the end of the duration 432), the wireless communication devices 450-a and 450-b may initiate the switches 422 and 424, respectively, from the second channel 404 to the first channel 402. Similar to the communication flows 400-a and 400-b, the wireless communication devices 450-a and 450-b may become available for transmission and reception on the first channel 402 within the duration 426 (such as the switch back delay), which may begin at the time 434, and the buffer period (not shown) may be added to the duration 426.

In some examples of communication flows 400-a, 400-b, and 400-c, the OBSS NAV 406-a may be longer than (extend past the end of) the OBSS NAV 406-b (not shown in the communication flows 400-a, 400-b, and 400-c). The techniques described also may apply in such examples. For example, if the wireless communication device 450-a is an AP 102 and the OBSS NAV 406-a is longer than the OBSS NAV 406-b, the wireless communication device 450-b (which may be a STA 104) may remain on the second channel 404 even if the first channel 402 is idle due to a later switching indication 444 or time indicated by the wireless communication device 450-a. For example, because a STA 104 may not provide signaling for other STAs 104, the STA 104 may remain on the second channel 404 instead of switching to the first channel 402 upon expiration of the OBSS NAV 406-b based on the switching indication 444 or time indicated by the wireless communication device 450-a. Additionally, or alternatively, if a STA 104 provides signaling for other STAs 104 and the OBSS NAV 406 detected by an AP is longer than the OBSS NAV 406 detected by a STA 104, the STA 104 and the AP 102 may perform a negotiation for a TXOP duration in the exchange of the ICF 412 and the ICR 414 via the second channel 404. Additionally, instead of the wireless communication device 450-a (such as an AP 102) announcing its return to the first channel 402 via the indication or the time 434, the wireless communication device 450-b (such as an NPCA non-AP STA) may transmit the switching indication 444 or the indication of the time 434 to the wireless communication device 450-a.

After the switches 422 and 424, the wireless communication devices 450-a and 450-b may communicate via the first channel 402. For example, the wireless communication device 450-a may transmit a PPDU 428 to the wireless communication device 450-b via the first channel 402, and the wireless communication device 450-b may transmit a BA 430 to the wireless communication device 450-a via the first channel. In some examples, the wireless communication devices 450-a and 450-b may communicate the PPDU 428 and the BA 430 during the OBSS NAV 406-b. That is, even though the OBSS NAV 406-b may extend past the switch 424, the wireless communication device 450-b may transmit the BA 430 to the wireless communication device 450-a in response to the PPDU 428 (because the wireless communication device 450-b may not perform a CCA to transmit the BA 430).

If an interference at the wireless communication device 450-b from the OBSS associated with the OBSS NAV 406-b is stronger than a threshold interference (such as determined by the wireless communication device 450-a and/or the wireless communication device 450-b), the wireless communication device 450-a may employ techniques to ensure successful reception of the PPDU 428 at the wireless communication device 450-a via the first channel 402. In some examples, the wireless communication device 450-a may use a relatively robust MCS (such as an MCS with one spatial stream, NSS=1) to transmit the PPDU 428 to the wireless communication device 450-b via the first channel 402. Additionally, or alternatively, the wireless communication device 450-a may initiate an exchange of ready to send (RTS) and CTS frames (similar to the ICF 412 and ICR 414) to check a NAV status or interference level of the wireless communication device 450-b with regard to the OBSS NAV 406-b. Additionally, or alternatively, the wireless communication device 450-a may include (exclusively include) traffic that has a QoS parameter (such as a latency parameter) that satisfies a threshold (that is lower than a latency threshold, such that the traffic may be transmitted relatively quickly) within the PPDU 428.

In some examples, the BA 430 may communicate NPCA coordination information to the wireless communication device 450-a. For example, the BA 430 (such as a response frame solicited by the PPDU 428) may indicate whether the wireless communication device 450-b switched from the second channel 404 to the first channel 402 due to an expiration of the OBSS NAV 406-b, due to the switching indication 444 or indicated time 434 from the wireless communication device 450-a, or both. In some examples, such information may be included in an AID-TID field of a multi-TID BA frame (such as such as the BA 430), an a-control field of a MAC header of a data frame, and or an a-control field of MAC header of a management frame. In some examples, such information may enable the wireless communication device 450-a to return to a “normal” mode (to stop employing the techniques to overcome the interference associated with the OBSS NAV 406-b) on the first channel 402.

In some examples, the wireless communication device 450-a may communicate a threshold duration (such as an NPCA switch threshold) to the wireless communication device 450-b (such as by including an indication of a value of the duration in beacon frames or probe response frames), and the wireless communication devices 450-a and 450-b may switch to the second channel 404 if a length of the OBSS NAVs 406 (a duration of OBSS activity on the first channel 402) is greater than the threshold duration. In some examples, the wireless communication device 450-a (such as an AP 102) may select a value (such as a time length) of the threshold duration, or one or more wireless standards may define the value of the threshold duration. For example, the wireless communication device 450-a may set the value of the threshold duration such that a threshold quantity of PPDUs 416 (such as one PPDU 416, a PPDU of a nominal duration), associated response frame(s) (such as the BA 418), associated ICF(s) 412, and/or associated ICR(s) 414 may be exchanged between the wireless communication device 450-a and the wireless communication device 450-b via the second channel 404 during the OBSS NAV 406 of at least the threshold duration. That is, a value of the threshold duration (such as a minimum value of a NPAC switching threshold) may be set to cover a TXOP duration, which may account for the ICF 412, the ICR 414, the PPDU 416 (a single PPDU), and an immediate response to the PPDU 416 (such as the BA 418). As an example, the value of the threshold duration may be 500 microseconds (μs).

The communication flow 400-d may illustrate an example in which the wireless communication device 450-a may not detect an OBSS NAV 406 associated with the first channel 402 and the wireless communication device 450-b may detect the OBSS NAV 406-b associated with the first channel 402. In such an example, the wireless communication device 450-b may switch 408 to the second channel 404 based on detecting the OBSS NAV 406-b (such as detecting PPDUs associated with the OBSS on the first channel 402) and the wireless communication device 450-a may remain on the first channel 402. In some examples, the wireless communication device 450-b may implement one or more NPCA coordination techniques to more efficiently utilize communication resources and to save power associated with attempting to communicate with the wireless communication device 450-a via the second channel 404 if the wireless communication device 450-a is not on the second channel 404.

In some examples, the wireless communication device 450-b may attempt to initiate a TXOP (attempt to communicate) with the wireless communication device 450-a up to a threshold quantity of attempts before the wireless communication device 450-b switches 424 back to the first channel 402. For example, each attempt may include transmitting at least one ICF 412 (such as an ICF 412-a, an ICF 412-b, until an ICF 412-n). If the wireless communication device 450-b does not receive a response from the wireless communication device 450-a to the attempts to initiate the TXOP, the wireless communication device 450-b may switch 424 from the second channel 404 to the first channel 402. In some examples, to improve the chances of the wireless communication device 450-a receiving and responding to the ICFs 412, the wireless communication device 450-b may increase (double) a CW value after the transmission of each failed ICF 412 (each ICF 412 in response to which the wireless communication device 450-b does not receive a response).

In some examples, the wireless communication device 450-b may be an AP 102 and the wireless communication device 450-a may be a STA 104. In such examples, if the wireless communication device 450-a does not respond to the ICFs 412 after the threshold quantity of attempts, the wireless communication device 450-b may remain on the second channel 404 and perform up to the threshold quantity of attempts to initiate a TXOP with other wireless communication device 450 (such as a different STA 104 in the same BSS as the wireless communication device 450-b). For example, the wireless communication device 450-b may attempt the threshold quantity of attempts with each STA 104 within a BSS of the wireless communication device 450-b before the switch 424 back to the first channel 402.

The threshold quantity of attempts (threshold quantity of ICFs 412, threshold quantity of retries or retransmissions of the ICF 412) may be set in one or more manners. In some examples, the wireless communication device 450-b (if it is a STA 104) may receive an indication of the threshold quantity of attempts from an AP 102 associated with the wireless communication device 450-b. For example, the wireless communication device 450-b may receive beacon frames, association response frames, and/or frames to acknowledge the start of an NPCA mode (such as during NPCA mode enablement) which may indicate the threshold quantity of attempts. Additionally, or alternatively, the threshold quantity of attempts may differ for each wireless communication device 450-a (for each STA 104 in the BSS associated with the wireless communication device 450-b, based on a proximity of each STA 104 to the wireless communication device 450-b or an AP 102 of the BSS). Additionally, or alternatively, the wireless communication device 450-b (such as a STA 104 or an AP 102) may select (determine using an ML algorithm) the threshold quantity of attempts at any time for any wireless communication device 450 based on previous attempts to initiate TXOPs with the wireless communication device 450.

In another example illustrated by communication flow 400-d, the wireless communication device 450-b may attempt to initiate a TXOP (attempt to communicate) with the wireless communication device 450-a until an expiration of a timer 436 (such as at the end of a duration indicated by the timer 436). For example, after the switch 408 to the second channel 404, the wireless communication device 450-b may initialize the timer 436 to count for a duration. If the wireless communication device 450-b has not attempted to initiate a TXOP (by transmitting an ICF 412), has not received any attempts from the wireless communication device 450-a to initiate a TXOP, or has not received any responses to attempts to initiate the TXOP before expiration of the timer 436, the wireless communication device 450-b may switch back to the first channel 402 at the expiration of the timer 436 (at the end of the duration indicated by the timer 436). As an example, the wireless communication device 450-b may transmit any quantity of ICFs 412 while the timer 436 is running (there may not be a limit on a quantity of attempts to initiate the TXOP during the timer 436), and may switch 424 back to the first channel 402 if the wireless communication device 450-b does not receive a response to any ICFs 412 before expiration of the timer 436. Additionally, or alternatively, the wireless communication device 450-b may switch back to the first channel 402 if the wireless communication device 450-b has not transmitted any ICFs 412 before the expiration of the timer 436 or has not received any attempts to initiate a TXOP from another wireless communication device 450 before the expiration of the timer 436. Additionally, or alternatively, if the wireless communication device 450-b detects (such as receives) a frame from another wireless communication device 450 via the second channel 404 that is addressed a different wireless communication device 450 (such as other than the wireless communication device 450-b), the wireless communication device 450-b may remain on the second channel 404 until an end of the OBSS NAV 406-b (such as to monitor for other frames for the wireless communication device 450-b). Additionally, or alternatively, if the timer 436 expires before the wireless communication device 450-b initiates a TXOP, the wireless communication device 450-b (such as if it is an AP 102) may initiate another instance of the timer 436 and remain on the second channel 404 attempt to initiate a TXOP with another wireless communication device 450 until the other instance of the timer 436 expires. For example, the wireless communication device 450-b may initiate other sequential instances of the timer 436 and attempt to initiate TXOPs for each STA 104 associated with the wireless communication device 450-b or until an expiration of the OBSS NAV 406-b (whichever occurs first).

In some examples, a value (such as a length in time, an absolute time of the TSF) of the timer 436 may be set in one or more manners, similar to the one or more manners in which the threshold quantity of attempts may be set. For example, an AP 102 may indicate the value of the timer 436 to the wireless communication device 450-b, the wireless communication device 450-b may determine the value for the timer 436 a wireless communication device 450 based on previous attempts to initiate a TXOP with the wireless communication device 450 (such as using an ML algorithm), or both. Additionally, or alternatively, the wireless communication device 450-b may receive or determine different timer values for attempting to initiate TXOPs with different wireless communication devices 450,

The communication flow 400-e may illustrate an example in which the wireless communication device 450-a switches 410 to the second channel 404 in response to detecting an OBSS NAV 406-a on the first channel 402 and detects an OBSS NAV 406-c (detects PPDUs indicating the OBSS NAV 406-c, associated with the same OBSS or a different OBSS than is associated with the OBSS NAV 406-a) associated with the second channel 404. If the OBSS NAV 406-c extends past the end of the OBSS NAV 406-a (has a value or length that is greater than the OBSS NAV 406-a on the first channel 402), the wireless communication device 450-a may switch 422 back to the first channel 402. For example, the wireless communication device 450-a may not receive or respond to any ICF 412 via the second channel 404 during the OBSS NAV 406-c. Because the wireless communication device 450-a cannot communicate with other wireless communication devices 450 during the OBSS NAV 406-a on either the first channel 402 or the second channel 404, the wireless communication device 450-a may enter a sleep mode 438 (such as a power saving mode, a low power mode) at or after the switch 422 and for at least a portion of the OBSS NAV 406-a on the first channel 402. In some examples, the wireless communication device 450-a may exit the sleep mode 438 before or after the end of the OBSS NAV 406-a by an offset duration (not shown).

In some examples, the techniques discussed with reference to each of the communication flows 400-a, 400-b, 400-c, 400-d, and 400-e may be implemented independently or jointly. For example, a wireless communication device 450 may indicate the time 434 (such as the duration 432) until which it may remain on the second channel 404 (such as described with respect to communication flow 400-c) and may transmit a switching indication 444 before initiating the switch 422 to the first channel 402 (such as described with respect to the communication flows 400-a and 400-b). As another example, a wireless communication device 450 may attempt up to the threshold quantity of attempts to initiate a TXOP on the second channel 404 (such as described with respect to communication flow 400-d), and may transmit the switching indication 444 before the switch 422 to the first channel 402 (such as described with respect to communication flows 400-a and 400-b) if the attempts fail to initiate a TXOP on the second channel 404. These combinations are merely exemplary and are in no way limiting to the combinations of the techniques of the present disclosure.

Additionally, any of the techniques described with respect to FIG. 4A-4E may include communication of capability reporting and/or activation signaling. For example, the wireless communication devices 450 may transmit a capability report to another wireless communication device 450 or an AP indicating a capability to switch back to the first channel 402 based on the switching indication, the indicated time, the threshold quantity of attempts, the timer, and/or the relative lengths of the OBSS NAV 406-c and the OBSS NAV 406-a. Additionally, or alternatively, the wireless communication devices 450 may receive a message that activates the use of the switching indication, the indicated time, the threshold quantity of attempts, the timer, and/or the relative lengths of the OBSS NAV 406-c and the OBSS NAV 406-a for switching from the second channel 404 to the first channel 402.

By increasing NPCA coordination between wireless communication devices 450, wireless communication devices 450 may use less resources on the second channel 404 (such as an O-primary channel, any non-primary channel), save power by reducing transmissions and entering the sleep mode 438, and improve communication quality by accounting for OBSS interference after switching back from the second channel 404 to the first channel 402.

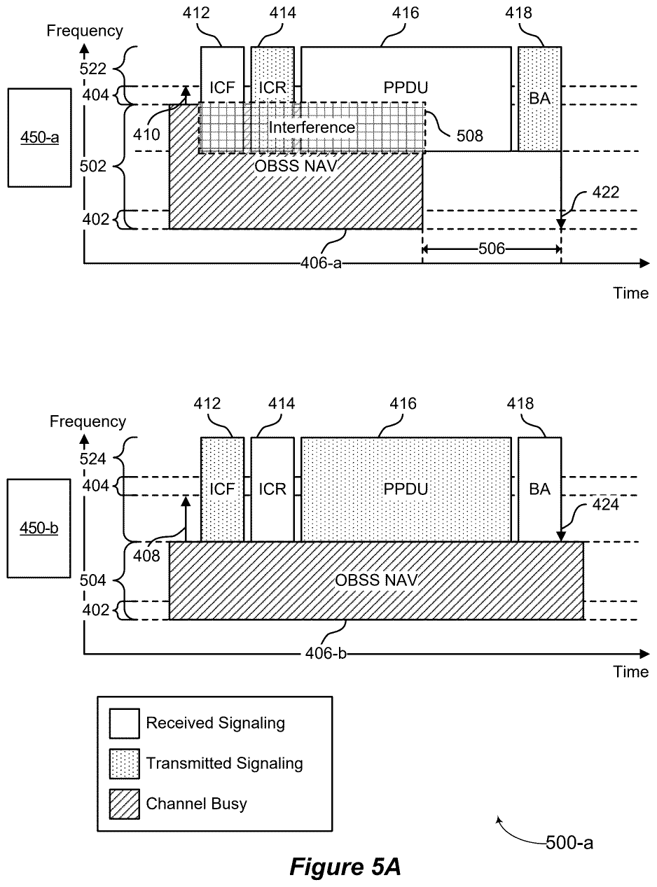

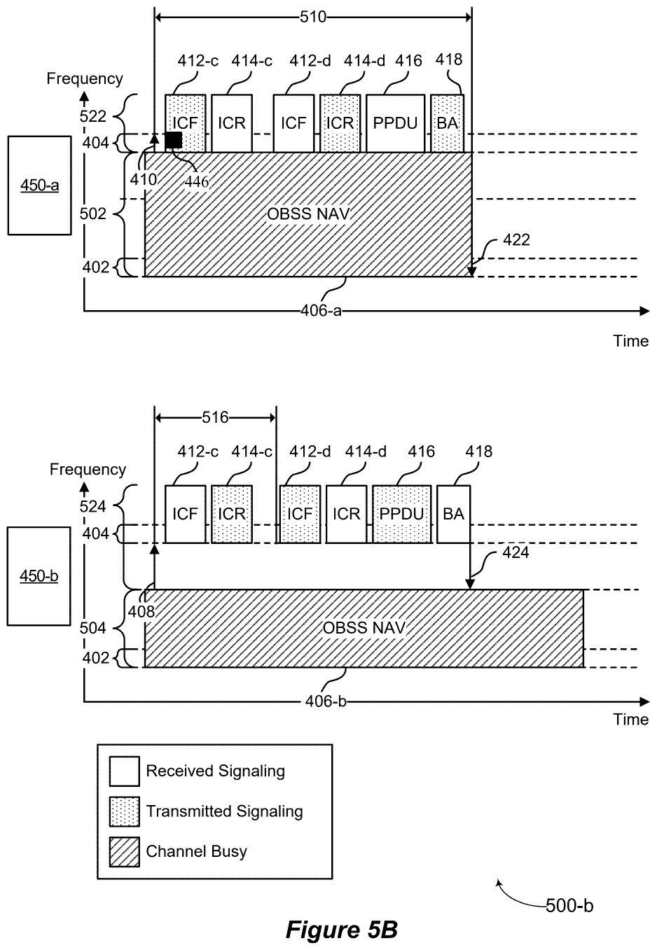

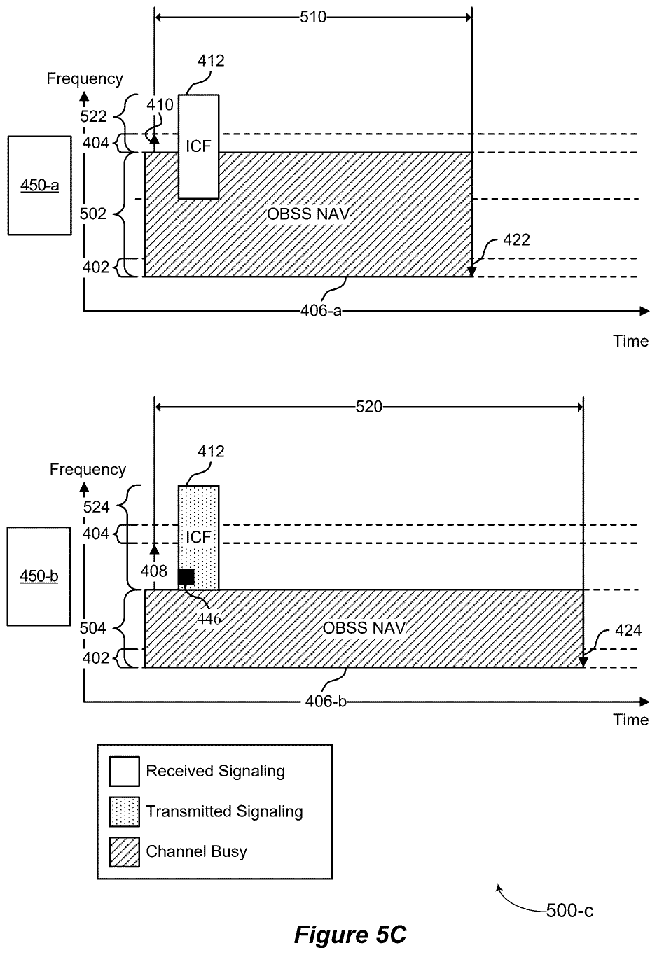

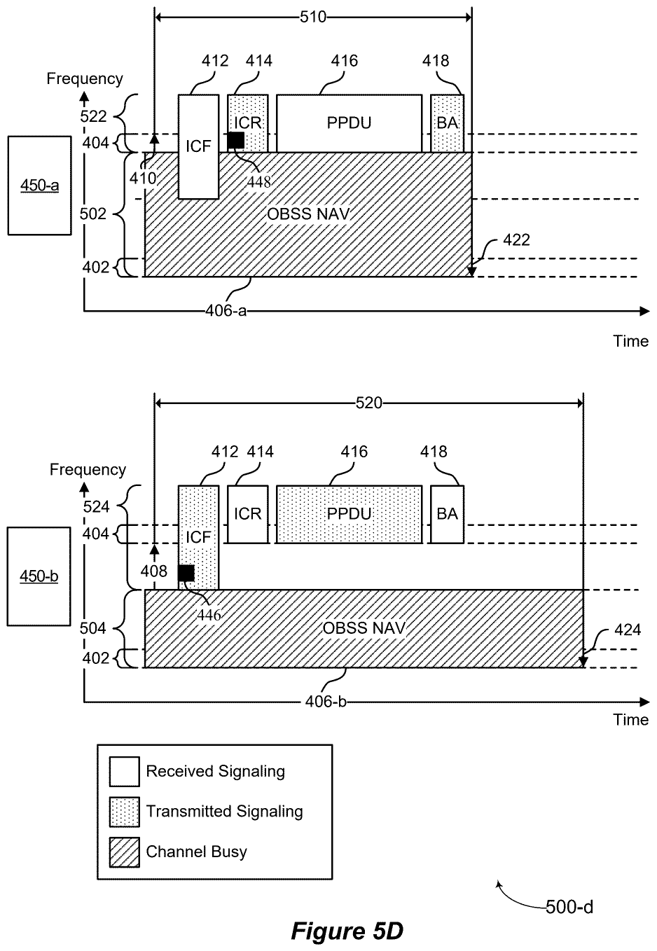

FIGS. 5A, 5B, 5C, and 5D show examples of communication flows 500 that support NPCA coordination. One or more aspects of the communication flows 500 may implement or be implemented by aspects of FIG. 1-4E. For example, the communication flows 500 may include wireless communication devices 450 (such as a wireless communication device 450-a and a wireless communication device 450-b, examples of the APs 102, the STAs 104, eMLSR APs, non-AP MLDs, or any combination thereof), a first channel 402 (an example of the M-primary channel, a primary link in an eMLSR AP system), and a second channel 404 (an example of an O-primary channel or any other non-primary channel, an NPCA primary channel, a non-primary link in an eMLSR AP system). Some components of the communications flows 500 (such as the ICF 412, the ICR 414, the PPDU 416, the BA 418, the OBSS NAVs 406, the switches 408, 410, 422, and 424, the first channel 402, the second channel 404) may be similar to and further described with respect to like components in FIG. 4A-4E. In some aspects, the communication flows 500 may illustrate the wireless communication devices 450 communicating or detecting signaling on the first channel 402 and the second channel 404 in response to detecting OBSS NAVs 406 (such as detecting PPDUs indicating the OBSS NAVs 406) that start at or near a same time. For example, the communication flows 400 may include transmitted signaling, received signaling, and channel busy times (such as the OBSS NAVs 406). Each of the FIG. 5A-5D may illustrate an exemplary technique for NPCA coordination, where the techniques described in any of the FIG. 5A-5D may be combined or utilized with techniques describes in one or more other of the FIGS. 5A-5D, as well as FIG. 4A-4E.

In some examples, wireless communication devices 450 may switch to a NPCA primary channel based on a localized view of the first channel 402 (such as in accordance with an OBSS detected by each wireless communication device 450), where a local view of the wireless communication device 450-a may be different than a local view of the wireless communication device 450-b. For example, a local view at a wireless communication device may include relative strengths and interference levels of wireless signaling at a wireless communication device 450. Different local views at the wireless communication devices 450 may cause the wireless communication devices 450 to detect different PPDUs that indicate different OBSS NAVs 406, which may be referred to as an asymmetric view, and which may affect NPCA operations at one or both of the wireless communication devices 450.

In such asymmetric view scenarios, both wireless communication devices 450 (such as two NPCA STAs) may switch to the second channel 404 at or near a same time but according to different local NPCA parameters (which may be based on the detection of PPDUs corresponding to different OBSSs). In some examples, NPCA parameters may include a duration parameter, a bandwidth parameter, a puncturing pattern, one or more other parameters (such as a threshold NPCA padding duration, MCS, NSS), or any combination thereof. In some examples, the duration parameter may indicate a busy duration, a duration of a detected OBSS NAV 406, an indication of a time at which a wireless communication device may switch from the second channel 404 back to the first channel 402, or any combination thereof. Additionally, or alternatively, the bandwidth parameter may indicate an occupied bandwidth associated with an OBSS NAV 406 (such as an occupied bandwidth 502 or 504), an available bandwidth outside of the OBSS NAVs 406 (such as an available bandwidth 522 or 524), or both. In some examples, the NPCA parameter associated with a wireless communication device 450 may be referred to as the local NPCA parameters of the wireless communication device 450. For example, based on the OBSS NAV 406-a and the OBSS NAV 406-b detected by the wireless communication devices 450-a and 450-b being associated with a different durations, different bandwidths, or both, each wireless communication device 450 may have different local NPCA parameters. That is, different local views at each wireless communication device 450 may correspond to different local NPCA parameters for each wireless communication device 450, and may accordingly result in a mismatch between one or more parameters that are allowable or acceptable for communication after switching to an NPCA primary channel (such as an O-Primary channel).

Additionally, or alternatively, different local views at the wireless communication devices 450 may cause one of the wireless communication devices 450 to detect a PPDU indicating an OBSS NAV 406 (referred to as detecting an OBSS NAV 406) on the first channel 402 while the other wireless communication device 450 may not detect an OBSS NAV 406 on the first channel 402, which may be referred to as a hidden node problem. The hidden node problem may cause one wireless communication device 450 to switch to the second channel 404 while the other wireless communication device 450 may not switch. In some examples, NPCA coordination may mitigate the resulting impact of the asymmetric view problem, the hidden node problem, or both.

The asymmetric view problem may occur in various examples. In a first example, the asymmetric view problem may be, in some aspects, two hidden node problems occurring separately for the wireless communication devices 450-a and 450-b. For example, the wireless communication device 450-a may detect the OBSS NAV 406-a but the wireless communication device 450-b may not, and the wireless communication device 450-b may detect the OBSS NAV 406-b but the wireless communication device 450-a may not. In such an example, the OBSS NAVs 406 may start at different times (such as more than a threshold decoding time different from each other), may last for different durations (expire at different times), and may be associated with different bandwidths (such as may occupy different bandwidths based on the PPDU that indicates the OBSS NAV 406). The wireless communication devices 450 may switch at different times and may have a different view of a busy duration of the first channel 402 and an available bandwidth for NPCA transmissions (such as a bandwidth that is within a total channel that is not being used for the detected PPDUs).

In some other examples, there may be a detection of PPDUs from different OBSSs (such as illustrated by the communication flows 500). For example, OBSS NAV 406-a and OBSS NAV 406-b may start at a same time (such as the exact same time, near a same time, within a threshold decoding time of each other, based on the PPDUs that indicate the OBSS NAVs 406 being transmitted at or near the same time), which may be referred to as a collision of PPDUs or a collision of OBSS NAVs 406. A local view (such as a signal to interference and noise ratio (SINR)) of each wireless communication device 450 with respect to each PPDU that indicates the OBSS NAVs 406 may be different, and the wireless communication device 450-a may decode a first PPDU (and detect the OBSS NAV 406-a) while the wireless communication device 450-b may decode a second PPDU (and detect the OBSS NAV 406-b). Based on a bandwidth reserved by the PPDUs, the OBSS NAV 406-a may occupy an occupied bandwidth 502 and the OBSS NAV 406-b may occupy an occupied bandwidth 504 (which may be different from each other, or one bandwidth may include more frequency resources than the other). Local NPCA parameters (such as the available bandwidths 522 and 524, frequency resource that are and are not reserved by respective OBSS NAVs 406) for the wireless communication devices 450 may be different.

Regarding communication flow 500-a (as an example), the wireless communication device 450-b (after the switch 408 to the second channel 404) may win a TXOP on the second channel 404 for the duration of the OBSS NAV 406-b. The wireless communication device 450-b may initiate communication on the TXOP by transmitting (broadcasting) the ICF 412. In some examples, the duration of the TXOP may be greater than a duration of the OBSS NAV 406-a detected by the wireless communication device 450-a (a TXOP responder, and AP 102). Additionally, or alternatively, the available bandwidth 524 at the wireless communication device 450-b may be greater than the available bandwidth 522 at the wireless communication device 450-b. That is, the local NPCA parameters of the wireless communication device 450-b may not be acceptable to the wireless communication device 450-a (may be incompatible with the local NPCA parameters of the wireless communication device 450-a). In some examples, RTS frames may not be allowed on the first channel 402, the second channel 404, or both (such as according to one or more standards document), and dynamic negotiation of a bandwidth for NPCA communications (such as via RTS frames) may not occur on the first channel 402, the second channel 404, or both.

In such an example, the wireless communication device 450-a may remain on the second channel (may not switch 422) until the end of the TXOP even though the first channel has become available for the wireless communication device 450-a based on the expiration of the OBSS NAV 406-a. In an example where the wireless communication device 450-a is an AP 102, this may prevent some wireless communication devices (such as legacy wireless communication devices, STAs 104, or devices that do not support the NPCA operation) from communicating with the wireless communication device 450-a during a blind duration 506. The blind duration 506 may increase latency and reduce communication efficiency in a wireless communication network and may result in inferior performance for the legacy wireless communication devices, STAs 104, or devices that do not support the NPCA operation. Additionally, or alternatively, if the wireless communication device 450-a is a STA (such as a non-AP STA), experiencing the blind duration 506 may cause the wireless communication device 450-a to perform medium synchronization recovery (which may utilize increased power and communication resources and increase the communication latency), and P2P traffic associated with the wireless communication device 450-a may be negatively impacted during the blind duration 506.

In addition to the negative impacts of the blind duration 506, the wireless communication device 450-a may experience interference 508 (such as increased interference in some resources of the OBSS NAV 406-a) due to the differences in the available bandwidths 522 and 524 (different local NPCA parameters). For example, because the wireless communication device 450-b may transmit the ICF 412 using the available bandwidth 524, subsequent communications in the associated TXOP (such as the ICR 414, the PPDU 416, the BA 418, or any combination thereof) communicated by the wireless communication devices 450 may utilize the available bandwidth 524, even though the available bandwidth 524 may overlap in frequency with the occupied bandwidth 502. The asymmetric view issue (such as when the OBSS NAVs 406 collide) may reduce communication quality between the wireless communication devices 450 based on the interference 508, the blind duration 506, or both.

In some examples, the wireless communication devices 450 may implement NPCA coordination techniques to reduce or eliminate the negative effects of the asymmetric view problem (and the hidden node problem). In some examples (such as described with respect to the communication flow 500-b), the wireless communication device 450-a (such as an AP) may broadcast an ICF 412 (an NPCA announcement frame, an NPCA ICF, a trigger frame, a frame) that indicates (includes) one or more NPCA parameters (requested NPCA parameters 446, advertised NPCA parameters, announced NPCA parameters, allowed NPCA parameters) followed by one or more frames in the downlink or triggered uplink (not shown in communication flow 500-a). In some examples, the wireless communication device 450-b (and any other wireless communication device) may refrain from contending for the second channel 404 at least until the wireless communication device 450-a broadcasts the ICF 412 (and the wireless communication device 450-b transmits an ICR in response), an expiration of a timer, or both. In some examples (such as described with respect to the communication flow 500-c), a wireless communication device 450 may ignore (not respond to, not decode entirely) any ICF 412 if one or more of the requested NPCA parameters fail acceptance (are incompatible, exceed) with respect to one or more local NPCA parameters of the wireless communication device 450 (are not acceptable to the wireless communication device 450). Additionally, or alternatively, the wireless communication devices 450 may negotiate NPCA parameters for a TXOP including the second channel 404 (or any other non-primary channel) via one or more ICFs 412 and ICRs 414.

Regarding the communication flow 500-b, the wireless communication device 450-a (such as an AP 102, a STA 104) may broadcast an ICF 412-c that indicates one or more NPCA parameters 446. In some examples, after the switch 408, the wireless communication device 450-b may refrain from contending for access of the second channel 404 (may wait) at least until the wireless communication device 450-a broadcasts the ICF 412-c. If the wireless communication device 450-b receives the ICF 412-c indicating the NPCA parameters 446 (such as the local NPCA parameters of the wireless communication device 450-a), the wireless communication device 450-b may transmit a response (such as an ICR 414-c) to the wireless communication device 450-a in accordance with the NPCA parameters 446. If the wireless communication device 450-a drops the TXOP after the ICR 414-c (for example by not sending any frame after the ICR 414-c), the wireless communication device 450-b may begin contending for access to the second channel 404. Additionally, or alternatively, (such as if the wireless communication device 450-a does not transmit the ICF 412-c), the wireless communication device 450-b may contend for access of the second channel 404 at or after the expiration of a timer 516, where the wireless communication device 450-b may initiate the timer 516 at the start of the OBSS NAV 406-b, at the switch 408, or at another time. In some examples, the timer 516 may expire before or after the ICF 412-c, the ICR 414-c, or both. Alternatively, the wireless communication device 450-a may communicate traffic with one or more other wireless communication devices 450 (such as through downlink communications or triggered uplink communications) after the ICR 414-c (not shown) according to the requested NPCA parameters 446 in the ICF 412-c.

In some examples, the wireless communication device 450-a may send the ICF 412-c if (only if) the wireless communication device 450-a has downlink traffic (such as downlink traffic) for another wireless communication device, or if the wireless communication device 450-a has a wireless communication device 450 to trigger (such as for an uplink transmission to the wireless communication device 450-a). For example, if the wireless communication device 450-a does not have traffic to transmit or trigger, the wireless communication device 450-a may not transmit the ICF 412-c. In some examples, refraining from transmitting the ICF 412-c due to a lack of traffic to transmit or trigger may reduce collisions of the ICFs 412-c from different wireless communication devices 450 (such as different APs 102) that do not have traffic to communicate.

In some examples, the ICF 412-c may be an example of one or more frames, including an ICF 412 (as described with respect to FIG. 1-4E). The one or more NPCA parameters 446 within the ICF 412-c may include a bandwidth parameter, a duration indication, a preamble puncturing pattern, a max padding duration associated with communications via the second channel 404, one or more other NPCA parameters (local NPCA parameters of the wireless communication device 450-a), or any combination thereof. In some examples, the bandwidth parameter (from the wireless communication device 450-a) may include an indication of the available bandwidth 522, an indication of the occupied bandwidth 502, or both. In some examples, the bandwidth parameter may account for a guard bandwidth between the channels used for NPCA operation (such as the second channel 404) and the occupied bandwidth 502 (bandwidth used by OBSS activity indicated by the OBSS NAVs 406) to mitigate interference to the OBSS activity, to the NPCA operation, or both. The duration parameter may include an indication of the available duration 510, an indication of the length of the OBSS NAV 406-a, an indication of a time at which the wireless communication device 450-a may switch 422 back to the first channel 402, or any combination thereof. In some examples, the duration parameter may be indicated in terms of an absolute time (such as a TSF value), a time length, or both (such as described with respect to the time 434 of FIG. 4C). The available duration 510 may beginning at the switch 410 and may include a time during which the wireless communication device 450-a may be on the second channel 404 (such as a duration between the switch 410 and the switch 422).

If the wireless communication device 450-a drops the TXOP or does not transmit the ICF 412-c before the expiration of the timer 516, the wireless communication device 450-b (along with other wireless communication devices 450) may contend for access (for a second TXOP) on the second channel 404. Such contention may include sending the ICF 412-d, an ICR 414-d, or both on the second channel 404. The wireless communication device 450-b (and other wireless communication devices 450 that receive the broadcasted ICF 412-c) may communicate frames associated with the second TXOP (such as the ICF 412-d, the ICR 414-d, the PPDU 416, the BA 418, other frames) according to the requested NPCA parameters 446. That is, the second TXOP may not exceed a duration parameter (such as the available duration 510) indicated by the ICF 412-c, a bandwidth parameter (such as the available bandwidth 522) indicated by the ICF 412-c, or one or more other NPCA parameters indicated in the ICF 412-c.

Implementing the techniques described with respect to the communication flow 500-b may reduce negative effects associated with the asymmetric view problem, the hidden node problem, or both. In one example, if the wireless communication device 450-b switches 408 to the second channel 404 but the wireless communication device 450-a does not, the wireless communication device 450-b may communicate via the second channel 404 after expiration of the timer 516, reducing failed communications and latency associated with the hidden node problem. Additionally, by indicating requested NPCA parameters 446 in the ICF 412-c, the wireless communication device 450-a may switch 422 to the first channel 402 at the end of the OBSS NAV 406-a, which may reduce or eliminate the blind duration 506 and the associated communication latency or failures. Additionally, having the wireless communication device 450-b wait for the ICF 412-c or the expiration of a timer may be a relatively simple technique to be applied at the wireless communication devices 450, reducing the use of power and computational resources at the wireless communication devices 450.

Regarding the communication flow 500-c, the wireless communication device 450-b may be a TXOP holder on the second channel 404 (the wireless communication device 450-b may contend for and win a TXOP on the second channel 404) after the switch 408, and may transmit an ICF 412 to the wireless communication device 450-a based on local NPCA parameters of the wireless communication device 450-b. The ICF 412 may include one or more requested NPCA parameters 446. The wireless communication device 450-a may ignore the ICF 412 if at least one of the one or more requested NPCA parameters 446 indicated by the ICF 412 fail acceptance with respect to (are incompatible with, exceed) the local NPCA parameters of the wireless communication device 450-a. For example, the wireless communication device 450-b (such as a STA 104) may transmit the ICF 412 to the wireless communication device 450-a after the switch 408 (and after the switch 410, as the switches 408 and 410 may occur at or near the same time based on the colliding OBSS NAVs 406). As described, requested NPCA parameters may include a duration parameter (an indication of the available duration 520, a requested TXOP duration, a time at which the wireless communication device 450-b may switch 424 back to the first channel 402), a bandwidth parameter (an indication of the available bandwidth 524, an indication of the occupied bandwidth 504, or both), a requested puncturing pattern, one or more other NPCA parameters, or any combination thereof.

In some examples, the wireless communication device 450-a (such as a TXOP responder) may compare the requested NPCA parameters 446 indicated by the ICF 412 with local NPCA parameters of the wireless communication device 450-a. For example, the local NPCA parameters of the wireless communication device 450-a may include the available duration 510, the available bandwidth 522, an available puncturing pattern, one or more other NPCA parameters, or any combination thereof. If the NPCA parameters indicated by the ICF 412 fail acceptance with respect to (are incompatible with, exceed) the local NPCA parameters of the wireless communication device 450-a, the wireless communication device 450-a may ignore (not respond, refrain from transmitting an ICR 414) to the ICF 412. In some examples, one or more of the requested NPCA parameters 446 may fail acceptance if the requested NPCA parameter 446 exceeds the corresponding local NPCA parameter. For example, if the available duration 510 indicated by the duration parameter or the available bandwidth 524 indicated by the bandwidth parameter are greater than (exceed) the available duration 510 or the available bandwidth 522, respectively, the wireless communication device 450-a may not respond to the ICF 412. In some examples, refraining from responding to such ICFs 412 may provide a simple implementation to reduce one or more negative effects of the asymmetric view problem, the hidden node problem, or both, and such a simple implementation may conserve power and computational resources at the wireless communication devices 450.

Regarding the communication flow 500-d, after the switches 408 and 410, the wireless communication devices 450 may negotiate one or more allowed NPCA parameters 448 for a TXOP associated with the second channel 404. For example, the wireless communication device 450-b (a TXOP holder) may transmit the ICF 412 to the wireless communication device 450-b, where the ICF 412 may include an indication of requested NPCA parameters 446 associated with the wireless communication device 450-b (such as the local NPCA parameters of the wireless communication device 450-b). For example, the requested NPCA parameters 446 may indicate the available duration 520, the available bandwidth 524, the occupied bandwidth 504, one or more other NPCA parameters, or any combination thereof. In some examples, the ICF 412 may be transmitted from the wireless communication device 450-b via the available bandwidth 524.

In response to the ICF 412, the wireless communication device 450-a (a TXOP responder) may transmit an ICR 414 to the wireless communication device 450-b. In some examples, the wireless communication device 450-a may transmit the ICR 414 according to the available bandwidth 522 associated with the wireless communication device 450-a. In some examples, the ICR 414 may include one or more allowed NPCA parameters 448 (negotiated NPCA parameters, minimum shared NPCA parameters). An allowed NPCA parameter 448 may be a minimum between a requested NPCA parameter 446 indicated in the ICF 412 and a local NPCA parameter of the wireless communication device 450-a (the TXOP responder).

The allowed NPCA parameters 448 may be determined by the wireless communication device 450-a based on comparing each requested NPCA parameter 446 to a corresponding local NPCA parameters of the wireless communication device 450-a. For example, the allowed NPCA parameters 448 may include an allowed duration parameter, which may be the minimum duration of a requested duration parameter indicated in the ICF 412 (such as the available duration 520) and the local duration parameter associated with the wireless communication device 450-a (such as the available duration 510, where the minimum duration in the example of the communication flow 500-d may be the available duration 510). Additionally, or alternatively, the allowed NPCA parameters 448 may include an allowed bandwidth parameter, which may be a minimum bandwidth of the bandwidth parameter indicated in the ICF 412 (such as the available bandwidth 524) and the local bandwidth parameter of the wireless communication device 450-a (such as the available bandwidth 522, where the minimum bandwidth in the example of the communication flow 500-d may be the available bandwidth 522). Additionally, or alternatively, the allowed puncturing pattern may be an intersection of the requested puncturing pattern (indicated in the requested NPCA parameters 446) and the local puncturing pattern of the wireless communication device 450-a, such that the allowed puncturing pattern may exclude portions of a bandwidth (the available bandwidth 522) that are commonly excluded between the requested puncturing pattern and the local puncturing pattern, include portions of the bandwidth that are commonly included between the requested puncturing pattern and the local puncturing pattern, or both.

In response to receiving the ICR 414 that indicates the allowed NPCA parameters 448, the wireless communication device 450-b (the TXOP holder) may adjust one or more applied NPCA parameters to comply with (match) the allowed NPCA parameters 448. For example, the wireless communication device 450-b may transmit a PPDU 416 according to the available bandwidth 522 (if indicated as an allowed NPCA parameter 448 in the ICR 414), and the wireless communication device 450-b may adjust the length of the PPDU 416 (accounting for the BA 418) to perform the TXOP in the available duration 510 (if indicated as an allowed NPCA parameter 448).

In some aspects, the wireless communication device 450-b (a TXOP initiator) may indicate a negotiation capability of the wireless communication device 450-b to the wireless communication device 450-a. For example, the negotiation capability may indicate whether the wireless communication device 450-b supports static negotiation, dynamic negotiation, both, or neither. If the wireless communication device 450-b supports dynamic negotiation, the wireless communication device 450-a (a TXOP responder) may transmit the ICR 414 including the allowed NPCA parameters 448, and subsequent frames of the TXOP (such as the PPDU 416 and the BA 418) may be exchanged according to the allowed NPCA parameters 448 (such as illustrated in the communication flow 500-d). If the TXOP initiator supports static negotiation, the wireless communication device 450-a may transmit the ICR 414 if the requested NPCA parameters 446 in the ICF 412 are allowed NPCA parameters 448 (are compatible with the local NPCA parameters at the wireless communication device 450-a). That is, if the wireless communication device 450-b supports static negotiation and the requested NPCA parameters 446 fail allowance (are not allowed) with respect to the local NPCA parameters of the wireless communication device 450-a, the wireless communication device 450-a may ignore the ICF 412 (such as illustrated in the communication flow 500-c), and the wireless communication device 450-a may drop (give up) the TXOP.

In some examples, the wireless communication device 450-a may indicate the negotiation capabilities via one or more other techniques. For example, the wireless communication device 450-a may indicate the negotiation capability as a capability announced during association between the wireless communication device 450-a and the wireless communication device 450-b. Additionally, or alternatively, the wireless communication device 450-b may indicate the negotiation capability as a semi-static indication, such as by announcing the negotiation capability using a management frame or an action frame (such as one or more beacon frames or an operating mode notification frame). Additionally, or alternatively, the ICF 412 may indicate the negotiation capability. For example, a first value (“1”) of a bit of the ICF 412 may indicate support for dynamic negotiation, and a second value (“0”) of the bit may indicate support for static negotiation. In some examples, an indication of support for one of the negotiation capabilities (such as support for dynamic negotiation) may indicate support for both negotiation capabilities, and the wireless communication device 450-a may act according to either capability.

In some examples, the wireless communication device 450-b may indicate the negotiation capabilities on a per-NPCA parameter basis. For example, the wireless communication device 450-b may indicate whether it supports negotiation (static or dynamic) for each NPCA parameter or for subsets of NPCA parameters. As an example, the indication of the negotiation capability may include a bit map, where each bit of the bit map may indicate whether the wireless communication device 450-b supports negotiation of a respective NPCA parameter (such as the duration parameter, the bandwidth parameter, a puncturing pattern parameter, other NPCA parameters) or a subset of the NPCA parameters (such as the duration and bandwidth parameters, and other NPCA parameters). Alternatively, the wireless communication device 450-b may indicate negotiation capabilities for NPCA parameters (all NPCA parameters) on a binary basis. That is, a first value (“0”) of a single bit in the indication of the negotiation capabilities may indicate that no negotiation of any NPCA parameter is supported, and a second value (“1”) of the single bit may indicate that negotiation of all parameters (dynamic negotiation, static negotiation, or both) is supported.

Negotiating the allowed NPCA parameters 448 between the wireless communication devices 450 may reduce or eliminate the negative effects of the asymmetric view problem, the hidden node problem, or both, by reducing the interference 508 for the wireless communication device 450-a and allowing the wireless communication device 450-a to switch 422 to the first channel 402 sooner (and reduce communication latency or failures).

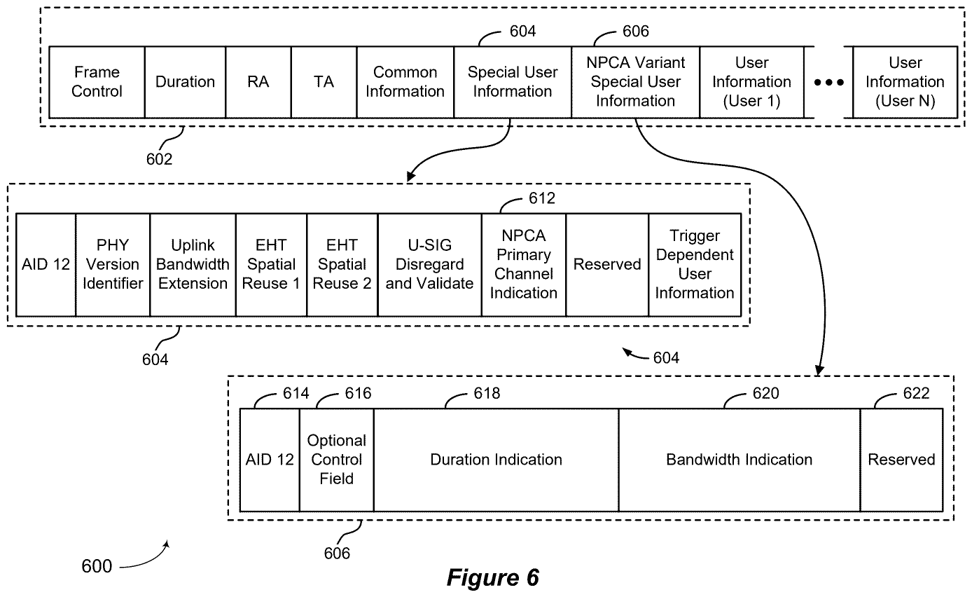

FIG. 6 shows an example of a frame format 600 that supports NPCA coordination. Some aspects of the frame format 600 may implement or be implemented by aspects of FIG. 1-5D. For example, the frame format 600 may include a trigger frame 602 (such as the ICFs 412), which may indicate the requested NPCA parameters 446 in a user information field (for example, an NPCA special user information field, a user information field associated with non-primary channel access), such as the NPCA variant special user information 606. For example, a duration parameter 618, a bandwidth parameter 620, and a reserved field 622 (one or more reserved fields) may be fields to indicate (include) the duration parameter, the bandwidth parameter, and one or more other NPCA parameters, respectively, described with respect to FIG. 5A-5D. In some aspects, the frame format 600 may illustrate the trigger frame 602 (an ICF 412, another frame) for communicating requested NPCA parameters 446 between wireless communication devices 450.

As described, the wireless communication devices 450 (examples of APs 102, STAs 104, both) may indicate requested NPCA parameters 446 to one another, such as via the ICFs 412. In some examples, the frames used to communicate the NPCA parameters may be trigger frames (for uplink, downlink, or both). The frame format 600 may illustrate a trigger frame 602 (a modified trigger frame format) capable of including indications of NPCA parameters.

In some examples, the trigger frame 602 may include multiple fields. For example, the trigger frame 602 may include a frame control frame, a duration frame, a receiver address (RA) field, a transmitter address (TA) field, a common information field, special user information 604, the NPCA variant special user information 606, and multiple user information fields (for any quantity of users, user 1 through user N).

In some examples, the special user information 604 also may include one or more fields. For example, the special user information 604 may include an AID 12 field 614, a PHY version identifier field, an uplink bandwidth extension field, an EHT spatial reuse 1 field, an EHT spatial reuse 2 field, a U-SIG disregard and validate field, an NPCA primary channel indication 612, a reserved field, and a trigger dependent user information field. If the trigger frame 602 is transmitted on an O-primary channel (such as the second channel 404, an NPCA primary channel), the trigger frame 602 may carry an explicit indication that the trigger frame 602 is transmitted via the O-primary channel. For example, the NPCA primary channel indication 612 may explicitly indicate whether the trigger frame 602 is transmitted on the O-primary channel. Additionally, or alternatively, the NPCA primary channel indication 612 may indicate whether the NPCA variant special user information 606 is present in the trigger frame 602. For example, a value of “1” for the NPCA primary channel indication 612 may indicate that the NPCA variant special user information 606 is present in the trigger frame 602, and a value of “0” for the NPCA primary channel indication 612 may indicate that the NPCA variant special user information 606 is not present in the trigger frame 602 (or vice versa).

The NPCA variant special user information 606 also may include one or more fields. For example, the NPCA variant special user information 606 may include an AID 12 field 614, an optional control field 616, a duration parameter 618, a bandwidth parameter 620, and a reserved field 622 (such as for indications of other NPCA parameters). In some examples, the AID 12 field 614, the optional control field 616, or both, may indicate that the NPCA variant special user information 606 is an NPCA variant (as opposed to one or more other variants of special user information). For example, the AID 12 field 614 may have a value above a threshold value (such as “2007”) to indicate that the NPCA variant special user information 606 is a variant of the special user information (but not necessarily the NPCA variant). In some examples, each value of the AID 12 field 614 above the threshold value may be mapped to a different variant of the special user information, and one or more of the values (such as “2024”) above the threshold value may indicate that the NPCA variant special user information 606 is an NPCA variant (as opposed to another variant of the special user information). Additionally, or alternatively, the values of both the AID 12 field 614 and the optional control field 616 may indicate that the NPCA variant special user information 606 is the NPCA variant. For example, a value above the threshold value (such as “2024”) may indicate that the NPCA variant special user information 606 is a variant of the special user information (but not which type of variant), and a value of the optional control field 616 (such as “0”) may indicate that the NPCA variant special user information 606 is specifically the NPCA variant.

The NPCA variant special user information 606 may indicate one or more NPCA parameters (such as requested NPCA parameter 446 as described with respect to FIG. 5A-5D). For example, the duration parameter 618 may indicate an available duration (such as the available durations 510 and 520) or a time at which a transmitting wireless communication device 450 may switch back to an M-primary channel, the bandwidth parameter 620 may indicate an available bandwidth (such as the available bandwidths 522 and 524), an occupied bandwidth (such as the occupied bandwidths 502 and 504), or both, and the reserved field 622 may indicate one or more other NPCA parameters (such as a maximum NPCA padding duration). Accordingly, the modified format of the trigger frame 602 may allow for communication of NPCA parameters between wireless communication devices 450, which may improve communication quality in a wireless communication network.

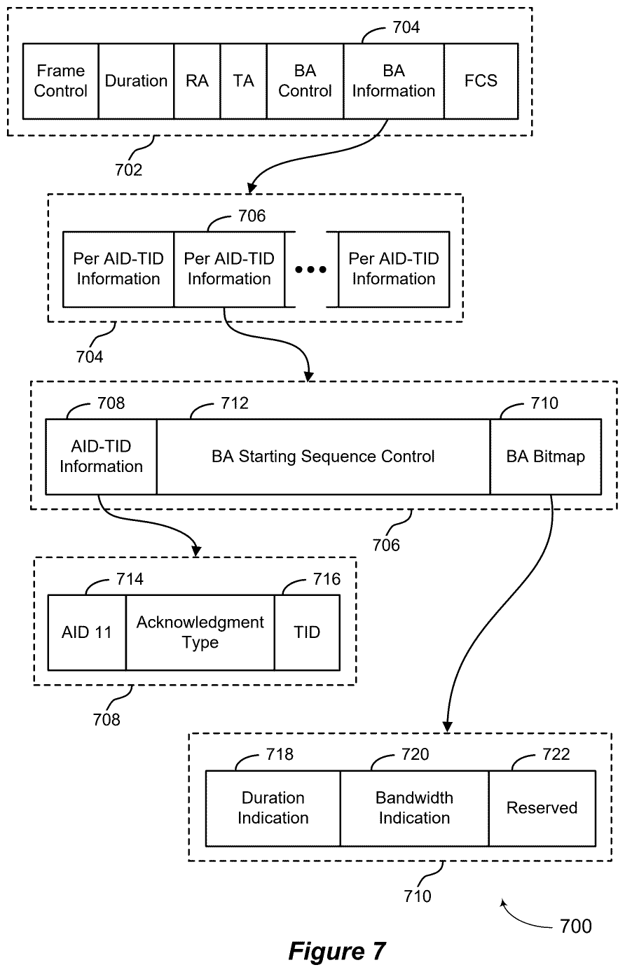

FIG. 7 shows an example of a frame format 700 that supports NPCA coordination. Some aspects of the frame format 700 may implement or be implemented by aspects of FIG. 1-6. For example, the frame format 700 may include a BA frame 702 (such as the ICRs 414, the BAs 418, a response frame), which may include indications of allowed NPCA parameters 448, such as a duration parameter 718, a bandwidth parameter 720, and a reserved field 722 (one or more reserved fields), which may be examples of the duration parameter, bandwidth parameter, and one or more other NPCA parameters, respectively, described with respect to FIG. 5A-5D. In some aspects, the frame format 700 may illustrate the BA frame 702 (the ICRs 414, another frame) for communicating allowed NPCA parameters 448 between wireless communication devices 450.

In some examples, an ICR 414 may carry indications of the allowed NPCA parameters 448 (as described with respect to FIG. 5D). In some examples, the ICRs 414 may be a multi-STA BA frame (such as the BA frame 702). The BA frame 702 may be a Multi-STA BA frame (a modified multi-STA BA frame) capable of indicating NPCA parameters (such as the allowed NPCA parameters 448).

In some examples, the BA frame 702 may include one or more fields. For example, the BA frame 702 may include a frame control field, a duration field, an RA field, a TA field, a BA control field, BA information 704, and an FCS field. In some examples, the BA information 704 may include one or more per AID-TID information fields 706, where one or more of the per AID-TID information fields 706 may include BA information. For example, the per AID-TID information fields 706 also may include one or more fields. As an example, the per AID-TID information field 706 may include AID-TID information 708, a BA starting sequence control 712, and a BA bitmap 710.

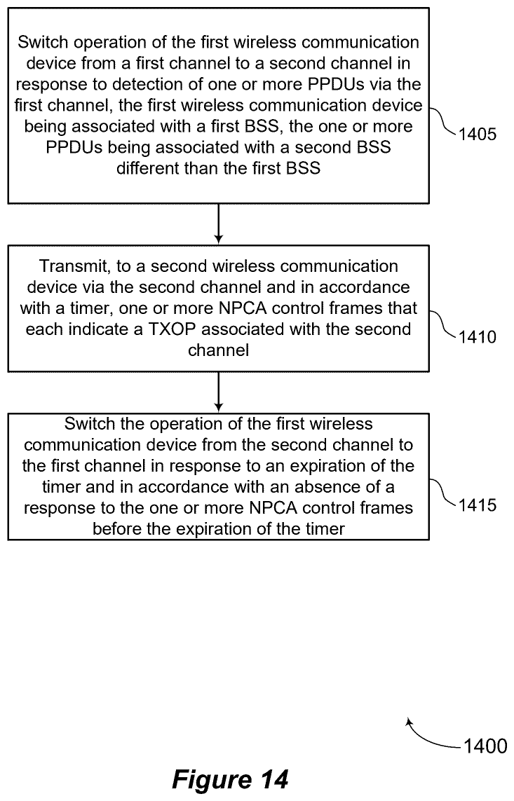

The AID-TID information 708 also may include one or more fields. For example, the AID-TID information 708 may include an AID 11 field 714, an acknowledgment type field, and a TID field 716. Similar to the use of the AID 12 field 614 and the optional control field 616, as described with respect to FIG. 6, the AID 11 field 714, the TID field 716, or both, may indicate whether the per AID-TID information field 706 is an NPCA variant of per AID-TID information. For example, one or more values of the AID 11 field 714 (such as above the threshold value described with respect to FIG. 14, “2024”) may indicate that that the per AID-TID information field 706 is an NPCA variant of the per AID-TID information (as opposed to a non-variant or a variant of a different kind). Additionally, or alternatively, a combination of a values of the AID 11 field 714 (such as “2024”) and the TID field 716 (such as “0”) may indicate that the per AID-TID information field 706 is an NPCA variant (as opposed to another type of variant).

The BA bitmap 710 also may include one or more fields. For example, the BA bitmap 710 may include the duration parameter 718 (which may indicate an allowed duration parameter described with respect to FIG. 5D), the bandwidth parameter 720 (which may indicate the allowed bandwidth parameter described with respect to FIG. 5D), and the reserved field 722 (to indicate one or more other allowed NPCA parameters 448, as described with respect to FIG. 5D). Accordingly, the BA frame 702 may include an indication of one or more NPCA parameters (allowed NPCA parameters 448), which may allow wireless communication devices 450 to coordinate NPCA and provide for higher quality communication in a wireless communication network.

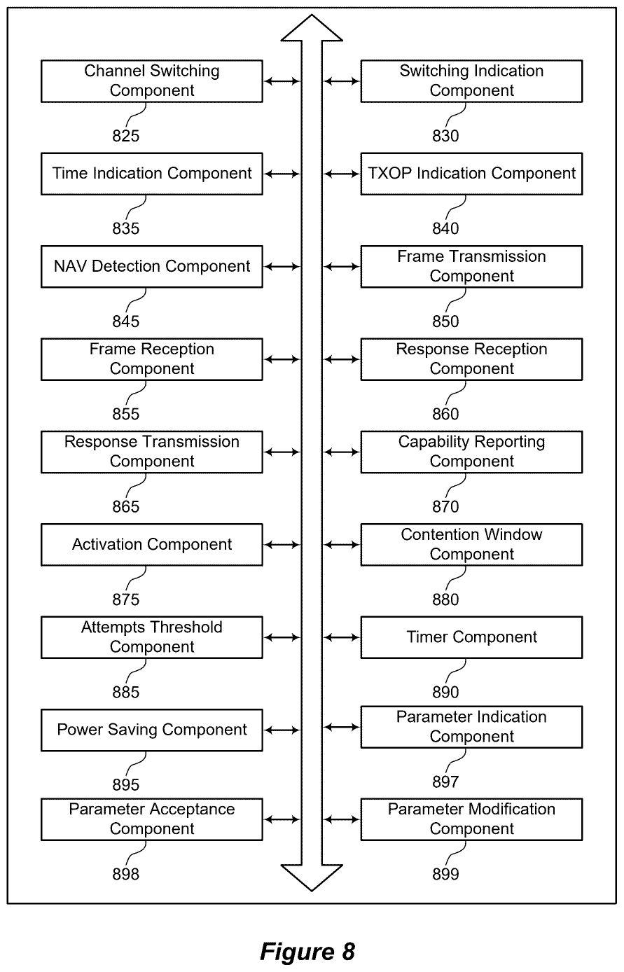

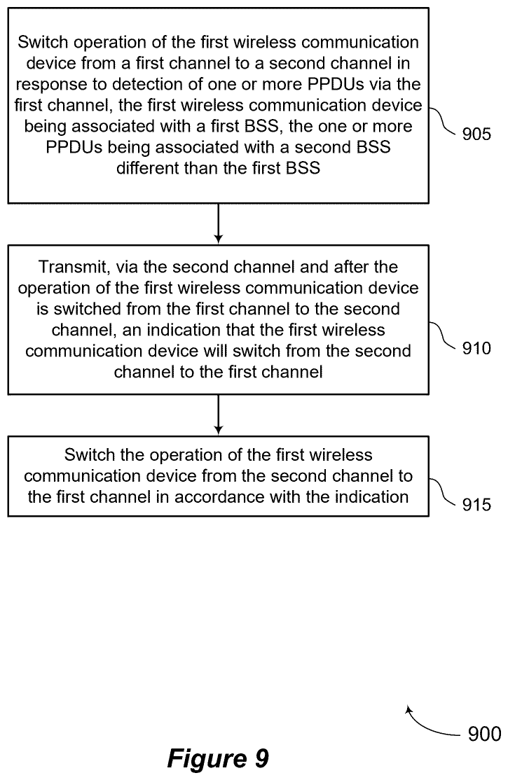

FIG. 8 shows an example wireless communication device that supports NPCA coordination. In some examples, the wireless communication device is configured to perform the processes 900, 1000, 1100, 1200, 1300, 1400, 1500, 1600, 1700, 1800, 1900, 2000, and 2100 described with reference to FIGS. 9, 10, 11, 12, 13, 14, 15, 16, 17, 18, 19, 20, and 21, respectively. The wireless communication device may include one or more chips, SoCs, chipsets, packages, components or devices that individually or collectively constitute or include a processing system. The processing system may interface with other components of the wireless communication device, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device may transmit the information output from the chip. In such an example, the second interface may refer to an interface between the processing system of the chip and a reception component, such that the wireless communication device may receive information that is then passed to the processing system. In some such examples, the first interface also may obtain information, such as from the transmission component, and the second interface also may output information, such as to the reception component.

The processing system of the wireless communication device includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some examples, one or more of the processors may be preconfigured to perform various functions or operations described herein without requiring configuration by software. The processing system may further include or be coupled with one or more modems (such as a Wi-Fi (such as IEEE compliant) modem or a cellular (such as 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device can be configurable or configured for use in an AP or STA, such as the AP 102 or the STA 104 described with reference to FIG. 1. In some other examples, the wireless communication device can be an AP or STA that includes such a processing system and other components including multiple antennas. The wireless communication device is capable of transmitting and receiving wireless communications in the form of, for example, wireless packets. For example, the wireless communication device can be configurable or configured to transmit and receive packets in the form of physical layer PPDUs and MPDUs conforming to one or more of the IEEE 802.11 family of wireless communication protocol standards. In some other examples, the wireless communication device can be configurable or configured to transmit and receive signals and communications conforming to one or more 3GPP specifications including those for 5G NR or 6G. In some examples, the wireless communication device also includes or can be coupled with one or more application processors which may be further coupled with one or more other memories. In some examples, the wireless communication device further includes a user interface (UI) (such as a touchscreen or keypad) and a display, which may be integrated with the UI to form a touchscreen display that is coupled with the processing system. In some examples, the wireless communication device may further include one or more sensors such as, for example, one or more inertial sensors, accelerometers, temperature sensors, pressure sensors, or altitude sensors, that are coupled with the processing system. In some examples, the wireless communication device further includes at least one external network interface coupled with the processing system that enables communication with a core network or backhaul network that enables the wireless communication device to gain access to external networks including the Internet.

The wireless communication device may be an example of aspects of a wireless communication device as described with reference to FIG. 1-7. The wireless communication device, or various components thereof, may be an example of means for performing various aspects of NPCA coordination as described herein. For example, the wireless communication device may include a channel switching component 825, a switching indication component 830, a time indication component 835, a TXOP indication component 840, a NAV detection component 845, a frame transmission component 850, a frame reception component 855, a response reception component 860, a response transmission component 865, a capability reporting component 870, an activation component 875, a contention window component 880, an attempts threshold component 885, a timer component 890, a power saving component 895, a parameter indication component 897, a parameter acceptance component 898, and a parameter modification component 899. Each of these components, or components or subcomponents thereof (such as one or more processors, one or more memories), may communicate, directly or indirectly, with one another (such as via one or more buses). Portions of one or more of the channel switching component 825, the switching indication component 830, the time indication component 835, the TXOP indication component 840, the NAV detection component 845, the frame transmission component 850, the frame reception component 855, the response reception component 860, the response transmission component 865, the capability reporting component 870, the activation component 875, the contention window component 880, the attempts threshold component 885, the timer component 890, the power saving component 895, the parameter indication component 897, the parameter acceptance component 898, or the parameter modification component 899 may be implemented at least in part in hardware or firmware. For example, one or more of the switching indication component 830, the time indication component 835, the TXOP indication component 840, the NAV detection component 845, the frame transmission component 850, the frame reception component 855, the response reception component 860, the response transmission component 865, the capability reporting component 870, the activation component 875, the contention window component 880, the attempts threshold component 885, the timer component 890, the power saving component 895, the parameter indication component 897, the parameter acceptance component 898, or the parameter modification component 899 may be implemented at least in part by at least a processor or a modem. In some examples, portions of one or more of the switching indication component 830, the time indication component 835, the TXOP indication component 840, the NAV detection component 845, the frame transmission component 850, the frame reception component 855, the response reception component 860, the response transmission component 865, the capability reporting component 870, the activation component 875, the contention window component 880, the attempts threshold component 885, the timer component 890, the power saving component 895, the parameter indication component 897, the parameter acceptance component 898, or the parameter modification component 899 may be implemented at least in part by a processor and software in the form of processor-executable code stored in memory.

The wireless communication device may support wireless communication in accordance with examples as disclosed herein. The channel switching component 825 is configurable or configured to switch operation of the first wireless communication device from a first channel to a second channel in response to detection of one or more physical layer (PHY) protocol data units (PPDUs) via the first channel, the first wireless communication device being associated with a first basic service set, the one or more PPDUs being associated with a second basic service set different than the first basic service set. The switching indication component 830 is configurable or configured to transmit, via the second channel and after the operation of the first wireless communication device is switched from the first channel to the second channel, an indication that the first wireless communication device will switch from the second channel to the first channel. In some examples, the channel switching component 825 is configurable or configured to switch the operation of the first wireless communication device from the second channel to the first channel in accordance with the indication.

In some examples, the indication is included in a NPCA announcement frame.

In some examples, the NPCA announcement frame includes one or more of a contention-free end frame, a clear-to-send (CTS)-to-self frame including a value of zero for at least one of a duration field or an identity field, a multi-station block acknowledgment, an aggregate control element in a medium access control header of a quality of service (QoS) null frame, a null management frame, an action frame, or a frame including an end of service period field including a value of one.

In some examples, the frame transmission component 850 is configurable or configured to transmit, while operating via the second channel, one or more frames to a second wireless communication device, where at least one frame of the one or more frames includes the indication.

In some examples, the at least one frame including the indication solicits a response from the second wireless communication device.

In some examples, the response reception component 860 is configurable or configured to receive a message including the response from the second wireless communication device, where the operation of the first wireless communication device is switched from the second channel to the first channel in accordance with a duration starting at an end of the message.

In some examples, the indication is included in a frame that is unassociated with a response from the second wireless communication device.

In some examples, the operation of the first wireless communication device is switched from the second channel to the first channel in accordance with a duration starting at an end of a frame including the indication.

In some examples, the operation of the first wireless communication device is switched from the second channel to the first channel in accordance with a buffer period extending from an end of a frame including the indication.

In some examples, the indication that the operation of the first wireless communication device will switch from the second channel to the first channel is associated with an expiration of a network allocation vector for the one or more PPDUs associated with the second basic service set.

In some examples, the frame transmission component 850 is configurable or configured to transmit, via the first channel and after the operation of the first wireless communication device is switched from the second channel to the first channel, a PPDU using a first set of one or more parameters different than a second set of one or more parameters used to transmit one or more frames via the second channel.

In some examples, the frame transmission component 850 is configurable or configured to transmit a request-to-send (RTS) frame via the first channel in accordance with the operation of the first wireless communication device being switched from the second channel to the first channel. In some examples, the frame reception component 855 is configurable or configured to receive a CTS frame via the first channel in response to the RTS frame. In some examples, the frame transmission component 850 is configurable or configured to transmit a PPDU via the first channel in response to receiving the CTS frame.

In some examples, the frame transmission component 850 is configurable or configured to transmit, via the first channel, a PPDU associated with one or more quality of service parameters that satisfy a threshold in accordance with the operation of the first wireless communication device being switched from the second channel to the first channel.

In some examples, the frame transmission component 850 is configurable or configured to transmit a PPDU to a second wireless communication device via the first channel in accordance with the operation of the first wireless communication device being switched from the second channel to the first channel. In some examples, the response reception component 860 is configurable or configured to receive a message including a response to the PPDU from the second wireless communication device via the first channel, where the response indicates that a reason for the operation of the second wireless communication device being switched from the second channel to the first channel includes the indication, an expiration of a network allocation vector, or both.

In some examples, the response includes one or more of a multi-traffic identifier block acknowledgment frame that includes an association identifier-traffic identifier field that indicates the reason, a data frame that includes an aggregate control field that indicates the reason, or a management frame that includes an aggregate control field that indicates the reason.

In some examples, the first wireless communication device includes an AP. In some examples, the second wireless communication device includes a STA.

Additionally, or alternatively, the wireless communication device may support wireless communication in accordance with examples as disclosed herein. In some examples, the channel switching component 825 is configurable or configured to switch operation of the second wireless communication device from a first channel to a second channel in response to detection of one or more PPDUs via the first channel, the second wireless communication device being associated with a first basic service set, the one or more PPDUs being associated with a second basic service set different than the first basic service set. In some examples, the switching indication component 830 is configurable or configured to receive, via the second channel and from a first wireless communication device, an indication that the first wireless communication device will switch from the second channel to the first channel. In some examples, the channel switching component 825 is configurable or configured to switch the operation of the second wireless communication device from the second channel to the first channel in accordance with the indication.

In some examples, the frame reception component 855 is configurable or configured to receive one or more messages from the first wireless communication device via the second channel, where the second wireless communication device maintains the operation via the second channel at least until the indication is received and in accordance with receiving the one or more messages.

In some examples, the one or more messages are intended for the second wireless communication device, intended for a third wireless communication device of the first basic service set, or both.

In some examples, the response transmission component 865 is configurable or configured to transmit a message including a response to the indication. In some examples, the channel switching component 825 is configurable or configured to switch the operation of the second wireless communication device from the second channel to the first channel in accordance with a duration starting at an end of the message.

In some examples, the indication is included in a NPCA announcement frame.

In some examples, the NPCA announcement frame includes one or more of a contention-free end frame, a CTS-to-self frame including a value of zero for at least one of a duration field or an identity field, a multi-station block acknowledgment, an aggregate control element in a medium access control header of a QoS null frame, a null management frame, an action frame, or a frame including an end of service period field including a value of one.

In some examples, the frame reception component 855 is configurable or configured to receive, while operating via the second channel, one or more frames from the first wireless communication device, where at least one frame of the one or more frames includes the indication.

In some examples, the at least one frame including the indication solicits a response from the second wireless communication device.

In some examples, the response transmission component 865 is configurable or configured to transmit a message including the response, where the operation of the second wireless communication device is switched from the second channel to the first channel in accordance with a duration starting at an end of the message.

In some examples, the at least one frame including the indication is unassociated with a response from the second wireless communication device.

In some examples, the operation of the second wireless communication device is switched from the second channel to the first channel in accordance with a duration starting at an end of a frame including the indication.

In some examples, the operation of the second wireless communication device is switched from the second channel to the first channel in accordance with a buffer period extending from an end of a frame including the indication.

In some examples, the frame reception component 855 is configurable or configured to receive, via the first channel and after the operation of the second wireless communication device is switched from the second channel to the first channel, a PPDU using a first set of one or more parameters different than a second set of one or more parameters used to receive one or more frames via the second channel.

In some examples, the frame reception component 855 is configurable or configured to receive a RTS frame via the first channel in accordance with the operation of the second wireless communication device being switched from the second channel to the first channel. In some examples, the frame transmission component 850 is configurable or configured to transmit a CTS frame via the first channel in response to the RTS frame. In some examples, the frame reception component 855 is configurable or configured to receive a PPDU via the first channel in response to transmitting the CTS frame.

In some examples, the frame reception component 855 is configurable or configured to receive a PPDU from the first wireless communication device via the first channel in accordance with the operation of the second wireless communication device being switched from the second channel to the first channel. In some examples, the response transmission component 865 is configurable or configured to transmit a message including a response to the PPDU to the first wireless communication device via the first channel, where the response indicates that a reason for the operation of the second wireless communication device being switched from the second channel to the first channel is the indication, an expiration of a network allocation vector for the first channel associated with the second basic service set, or both.

In some examples, the response includes one or more of a multi-traffic identifier block acknowledgment frame that includes an association identifier-traffic identifier field that indicates the reason, a data frame that includes an aggregate control field that indicates the reason, or a management frame that includes an aggregate control field that indicates the reason.

In some examples, the capability reporting component 870 is configurable or configured to transmit a capability report to the first wireless communication device indicating a capability of the second wireless communication device to switch the operation of the second wireless communication device from the second channel to the first channel in response to the indication.

In some examples, the activation component 875 is configurable or configured to receive, from the first wireless communication device, a control message indicating an activation of the indication, where the indication is received in accordance with the control message.

In some examples, the first wireless communication device includes an AP. In some examples, the second wireless communication device includes a STA.

Additionally, or alternatively, the wireless communication device may support wireless communication in accordance with examples as disclosed herein. In some examples, the channel switching component 825 is configurable or configured to switch operation of the first wireless communication device from a first channel to a second channel in response to detection of one or more PPDUs via the first channel, the first wireless communication device being associated with a first basic service set, the one or more PPDUs being associated with a second basic service set different than the first basic service set. The time indication component 835 is configurable or configured to transmit, via the second channel and after the operation of the first wireless communication device is switched from the first channel to the second channel, one or more frames indicating a time at which the first wireless communication device will switch from the second channel to the first channel. In some examples, the channel switching component 825 is configurable or configured to switch the operation of the first wireless communication device from the second channel to the first channel in accordance with the time indicated by the one or more frames.

In some examples, the one or more frames include an initial control frame or an initial control response transmitted via the second channel.

In some examples, the one or more frames include each frame transmitted by the first wireless communication device via the second channel after the operation of the first wireless communication device is switched from the first channel to the second channel.

In some examples, the one or more frames include one or more of a trigger frame that includes a special user information field that indicates the time, a multi-traffic identifier block acknowledgment frame that includes an association identifier-traffic identifier field that indicates the time, or a frame including a medium access control header that includes a duration field, an identifier field, or an aggregate control field of that indicates the time.

In some examples, the one or more frames each indicate the time via a value associated with a time synchronization function.

In some examples, the time synchronization function is associated with a set of multiple bits. In some examples, the value associated with the time synchronization function is for a subset of the set of multiple bits.

In some examples, the one or more frames each indicate the time as a remaining quantity of time from an end of a PPDU transmitted via the second channel in accordance with the operation of the first wireless communication device being switched from the first channel to the second channel.

In some examples, the operation of the first wireless communication device is switched from the second channel to the first channel within a duration starting at the time at which the first wireless communication device will switch from the second channel to the first channel.

In some examples, the time is associated with an expiration of a network allocation vector of the one or more PPDUs associated with the second basic service set.

In some examples, the frame transmission component 850 is configurable or configured to transmit, via the first channel and after the operation of the first wireless communication device is switched from the second channel to the first channel, a PPDU using a first set of one or more parameters different than a second set of one or more parameters used to transmit one or more frames via the second channel.

In some examples, the frame transmission component 850 is configurable or configured to transmit a RTS frame via the first channel in accordance with the operation of the first wireless communication device being switched from the second channel to the first channel. In some examples, the frame reception component 855 is configurable or configured to receive a CTS frame via the first channel in response to the RTS frame. In some examples, the frame transmission component 850 is configurable or configured to transmit a PPDU via the first channel in response to receiving the CTS frame.

In some examples, the frame transmission component 850 is configurable or configured to transmit, via the first channel, a PPDU associated with one or more quality of service parameters that satisfy a threshold in accordance with the operation of the first wireless communication device being switched from the second channel to the first channel.

In some examples, the frame transmission component 850 is configurable or configured to transmit a PPDU to a second wireless communication device via the first channel in accordance with the operation of the first wireless communication device being switched from the second channel to the first channel. In some examples, the response reception component 860 is configurable or configured to receive a message including a response to the PPDU from the second wireless communication device via the first channel, where the response indicates that a reason for the operation of the second wireless communication device being switched from the second channel to the first channel is the time indicated by the one or more frames, an expiration of a network allocation vector detected by the second wireless communication device for the first channel, or both.

In some examples, the response includes a multi-traffic identifier block acknowledgment frame that includes an association identifier-traffic identifier field that indicates the reason, a data frame that includes an aggregate control field that indicates the reason, or a management frame that includes an aggregate control field that indicates the reason, or any combination thereof.

In some examples, the first wireless communication device includes an AP. In some examples, the second wireless communication device includes a STA.

Additionally, or alternatively, the wireless communication device may support wireless communication in accordance with examples as disclosed herein. In some examples, the channel switching component 825 is configurable or configured to switch operation of the second wireless communication device from a first channel to a second channel in response to detection of one or more PPDUs via the first channel, the second wireless communication device being associated with a first basic service set, the one or more PPDUs being associated with a second basic service set different than the first basic service set. In some examples, the time indication component 835 is configurable or configured to receive, via the second channel and from a first wireless communication device, one or more frames indicating a time at which the first wireless communication device will switch from the second channel to the first channel. In some examples, the channel switching component 825 is configurable or configured to switch the operation of the second wireless communication device from the second channel to the first channel in accordance with the time indicated by the one or more frames.

In some examples, the one or more frames include an initial control frame or an initial control response received via the second channel.

In some examples, the one or more frames include each frame received from the first wireless communication device via the second channel after the operation of the second wireless communication device is switched from the first channel to the second channel.

In some examples, the one or more frames include one or more of a trigger frame that includes a special user information field that indicates the time, a multi-traffic identifier block acknowledgment frame that includes an association identifier-traffic identifier field that indicates the time, or a frame including a medium access control header that includes a duration field, an identifier field, or an aggregate control field that indicates the time.

In some examples, the one or more frames each indicate the time via a value associated with a time synchronization function.

In some examples, the time synchronization function is associated with a set of multiple bits. In some examples, the value associated with the time synchronization function is for a subset of the set of multiple bits.

In some examples, the one or more frames each indicate the time as a remaining quantity of time from an end of a PPDU received via the second channel in accordance with the operation of the second wireless communication device being switched from the first channel to the second channel.

In some examples, the operation of the second wireless communication device is switched from the second channel to the first channel within a duration starting at the time at which the first wireless communication device will switch from the second channel to the first channel.

In some examples, the frame reception component 855 is configurable or configured to receive, via the first channel and after the operation of the first wireless communication device is switched from the second channel to the first channel, a PPDU using a first set of one or more parameters different than a second set of one or more parameters used to receive one or more frames via the second channel.

In some examples, the frame reception component 855 is configurable or configured to receive a RTS frame via the first channel in accordance with the operation of the second wireless communication device being switched from the second channel to the first channel. In some examples, the frame transmission component 850 is configurable or configured to transmit a CTS frame via the first channel in response to the RTS frame. In some examples, the frame reception component 855 is configurable or configured to receive a PPDU via the first channel in response to receiving the CTS frame.

In some examples, the frame reception component 855 is configurable or configured to receive a PPDU from the first wireless communication device via the first channel in accordance with the operation of the second wireless communication device being switched from the second channel to the first channel. In some examples, the response transmission component 865 is configurable or configured to transmit a message including a response to the PPDU from the first wireless communication device via the first channel, where the response indicates that a reason for the operation of the second wireless communication device being switched from the second channel to the first channel is the time indicated by the one or more frames, a network allocation vector for the first channel associated with the second basic service set, or both.

In some examples, the response includes a multi-traffic identifier block acknowledgment frame that includes an association identifier-traffic identifier field that indicates the reason, a data frame that includes an aggregate control field that indicates the reason, or of a management frame that includes an aggregate control field that indicates the reason, or any combination thereof.

In some examples, the capability reporting component 870 is configurable or configured to transmit a capability report to the first wireless communication device indicating a capability of the second wireless communication device to switch the operation of the second wireless communication device from the second channel to the first channel according to the time.

In some examples, the activation component 875 is configurable or configured to receive, from the first wireless communication device, a control message indicating an activation of the time, where the one or more frames indicate the time in accordance with the control message.

In some examples, the first wireless communication device includes an AP. In some examples, the second wireless communication device includes a STA.

Additionally, or alternatively, the wireless communication device may support wireless communication in accordance with examples as disclosed herein. In some examples, the channel switching component 825 is configurable or configured to switch operation of the first wireless communication device from a first channel to a second channel in response to detection of one or more PPDUs via the first channel, the first wireless communication device being associated with a first basic service set, the one or more PPDUs being associated with a second basic service set different than the first basic service set. The TXOP indication component 840 is configurable or configured to transmit, to a second wireless communication device via the second channel and in accordance with a threshold quantity of attempts, one or more NPCA control frames that each indicate a transmission opportunity associated with the second channel. In some examples, the channel switching component 825 is configurable or configured to switch the operation of the first wireless communication device from the second channel to the first channel in accordance with an absence of a response to the one or more NPCA control frames and in accordance with a quantity of the one or more NPCA control frames satisfying the threshold quantity of attempts.

In some examples, the one or more NPCA control frames include a first NPCA control frame, and the contention window component 880 is configurable or configured to increase a contention window associated with a second NPCA control frame of the one or more NPCA control frames in accordance with an absence of a response to the first NPCA control frame. In some examples, the one or more NPCA control frames include a first NPCA control frame, and the frame transmission component 850 is configurable or configured to transmit the second NPCA control frame in accordance with the contention window being increased.

In some examples, the frame transmission component 850 is configurable or configured to transmit, to a third wireless communication device via the second channel and in accordance with a second threshold quantity of attempts, one or more additional NPCA control frames that each indicate a second transmission opportunity associated with the second channel, where the operation of the first wireless communication device is switched from the second channel to the first channel further in accordance with an absence of a response to the one or more additional NPCA control frames and in accordance with a quantity of the one or more additional NPCA control frames satisfying the second threshold quantity of attempts.

In some examples, the second threshold quantity of attempts associated with the third wireless communication device is different than the threshold quantity of attempts associated with the second wireless communication device.

In some examples, the attempts threshold component 885 is configurable or configured to receive a message including an indication of the threshold quantity of attempts from an access point of the first basic service set, the message including one or more of a beacon frame, an association response, or an acknowledgment frame that initiates a NPCA mode of the first wireless communication device.

In some examples, the attempts threshold component 885 is configurable or configured to select the threshold quantity of attempts in accordance with one or more previous attempts to communicate via the second channel.

In some examples, the capability reporting component 870 is configurable or configured to transmit a capability report indicating a capability of the first wireless communication device to switch the operation of the first wireless communication device from the second channel to the first channel in accordance with the threshold quantity of attempts.

In some examples, the activation component 875 is configurable or configured to receive a control message indicating an activation of the threshold quantity of attempts, where the operation of the first wireless communication device is switched from the second channel to the first channel in accordance with the control message.

Additionally, or alternatively, the wireless communication device may support wireless communication in accordance with examples as disclosed herein. In some examples, the channel switching component 825 is configurable or configured to switch operation of the first wireless communication device from a first channel to a second channel in response to a detection of one or more PPDUs via the first channel, the first wireless communication device being associated with a first basic service set, the one or more PPDUs being associated with a second basic service set different than the first basic service set. In some examples, the TXOP indication component 840 is configurable or configured to transmit, to a second wireless communication device via the second channel and in accordance with a timer, one or more NPCA control frames that each indicate a transmission opportunity associated with the second channel. In some examples, the channel switching component 825 is configurable or configured to switch the operation of the first wireless communication device from the second channel to the first channel in response to an expiration of the timer and in accordance with an absence of a response to the one or more NPCA control frames before the expiration of the timer.

In some examples, the one or more NPCA control frames are further transmitted in accordance with a threshold quantity of attempts while the timer is running. In some examples, the operation of the first wireless communication device is switched from the second channel to the first channel further in accordance with a quantity of the one or more NPCA control frames satisfying the threshold quantity of attempts.

In some examples, the operation of the first wireless communication device is switched from the second channel to the first channel further in accordance with an absence of receiving a NPCA control frame from a third wireless communication device.

In some examples, the channel switching component 825 is configurable or configured to switch operation of the first wireless communication device from the first channel to the second channel in response to a detection of one or more PPDUs associated with the second basic service set via the first channel. In some examples, the frame reception component 855 is configurable or configured to receive, from the second wireless communication device via the second channel and before an expiration of a second timer, a second NPCA control frame associated with a third wireless communication device, where the first wireless communication device maintains the operation via the second channel after the expiration of the second timer and in response to receiving the second NPCA control frame associated with the third wireless communication device.

In some examples, the timer component 890 is configurable or configured to initialize the timer in response to the operation of the first wireless communication device being switched from the first channel to the second channel.

In some examples, the frame transmission component 850 is configurable or configured to transmit, to a third wireless communication device via the second channel and in accordance with a second timer, one or more additional NPCA control frames that each indicate a second transmission opportunity associated with the second channel, where the operation of the first wireless communication device is switched from the second channel to the first channel further in accordance with an absence of a response to the one or more additional NPCA control frames before an expiration of the second timer.

In some examples, the second timer associated with the third wireless communication device is initialized to a different value than the timer associated with the second wireless communication device.

In some examples, the timer component 890 is configurable or configured to receive a message including an indication of a value for the timer from an access point of the first basic service set, the message including one or more of a beacon frame that indicates the value for the timer, an association response that indicates the value for the timer, or an acknowledgment frame that indicates the value for the timer and initiates a NPCA mode of the first wireless communication device.

In some examples, the timer component 890 is configurable or configured to select a value for the timer in accordance with one or more previous attempts to communicate via the second channel.

In some examples, the capability reporting component 870 is configurable or configured to transmit a capability report indicating a capability of the first wireless communication device to switch the operation of the first wireless communication device from the second channel to the first channel in accordance with the absence of a response to the one or more NPCA control frames before the expiration of the timer.

In some examples, the activation component 875 is configurable or configured to receive a control message indicating an activation of the timer, where the one or more NPCA control frames are transmitted in accordance with the control message.

Additionally, or alternatively, the wireless communication device may support wireless communication in accordance with examples as disclosed herein. In some examples, the channel switching component 825 is configurable or configured to switch operation of the first wireless communication device from a first channel to a second channel in response to detection of a first set of one or more PPDUs via the first channel, the first wireless communication device being associated with a first basic service set, the first set of one or more PPDUs associated with a second basic service set different than the first basic service set. The NAV detection component 845 is configurable or configured to detect, via the second channel, a second set of one or more PPDUs from a second wireless communication device of a third basic service set different than the first basic service set and the second basic service set, the second set of one or more PPDUs indicating a second network allocation vector associated with the second set of one or more PPDUs that extends past an expiration of a first network allocation vector associated with the first set of one or more PPDUs. In some examples, the channel switching component 825 is configurable or configured to switch the operation of the first wireless communication device from the second channel to the first channel prior to the expiration of the first network allocation vector in accordance with the second network allocation vector extending past the expiration of the first network allocation vector.

In some examples, the power saving component 895 is configurable or configured to enter a power saving mode until the expiration of the first network allocation vector in accordance with the second network allocation vector extending past the expiration of the first network allocation vector.

In some examples, the capability reporting component 870 is configurable or configured to transmit a capability report indicating a capability of the first wireless communication device to switch the operation of the first wireless communication device from the second channel to the first channel in accordance with the second network allocation vector associated with the second set of one or more PPDUs.

In some examples, the activation component 875 is configurable or configured to receive a control message indicating an activation of switching the operation of the first wireless communication device in accordance with the second network allocation vector, where the operation of the first wireless communication device is switched from the second channel to the first channel in accordance with the control message.

Additionally, or alternatively, the wireless communication device may support wireless communication in accordance with examples as disclosed herein. The channel switching component 825 is configurable or configured to switch operation of the first wireless communication device from a first channel to a second channel in response to detection of one or more PPDUs via the first channel, the first wireless communication device being associated with a first basic service set, the one or more PPDUs being associated with a second basic service set different than the first basic service set. The parameter indication component 897 is configurable or configured to broadcast, via the second channel and after the operation of the first wireless communication device is switched from the first channel to the second channel, a frame indicating one or more parameters associated with the first channel or associated with communication via the second channel, or both.

In some examples, the frame transmission component 850 is configurable or configured to transmit, while operating via the second channel, one or more frames to a second wireless communication device in accordance with the one or more parameters, where the one or more frames are transmitted within a duration parameter of the one or more parameters.

In some examples, the frame reception component 855 is configurable or configured to receive, while operating via the second channel, one or more frames from at least one wireless communication device, where each frame of the one or more frames is received in accordance with a bandwidth parameter of the one or more parameters, and where the one or more frames are received within a duration parameter of the one or more parameters.

In some examples, the frame is broadcast in accordance with an availability of downlink data or one or more triggers for uplink data.

In some examples, the frame reception component 855 is configurable or configured to receive an initial control frame from a second wireless communication device via the second channel, where the initial control frame indicates one or more requested parameters for communication via the second channel.

In some examples, the frame reception component 855 is configurable or configured to transmit, in accordance with the initial control frame, an initial control response frame to the second wireless communication device, where the initial control response frame is transmitted in accordance with the one or more requested parameters being accepted by the first wireless communication device.

In some examples, the parameter acceptance component 898 is configurable or configured to determine that the one or more requested parameters are accepted in accordance with a first duration parameter of the one or more requested parameters being less than or equal to a second duration parameter of the one or more parameters, or in accordance with a first bandwidth parameter of the one or more requested parameters being less than or equal to a second bandwidth parameter of the one or more parameters, or both.

In some examples, the frame transmission component 850 is configurable or configured to refrain from transmitting an initial control response frame to the second wireless communication device in accordance with the one or more requested parameters failing acceptance by the first wireless communication device.

In some examples, the one or more requested parameters include at least one of a duration parameter or a bandwidth parameter.

In some examples, the frame includes a broadcast initial control frame.

In some examples, the one or more parameters include at least one of a duration parameter or a bandwidth parameter.

In some examples, the bandwidth parameter includes a threshold bandwidth available for communicating frames via the second channel. In some examples, the duration parameter includes a threshold duration indicative of a time at which the first wireless communication device will switch from the second channel to the first channel.

In some examples, the frame includes a user information field (for example, an NPCA special user information field, a user information field associated with non-primary channel access) that includes respective fields for the one or more parameters.

Additionally, or alternatively, the wireless communication device may support wireless communication in accordance with examples as disclosed herein. In some examples, the channel switching component 825 is configurable or configured to switch operation of the second wireless communication device from a first channel to a second channel in response to detection of one or more PPDUs via the first channel, the second wireless communication device being associated with a first basic service set, the one or more PPDUs being associated with a second basic service set different than the first basic service set. In some examples, the parameter indication component 897 is configurable or configured to receive, via the second channel and from a first wireless communication device, a broadcast frame indicating one or more parameters associated with the first channel or associated with communication via the second channel, or both.

In some examples, the frame transmission component 850 is configurable or configured to transmit, while operating via the second channel, one or more frames to the first wireless communication device, where each frame of the one or more frames is transmitted in accordance with the one or more parameters, and where the one or more frames are transmitted within a duration parameter of the one or more parameters.

In some examples, the frame reception component 855 is configurable or configured to receive, while operating via the second channel, one or more frames from the first wireless communication device in accordance with a bandwidth parameter of the one or more parameters, where the one or more frames are received within a duration parameter of the one or more parameters.

In some examples, the frame transmission component 850 is configurable or configured to transmit an initial control frame to the first wireless communication device via the second channel, where the initial control frame is transmitted after a first initial control frame is received from the first wireless communication device or after a timer expires, where the initial control frame includes an indication of one or more requested parameters for communication via the second channel.

In some examples, the frame reception component 855 is configurable or configured to receive an initial control response frame from the first wireless communication device, where the initial control response frame is received in accordance with the one or more requested parameters being accepted by the first wireless communication device.

In some examples, the one or more requested parameters are accepted in accordance with a first duration parameter of the one or more requested parameters being less than or equal to a second duration parameter of the one or more parameters, or in accordance with a first bandwidth parameter of the one or more requested parameters being less than or equal to a second bandwidth parameter of the one or more parameters, or both.

In some examples, the one or more requested parameters include at least one of a duration parameter or a bandwidth parameter.

In some examples, the one or more parameters include at least one of a duration parameter or a bandwidth parameter.

In some examples, the bandwidth parameter includes a threshold bandwidth available for communicating frames via the second channel. In some examples, the duration parameter includes a threshold duration indicative of a time at which the first wireless communication device will switch from the second channel to the first channel.

In some examples, the broadcast frame includes an initial control frame received via the second channel.

In some examples, the broadcast frame includes a user information field (for example, an NPCA special user information field, a user information field associated with non-primary channel access) that includes respective fields for the one or more parameters.

Additionally, or alternatively, the wireless communication device may support wireless communication in accordance with examples as disclosed herein. In some examples, the channel switching component 825 is configurable or configured to switch operation of the first wireless communication device from a first channel to a second channel in response to detection of one or more PPDUs via the first channel, the first wireless communication device being associated with a first basic service set, the one or more PPDUs being associated with a second basic service set different than the first basic service set. In some examples, the parameter indication component 897 is configurable or configured to receive, via the second channel and from a second wireless communication device, a frame indicating one or more requested parameters for communication via the second channel.

In some examples, the parameter acceptance component 898 is configurable or configured to determine whether the one or more requested parameters are accepted in accordance with a comparison between the one or more requested parameters and one or more parameters associated with the first channel or associated with communication via the second channel, or both.

In some examples, the frame transmission component 850 is configurable or configured to transmit, while operating via the second channel, a response frame to the second wireless communication device, where the response frame is transmitted in accordance with the one or more requested parameters being accepted by the first wireless communication device.

In some examples, the frame transmission component 850 is configurable or configured to refrain from transmitting a response frame to the second wireless communication device in accordance with at least one of the one or more requested parameters failing acceptance by the first wireless communication device.

In some examples, the one or more requested parameters are accepted in accordance with a first duration parameter of the one or more requested parameters being less than or equal to a second duration parameter of the one or more parameters, or in accordance with a first bandwidth parameter of the one or more requested parameters being less than or equal to a second bandwidth parameter of the one or more parameters, or both.

In some examples, the one or more requested parameters include at least one of a requested transmission opportunity duration or a bandwidth parameter.

Additionally, or alternatively, the wireless communication device may support wireless communication in accordance with examples as disclosed herein. In some examples, the channel switching component 825 is configurable or configured to switch operation of the second wireless communication device from a first channel to a second channel in response to detection of one or more PPDUs via the first channel, the second wireless communication device being associated with a first basic service set, the one or more PPDUs being associated with a second basic service set different than the first basic service set. In some examples, the parameter indication component 897 is configurable or configured to transmit, via the second channel and after the operation of the second wireless communication device is switched from the first channel to the second channel, a frame indicating one or more requested parameters for communication via the second channel.

In some examples, the frame reception component 855 is configurable or configured to receive, while operating via the second channel, a response frame from a first wireless communication device, where the response frame is received in accordance with the one or more requested parameters. In some examples, the frame transmission component 850 is configurable or configured to transmit at least one PPDU via the second channel to the first wireless communication device in accordance with the one or more requested parameters.

In some examples, the one or more requested parameters include at least one of a requested transmission opportunity duration or a bandwidth parameter.

Additionally, or alternatively, the wireless communication device may support wireless communication in accordance with examples as disclosed herein. In some examples, the channel switching component 825 is configurable or configured to switch operation of the first wireless communication device from a first channel to a second channel in response to detection of one or more PPDUs via the first channel, the first wireless communication device being associated with a first basic service set, the one or more PPDUs being associated with a second basic service set different than the first basic service set. In some examples, the parameter indication component 897 is configurable or configured to transmit, via the second channel and to a second wireless communication device is switched from the first channel to the second channel, a frame indicating one or more requested parameters for communication via the second channel. The parameter indication component 897 is configurable or configured to receive, via the second channel and from the second wireless communication device, a response frame indicating one or more allowed parameters for communication via the second channel. The frame transmission component 850 is configurable or configured to transmit one or more frames to the second wireless communication device in accordance with the one or more allowed parameters.

In some examples, the parameter modification component 899 is configurable or configured to modify at least one of a communication bandwidth or a transmission opportunity duration for transmitting the one or more frames in accordance with the one or more allowed parameters.

In some examples, the one or more allowed parameters include at least one of an allowed transmission opportunity duration or an allowed bandwidth parameter.

In some examples, the allowed transmission opportunity duration includes a threshold duration in accordance with a first comparison between a requested transmission opportunity duration of the one or more requested parameters and a duration associated with at least one PPDU detected via the first channel by the second wireless communication device. In some examples, the allowed bandwidth parameter includes a threshold bandwidth in accordance with a second comparison between a requested bandwidth parameter of the one or more requested parameters and an available bandwidth of the second channel for the second wireless communication device.

In some examples, the frame includes an initial control frame that includes a user information field (for example, an NPCA special user information field, a user information field associated with non-primary channel access) that includes respective fields for the one or more requested parameters.

In some examples, the response frame includes a multi-station block acknowledgment frame that includes a bitmap indicating the one or more allowed parameters.

Additionally, or alternatively, the wireless communication device may support wireless communication in accordance with examples as disclosed herein. In some examples, the channel switching component 825 is configurable or configured to switch operation of the second wireless communication device from a first channel to a second channel in response to detection of one or more PPDUs via the first channel, the second wireless communication device being associated with a first basic service set, the one or more PPDUs being associated with a second basic service set different than the first basic service set. In some examples, the parameter indication component 897 is configurable or configured to receive, via the second channel and from a first wireless communication device, a frame indicating one or more requested parameters for communication via the second channel. In some examples, the parameter indication component 897 is configurable or configured to transmit, via the second channel and to the first wireless communication device, a response frame indicating one or more allowed parameters for communication via the second channel. The frame reception component 855 is configurable or configured to receive one or more frames to the second wireless communication device in accordance with the one or more allowed parameters.

In some examples, the one or more allowed parameters are in accordance with the one or more PPDUs detected via the first channel by the second wireless communication device.

In some examples, the one or more allowed parameters include at least one of an allowed transmission opportunity duration or an allowed bandwidth parameter.

In some examples, the allowed transmission opportunity duration includes a threshold duration in accordance with a first comparison between a requested transmission opportunity duration of the one or more requested parameters and a duration associated with at least one PPDU detected via the first channel by the second wireless communication device. In some examples, the allowed bandwidth parameter includes a threshold bandwidth in accordance with a second comparison between a requested bandwidth parameter of the one or more requested parameters and an available bandwidth of the second channel for the second wireless communication device.

In some examples, the frame includes an initial control frame that includes a user information field (for example, an NPCA special user information field, a user information field associated with non-primary channel access) that includes respective fields for the one or more requested parameters.

In some examples, the response frame includes a multi-station block acknowledgment frame that includes a bitmap indicating the one or more allowed parameters.

FIG. 9 shows a flowchart illustrating an example process 900 performable by or at a first wireless communication device that supports NPCA coordination. The operations of the process 900 may be implemented by a first wireless communication device or its components as described herein. For example, the process 900 may be performed by a wireless communication device, such as the wireless communication device described with reference to FIG. 8, operating as or within a wireless AP or a wireless STA. In some examples, the process 900 may be performed by a wireless AP or a wireless STA, such as one of the APs 102 or the STAs 104 described with reference to FIG. 1.

In some examples, in 905, the first wireless communication device may switch operation of the first wireless communication device from a first channel to a second channel in response to detection of one or more PPDUs via the first channel, the first wireless communication device being associated with a first basic service set, the one or more PPDUs being associated with a second basic service set different than the first basic service set. The operations of 905 may be performed in accordance with examples as disclosed herein. In some implementations, aspects of the operations of 905 may be performed by a channel switching component 825 as described with reference to FIG. 8.

In some examples, in 910, the first wireless communication device may transmit, via the second channel and after the operation of the first wireless communication device is switched from the first channel to the second channel, an indication that the first wireless communication device will switch from the second channel to the first channel. The operations of 910 may be performed in accordance with examples as disclosed herein. In some implementations, aspects of the operations of 910 may be performed by a switching indication component 830 as described with reference to FIG. 8.

In some examples, in 915, the first wireless communication device may switch the operation of the first wireless communication device from the second channel to the first channel in accordance with the indication. The operations of 915 may be performed in accordance with examples as disclosed herein. In some implementations, aspects of the operations of 915 may be performed by a channel switching component 825 as described with reference to FIG. 8.

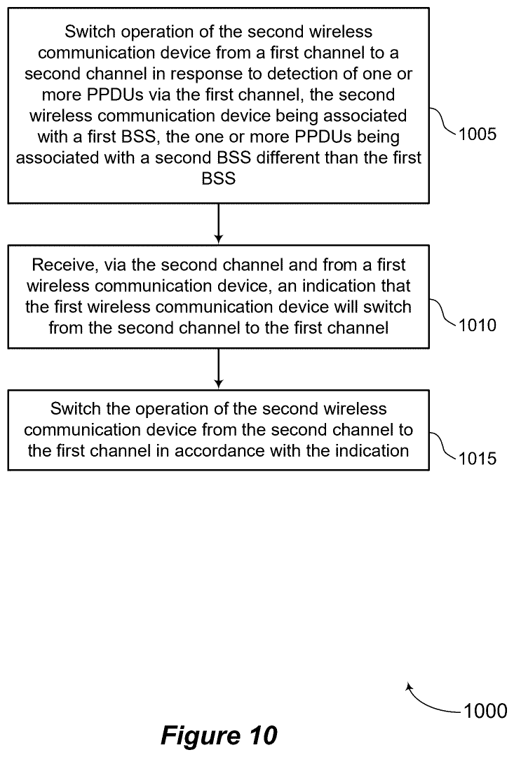

FIG. 10 shows a flowchart illustrating an example process 1000 performable by or at a second wireless communication device that supports NPCA coordination. The operations of the process 1000 may be implemented by a second wireless communication device or its components as described herein. For example, the process 1000 may be performed by a wireless communication device, such as the wireless communication device described with reference to FIG. 8, operating as or within a wireless AP or a wireless STA. In some examples, the process 1000 may be performed by a wireless AP or a wireless STA, such as one of the APs 102 or the STAs 104 described with reference to FIG. 1.

In some examples, in 1005, the second wireless communication device may switch operation of the second wireless communication device from a first channel to a second channel in response to detection of one or more PPDUs via the first channel, the second wireless communication device being associated with a first basic service set, the one or more PPDUs being associated with a second basic service set different than the first basic service set. The operations of 1005 may be performed in accordance with examples as disclosed herein. In some implementations, aspects of the operations of 1005 may be performed by a channel switching component 825 as described with reference to FIG. 8.

In some examples, in 1010, the second wireless communication device may receive, via the second channel and from a first wireless communication device, an indication that the first wireless communication device will switch from the second channel to the first channel. The operations of 1010 may be performed in accordance with examples as disclosed herein. In some implementations, aspects of the operations of 1010 may be performed by a switching indication component 830 as described with reference to FIG. 8.

In some examples, in 1015, the second wireless communication device may switch the operation of the second wireless communication device from the second channel to the first channel in accordance with the indication. The operations of 1015 may be performed in accordance with examples as disclosed herein. In some implementations, aspects of the operations of 1015 may be performed by a channel switching component 825 as described with reference to FIG. 8.

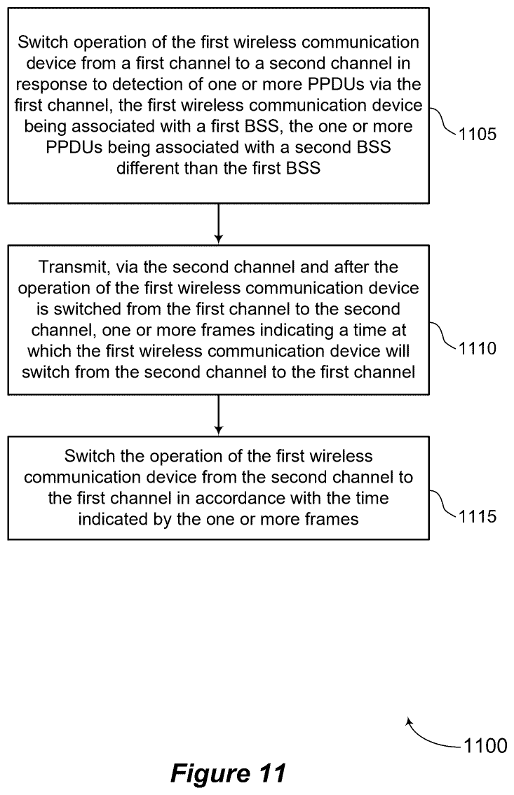

FIG. 11 shows a flowchart illustrating an example process 1100 performable by or at a first wireless communication device that supports NPCA coordination. The operations of the process 1100 may be implemented by a first wireless communication device or its components as described herein. For example, the process 1100 may be performed by a wireless communication device, such as the wireless communication device described with reference to FIG. 8, operating as or within a wireless AP or a wireless STA. In some examples, the process 1100 may be performed by a wireless AP or a wireless STA, such as one of the APs 102 or the STAs 104 described with reference to FIG. 1.

In some examples, in 1105, the first wireless communication device may switch operation of the first wireless communication device from a first channel to a second channel in response to detection of one or more PPDUs via the first channel, the first wireless communication device being associated with a first basic service set, the one or more PPDUs being associated with a second basic service set different than the first basic service set. The operations of 1105 may be performed in accordance with examples as disclosed herein. In some implementations, aspects of the operations of 1105 may be performed by a channel switching component 825 as described with reference to FIG. 8.

In some examples, in 1110, the first wireless communication device may transmit, via the second channel and after the operation of the first wireless communication device is switched from the first channel to the second channel, one or more frames indicating a time at which the first wireless communication device will switch from the second channel to the first channel. The operations of 1110 may be performed in accordance with examples as disclosed herein. In some implementations, aspects of the operations of 1110 may be performed by a time indication component 835 as described with reference to FIG. 8.

In some examples, in 1115, the first wireless communication device may switch the operation of the first wireless communication device from the second channel to the first channel in accordance with the time indicated by the one or more frames. The operations of 1115 may be performed in accordance with examples as disclosed herein. In some implementations, aspects of the operations of 1115 may be performed by a channel switching component 825 as described with reference to FIG. 8.

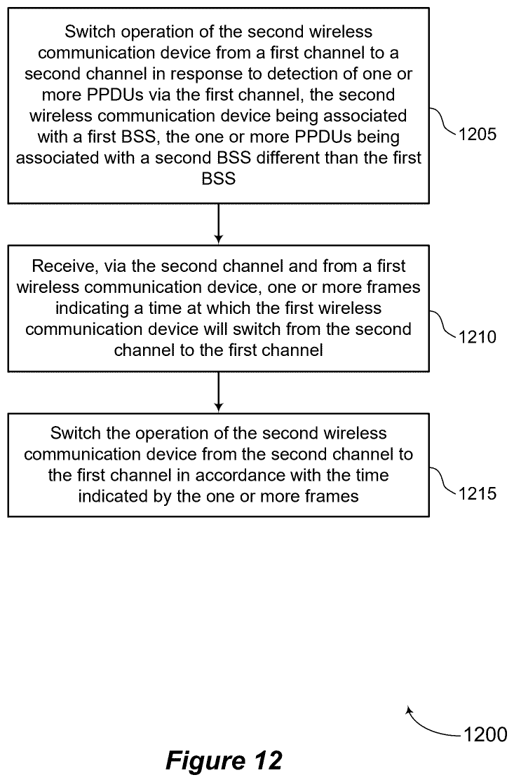

FIG. 12 shows a flowchart illustrating an example process 1200 performable by or at a second wireless communication device that supports NPCA coordination. The operations of the process 1200 may be implemented by a second wireless communication device or its components as described herein. For example, the process 1200 may be performed by a wireless communication device, such as the wireless communication device described with reference to FIG. 8, operating as or within a wireless AP or a wireless STA. In some examples, the process 1200 may be performed by a wireless AP or a wireless STA, such as one of the APs 102 or the STAs 104 described with reference to FIG. 1.

In some examples, in 1205, the second wireless communication device may switch operation of the second wireless communication device from a first channel to a second channel in response to detection of one or more PPDUs via the first channel, the second wireless communication device being associated with a first basic service set, the one or more PPDUs being associated with a second basic service set different than the first basic service set. The operations of 1205 may be performed in accordance with examples as disclosed herein. In some implementations, aspects of the operations of 1205 may be performed by a channel switching component 825 as described with reference to FIG. 8.

In some examples, in 1210, the second wireless communication device may receive, via the second channel and from a first wireless communication device, one or more frames indicating a time at which the first wireless communication device will switch from the second channel to the first channel. The operations of 1210 may be performed in accordance with examples as disclosed herein. In some implementations, aspects of the operations of 1210 may be performed by a time indication component 835 as described with reference to FIG. 8.

In some examples, in 1215, the second wireless communication device may switch the operation of the second wireless communication device from the second channel to the first channel in accordance with the time indicated by the one or more frames. The operations of 1215 may be performed in accordance with examples as disclosed herein. In some implementations, aspects of the operations of 1215 may be performed by a channel switching component 825 as described with reference to FIG. 8.

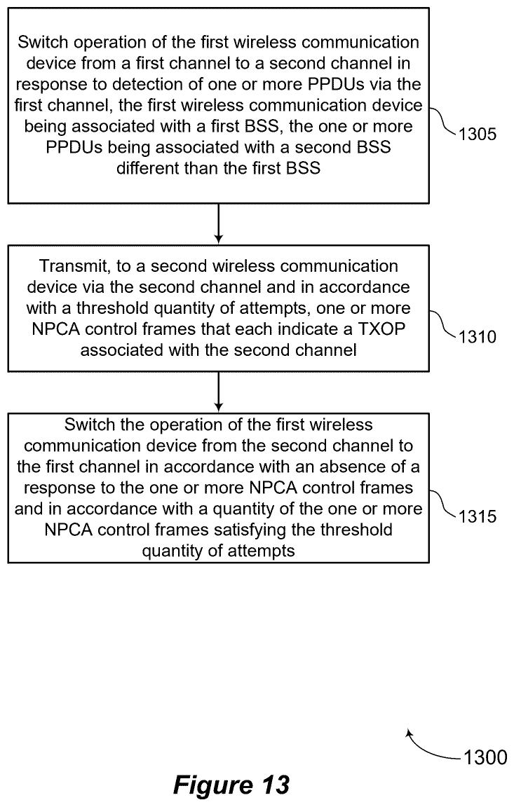

FIG. 13 shows a flowchart illustrating an example process 1300 performable by or at a first wireless communication device that supports NPCA coordination. The operations of the process 1300 may be implemented by a first wireless communication device or its components as described herein. For example, the process 1300 may be performed by a wireless communication device, such as the wireless communication device described with reference to FIG. 8, operating as or within a wireless AP or a wireless STA. In some examples, the process 1300 may be performed by a wireless AP or a wireless STA, such as one of the APs 102 or the STAs 104 described with reference to FIG. 1.

In some examples, in 1305, the first wireless communication device may switch operation of the first wireless communication device from a first channel to a second channel in response to detection of one or more PPDUs via the first channel, the first wireless communication device being associated with a first basic service set, the one or more PPDUs being associated with a second basic service set different than the first basic service set. The operations of 1305 may be performed in accordance with examples as disclosed herein. In some implementations, aspects of the operations of 1305 may be performed by a channel switching component 825 as described with reference to FIG. 8.

In some examples, in 1310, the first wireless communication device may transmit, to a second wireless communication device via the second channel and in accordance with a threshold quantity of attempts, one or more NPCA control frames that each indicate a transmission opportunity associated with the second channel. The operations of 1310 may be performed in accordance with examples as disclosed herein. In some implementations, aspects of the operations of 1310 may be performed by a TXOP indication component 840 as described with reference to FIG. 8.

In some examples, in 1305, the first wireless communication device may switch the operation of the first wireless communication device from the second channel to the first channel in accordance with an absence of a response to the one or more NPCA control frames and in accordance with a quantity of the one or more NPCA control frames satisfying the threshold quantity of attempts. The operations of 1315 may be performed in accordance with examples as disclosed herein. In some implementations, aspects of the operations of 1315 may be performed by a channel switching component 825 as described with reference to FIG. 8.

FIG. 14 shows a flowchart illustrating an example process 1400 performable by or at a first wireless communication device that supports NPCA coordination. The operations of the process 1400 may be implemented by a first wireless communication device or its components as described herein. For example, the process 1400 may be performed by a wireless communication device, such as the wireless communication device described with reference to FIG. 8, operating as or within a wireless AP or a wireless STA. In some examples, the process 1400 may be performed by a wireless AP or a wireless STA, such as one of the APs 102 or the STAs 104 described with reference to FIG. 1.

In some examples, in 1405, the first wireless communication device may switch operation of the first wireless communication device from a first channel to a second channel in response to a detection of one or more PPDUs via the first channel, the first wireless communication device being associated with a first basic service set, the one or more PPDUs being associated with a second basic service set different than the first basic service set. The operations of 1405 may be performed in accordance with examples as disclosed herein. In some implementations, aspects of the operations of 1405 may be performed by a channel switching component 825 as described with reference to FIG. 8.

In some examples, in 1410, the first wireless communication device may transmit, to a second wireless communication device via the second channel and in accordance with a timer, one or more NPCA control frames that each indicate a transmission opportunity associated with the second channel. The operations of 1410 may be performed in accordance with examples as disclosed herein. In some implementations, aspects of the operations of 1410 may be performed by a TXOP indication component 840 as described with reference to FIG. 8.

In some examples, in 1415, the first wireless communication device may switch the operation of the first wireless communication device from the second channel to the first channel in response to an expiration of the timer and in accordance with an absence of a response to the one or more NPCA control frames before the expiration of the timer. The operations of 1415 may be performed in accordance with examples as disclosed herein. In some implementations, aspects of the operations of 1415 may be performed by a channel switching component 825 as described with reference to FIG. 8.

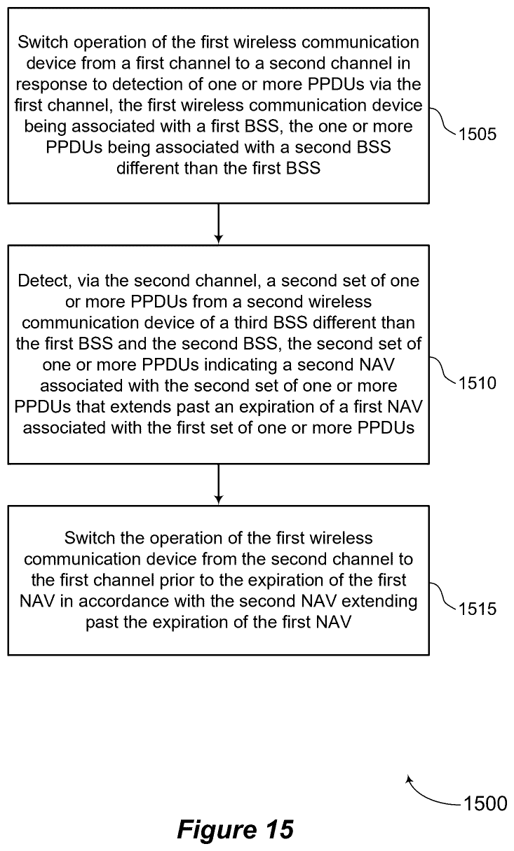

FIG. 15 shows a flowchart illustrating an example process 1500 performable by or at a first wireless communication device that supports NPCA coordination. The operations of the process 1500 may be implemented by a first wireless communication device or its components as described herein. For example, the process 1500 may be performed by a wireless communication device, such as the wireless communication device described with reference to FIG. 8, operating as or within a wireless AP or a wireless STA. In some examples, the process 1500 may be performed by a wireless AP or a wireless STA, such as one of the APs 102 or the STAs 104 described with reference to FIG. 1.

In some examples, in 1505, the first wireless communication device may switch operation of the first wireless communication device from a first channel to a second channel in response to detection of a first set of one or more PPDUs via the first channel, the first wireless communication device being associated with a first basic service set, the first set of one or more PPDUs associated with a second basic service set different than the first basic service set. The operations of 1505 may be performed in accordance with examples as disclosed herein. In some implementations, aspects of the operations of 1505 may be performed by a channel switching component 825 as described with reference to FIG. 8.

In some examples, in 1505, the first wireless communication device may detect, via the second channel, a second set of one or more PPDUs from a second wireless communication device of a third basic service set different than the first basic service set and the second basic service set, the second set of one or more PPDUs indicating a second network allocation vector associated with the second set of one or more PPDUs that extends past an expiration of a first network allocation vector associated with the first set of one or more PPDUs. The operations of 1510 may be performed in accordance with examples as disclosed herein. In some implementations, aspects of the operations of 1510 may be performed by a NAV detection component 845 as described with reference to FIG. 8.

In some examples, in 1505, the first wireless communication device may switch the operation of the first wireless communication device from the second channel to the first channel prior to the expiration of the first network allocation vector in accordance with the second network allocation vector extending past the expiration of the first network allocation vector. The operations of 1515 may be performed in accordance with examples as disclosed herein. In some implementations, aspects of the operations of 1515 may be performed by a channel switching component 825 as described with reference to FIG. 8.

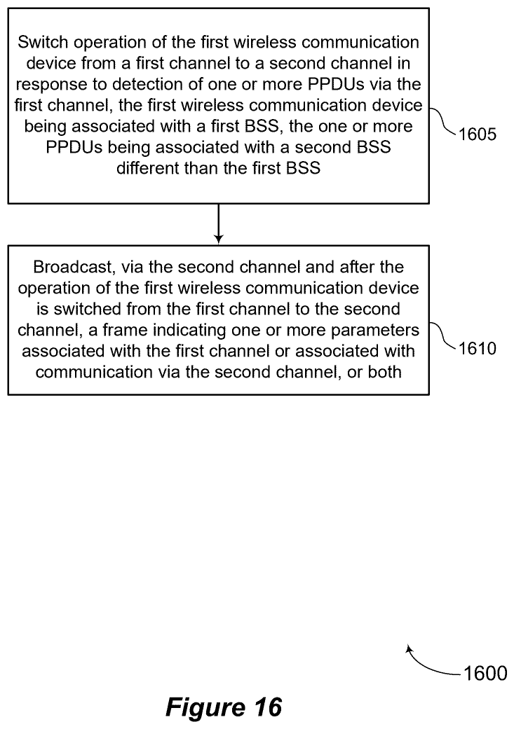

FIG. 16 shows a flowchart illustrating an example process 1600 performable by or at a first wireless communication device that supports NPCA coordination. The operations of the process 1600 may be implemented by a first wireless communication device or its components as described herein. For example, the process 1600 may be performed by a wireless communication device, such as the wireless communication device described with reference to FIG. 8, operating as or within a wireless AP or a wireless STA. In some examples, the process 1600 may be performed by a wireless AP or a wireless STA, such as one of the APs 102 or the STAs 104 described with reference to FIG. 1.

In some examples, in 1605, the first wireless communication device may switch operation of the first wireless communication device from a first channel to a second channel in response to detection of one or more PPDUs via the first channel, the first wireless communication device being associated with a first basic service set, the one or more PPDUs being associated with a second basic service set different than the first basic service set. The operations of 1605 may be performed in accordance with examples as disclosed herein. In some implementations, aspects of the operations of 1605 may be performed by a channel switching component 825 as described with reference to FIG. 8.

In some examples, in 1610, the first wireless communication device may broadcast, via the second channel and after the operation of the first wireless communication device is switched from the first channel to the second channel, a frame indicating one or more parameters associated with the first channel or associated with communication via the second channel, or both. The operations of 1610 may be performed in accordance with examples as disclosed herein. In some implementations, aspects of the operations of 1610 may be performed by a parameter indication component 897 as described with reference to FIG. 8.

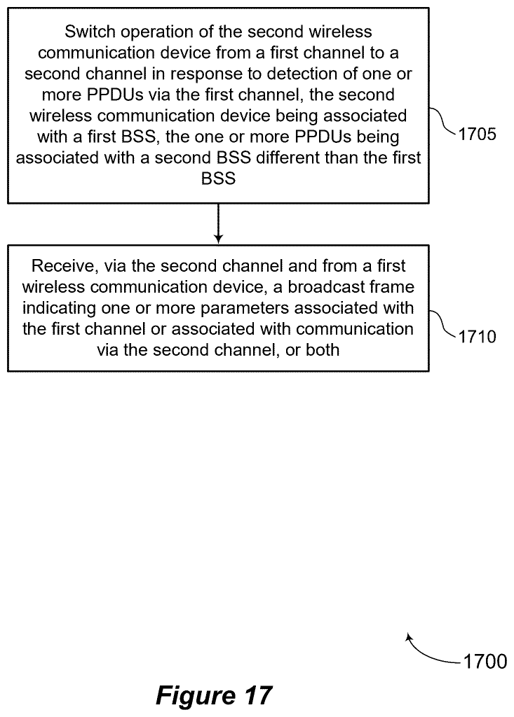

FIG. 17 shows a flowchart illustrating an example process 1700 performable by or at a second wireless communication device that supports NPCA coordination. The operations of the process 1700 may be implemented by a second wireless communication device or its components as described herein. For example, the process 1700 may be performed by a wireless communication device, such as the wireless communication device described with reference to FIG. 8, operating as or within a wireless AP or a wireless STA. In some examples, the process 1700 may be performed by a wireless AP or a wireless STA, such as one of the APs 102 or the STAs 104 described with reference to FIG. 1.

In some examples, in 1705, the second wireless communication device may switch operation of the second wireless communication device from a first channel to a second channel in response to detection of one or more PPDUs via the first channel, the second wireless communication device being associated with a first basic service set, the one or more PPDUs being associated with a second basic service set different than the first basic service set. The operations of 1705 may be performed in accordance with examples as disclosed herein. In some implementations, aspects of the operations of 1705 may be performed by a channel switching component 825 as described with reference to FIG. 8.

In some examples, in 1710, the second wireless communication device may receive, via the second channel and from a first wireless communication device, a broadcast frame indicating one or more parameters associated with the first channel or associated with communication via the second channel, or both. The operations of 1710 may be performed in accordance with examples as disclosed herein. In some implementations, aspects of the operations of 1710 may be performed by a parameter indication component 897 as described with reference to FIG. 8.

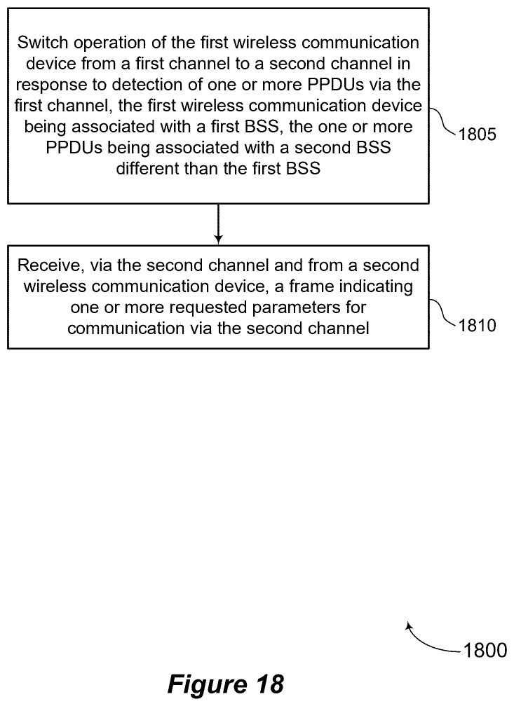

FIG. 18 shows a flowchart illustrating an example process 1800 performable by or at a first wireless communication device that supports NPCA coordination. The operations of the process 1800 may be implemented by a first wireless communication device or its components as described herein. For example, the process 1800 may be performed by a wireless communication device, such as the wireless communication device described with reference to FIG. 8, operating as or within a wireless AP or a wireless STA. In some examples, the process 1800 may be performed by a wireless AP or a wireless STA, such as one of the APs 102 or the STAs 104 described with reference to FIG. 1.

In some examples, in 1805, the first wireless communication device may switch operation of the first wireless communication device from a first channel to a second channel in response to detection of one or more PPDUs via the first channel, the first wireless communication device being associated with a first basic service set, the one or more PPDUs being associated with a second basic service set different than the first basic service set. The operations of 1805 may be performed in accordance with examples as disclosed herein. In some implementations, aspects of the operations of 1805 may be performed by a channel switching component 825 as described with reference to FIG. 8.

In some examples, in 1810, the first wireless communication device may receive, via the second channel and from a second wireless communication device, a frame indicating one or more requested parameters for communication via the second channel. The operations of 1810 may be performed in accordance with examples as disclosed herein. In some implementations, aspects of the operations of 1810 may be performed by a parameter indication component 897 as described with reference to FIG. 8.

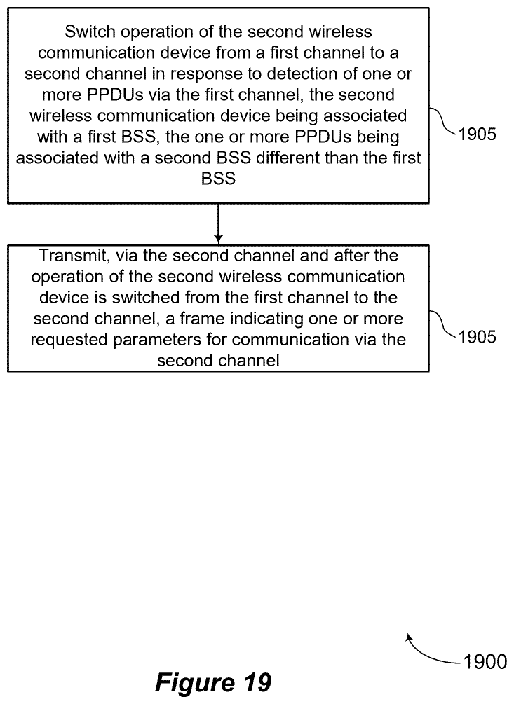

FIG. 19 shows a flowchart illustrating an example process 1900 performable by or at a second wireless communication device that supports NPCA coordination. The operations of the process 1900 may be implemented by a second wireless communication device or its components as described herein. For example, the process 1900 may be performed by a wireless communication device, such as the wireless communication device described with reference to FIG. 8, operating as or within a wireless AP or a wireless STA. In some examples, the process 1900 may be performed by a wireless AP or a wireless STA, such as one of the APs 102 or the STAs 104 described with reference to FIG. 1.

In some examples, in 1905, the second wireless communication device may switch operation of the second wireless communication device from a first channel to a second channel in response to detection of one or more PPDUs via the first channel, the second wireless communication device being associated with a first basic service set, the one or more PPDUs being associated with a second basic service set different than the first basic service set. The operations of 1905 may be performed in accordance with examples as disclosed herein. In some implementations, aspects of the operations of 1905 may be performed by a channel switching component 825 as described with reference to FIG. 8.

In some examples, in 1910, the second wireless communication device may transmit, via the second channel and after the operation of the second wireless communication device is switched from the first channel to the second channel, a frame indicating one or more requested parameters for communication via the second channel. The operations of 1910 may be performed in accordance with examples as disclosed herein. In some implementations, aspects of the operations of 1910 may be performed by a parameter indication component 897 as described with reference to FIG. 8.

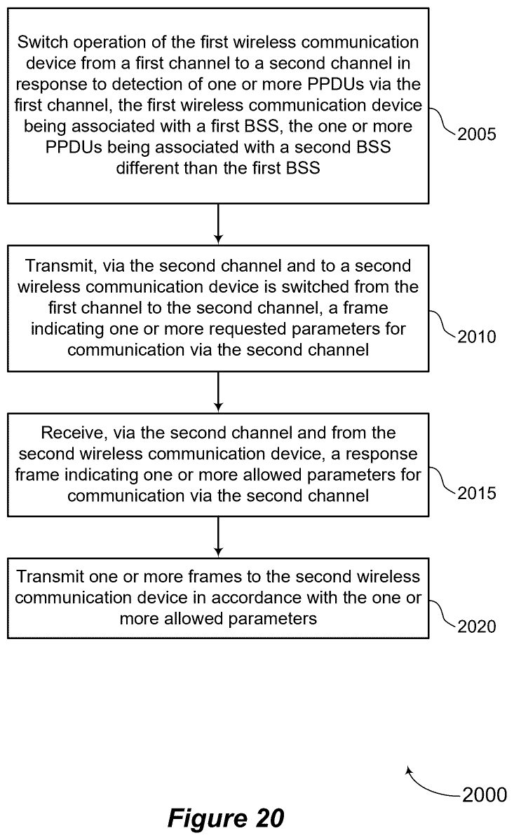

FIG. 20 shows a flowchart illustrating an example process 2000 performable by or at a first wireless communication device that supports NPCA coordination. The operations of the process 2000 may be implemented by a first wireless communication device or its components as described herein. For example, the process 2000 may be performed by a wireless communication device, such as the wireless communication device described with reference to FIG. 8, operating as or within a wireless AP or a wireless STA. In some examples, the process 2000 may be performed by a wireless AP or a wireless STA, such as one of the APs 102 or the STAs 104 described with reference to FIG. 1.

In some examples, in 2005, the first wireless communication device may switch operation of the first wireless communication device from a first channel to a second channel in response to detection of one or more PPDUs via the first channel, the first wireless communication device being associated with a first basic service set, the one or more PPDUs being associated with a second basic service set different than the first basic service set. The operations of 2005 may be performed in accordance with examples as disclosed herein. In some examples, aspects of the operations of 2005 may be performed by a channel switching component 825 as described with reference to FIG. 8.

In some examples, in 2010, the first wireless communication device may transmit, via the second channel and to a second wireless communication device is switched from the first channel to the second channel, a frame indicating one or more requested parameters for communication via the second channel. The operations of 2010 may be performed in accordance with examples as disclosed herein. In some examples, aspects of the operations of 2010 may be performed by a parameter indication component 897 as described with reference to FIG. 8.

In some examples, in 2015, the first wireless communication device may receive, via the second channel and from the second wireless communication device, a response frame indicating one or more allowed parameters for communication via the second channel. The operations of 2015 may be performed in accordance with examples as disclosed herein. In some examples, aspects of the operations of 2015 may be performed by an parameter indication component 897 as described with reference to FIG. 8.

In some examples, in 2015, the first wireless communication device may transmit one or more frames to the second wireless communication device in accordance with the one or more allowed parameters. The operations of 2020 may be performed in accordance with examples as disclosed herein. In some examples, aspects of the operations of 2020 may be performed by a frame transmission component 850 as described with reference to FIG. 8.

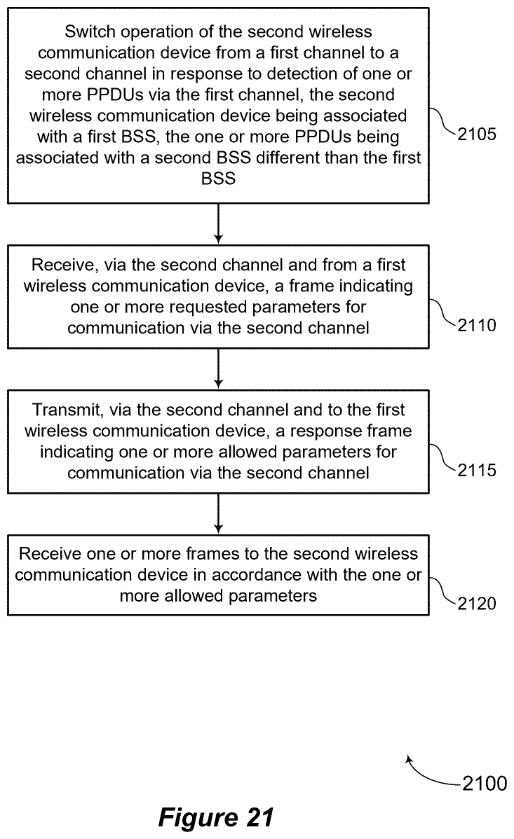

FIG. 21 shows a flowchart illustrating an example process 2100 performable by or at a second wireless communication device that supports NPCA coordination. The operations of the process 2100 may be implemented by a second wireless communication device or its components as described herein. For example, the process 2100 may be performed by a wireless communication device, such as the wireless communication device described with reference to FIG. 8, operating as or within a wireless AP or a wireless STA. In some examples, the process 2100 may be performed by a wireless AP or a wireless STA, such as one of the APs 102 or the STAs 104 described with reference to FIG. 1.

In some examples, in 2105, the second wireless communication device may switch operation of the second wireless communication device from a first channel to a second channel in response to detection of one or more PPDUs via the first channel, the second wireless communication device being associated with a first basic service set, the one or more PPDUs being associated with a second basic service set different than the first basic service set. The operations of 2105 may be performed in accordance with examples as disclosed herein. In some examples, aspects of the operations of 2105 may be performed by a channel switching component 825 as described with reference to FIG. 8.

In some examples, in 2110, the second wireless communication device may receive, via the second channel and from a first wireless communication device, a frame indicating one or more requested parameters for communication via the second channel. The operations of 2110 may be performed in accordance with examples as disclosed herein. In some examples, aspects of the operations of 2110 may be performed by a parameter indication component 897 as described with reference to FIG. 8.

In some examples, in 2115, the second wireless communication device may transmit, via the second channel and to the first wireless communication device, a response frame indicating one or more allowed parameters for communication via the second channel. The operations of 2115 may be performed in accordance with examples as disclosed herein. In some examples, aspects of the operations of 2115 may be performed by a parameter indication component 897 as described with reference to FIG. 8.

In some examples, in 2120, the second wireless communication device may receive one or more frames to the second wireless communication device in accordance with the one or more allowed parameters. The operations of 2120 may be performed in accordance with examples as disclosed herein. In some examples, aspects of the operations of 2120 may be performed by a frame reception component 855 as described with reference to FIG. 8.

Implementation examples are described in the following numbered clauses:
Aspect 1: A method for wireless communication by a first wireless communication device, comprising: switching operation of the first wireless communication device from a first channel to a second channel in response to detection of one or more PPDUs via the first channel, the first wireless communication device being associated with a first BSS, the one or more PPDUs being associated with a second BSS different than the first BSS; transmitting, via the second channel and after the operation of the first wireless communication device is switched from the first channel to the second channel, an indication that the first wireless communication device will switch from the second channel to the first channel; and switching the operation of the first wireless communication device from the second channel to the first channel in accordance with the indication.
Aspect 2: The method of aspect 1, wherein the indication is included in a NPCA announcement frame.
Aspect 3: The method of aspect 2, wherein the NPCA announcement frame comprises one or more of a contention-free end frame, a CTS-to-self frame comprising a value of zero for at least one of a duration field or an identity field, a multi-station BA, an a-control element in a MAC header of a QoS null frame, a null management frame, an action frame, or a frame including an end of service period field comprising a value of one.
Aspect 4: The method of any of aspects 1-3, further comprising: transmitting, while operating via the second channel, one or more frames to a second wireless communication device, wherein at least one frame of the one or more frames comprises the indication.
Aspect 5: The method of aspect 4, wherein the at least one frame comprising the indication solicits a response from the second wireless communication device.
Aspect 6: The method of aspect 5, further comprising: receiving a message comprising the response from the second wireless communication device, wherein the operation of the first wireless communication device is switched from the second channel to the first channel in accordance with a duration starting at an end of the message.
Aspect 7: The method of any of aspects 1-4, wherein the indication is included in a frame that is unassociated with a response from the second wireless communication device.
Aspect 8: The method of aspect 7, wherein the operation of the first wireless communication device is switched from the second channel to the first channel in accordance with a duration starting at an end of a frame comprising the indication.
Aspect 9: The method of any of aspects 1-8, wherein the operation of the first wireless communication device is switched from the second channel to the first channel in accordance with a buffer period extending from an end of a frame comprising the indication.
Aspect 10: The method of any of aspects 1-9, wherein the indication that the operation of the first wireless communication device will switch from the second channel to the first channel is associated with an expiration of a NAV for the one or more PPDUs associated with the second BSS.
Aspect 11: The method of any of aspects 1-10, further comprising: transmitting, via the first channel and after the operation of the first wireless communication device is switched from the second channel to the first channel, a PPDU using a first set of one or more parameters different than a second set of one or more parameters used to transmit one or more frames via the second channel.
Aspect 12: The method of any of aspects 1-11, further comprising: transmitting a RTS frame via the first channel in accordance with the operation of the first wireless communication device being switched from the second channel to the first channel; receiving a CTS frame via the first channel in response to the RTS frame; and transmitting a PPDU via the first channel in response to receiving the CTS frame.
Aspect 13: The method of any of aspects 1-12, further comprising: transmitting, via the first channel, a PPDU associated with one or more quality of service parameters that satisfy a threshold in accordance with the operation of the first wireless communication device being switched from the second channel to the first channel.
Aspect 14: The method of any of aspects 1-13, further comprising: transmitting a PPDU to a second wireless communication device via the first channel in accordance with the operation of the first wireless communication device being switched from the second channel to the first channel; and receiving a message comprising a response to the PPDU from the second wireless communication device via the first channel, wherein the response indicates that a reason for the operation of the second wireless communication device being switched from the second channel to the first channel comprises the indication, an expiration of a NAV, or both.
Aspect 15: The method of aspect 14, wherein the response comprises one or more of a multi-TID block acknowledgment frame that includes an AID-TID field that indicates the reason, a data frame that includes an a-control field that indicates the reason, or a management frame that includes an a-control field that indicates the reason.
Aspect 16: The method of any of aspects 14-15, wherein the first wireless communication device comprises an AP, and the second wireless communication device comprises a STA.
Aspect 17: A method for wireless communication at a second wireless communication device, comprising: switching operation of the second wireless communication device from a first channel to a second channel in response to detection of one or more PPDUs via the first channel, the second wireless communication device being associated with a first BSS, the one or more PPDUs being associated with a second BSS different than the first BSS; receiving, via the second channel and from a first wireless communication device, an indication that the first wireless communication device will switch from the second channel to the first channel; and switching the operation of the second wireless communication device from the second channel to the first channel in accordance with the indication.
Aspect 18: The method of aspect 17, further comprising: receiving one or more messages from the first wireless communication device via the second channel, wherein the second wireless communication device maintains the operation via the second channel at least until the indication is received and in accordance with receiving the one or more messages.
Aspect 19: The method of aspect 18, wherein the one or more messages are intended for the second wireless communication device, intended for a third wireless communication device of the first BSS, or both.
Aspect 20: The method of any of aspects 17-19, further comprising: transmitting a message comprising a response to the indication; and switching the operation of the second wireless communication device from the second channel to the first channel in accordance with a duration starting at an end of the message.
Aspect 21: The method of any of aspects 17-20, wherein the indication is included in a NPCA announcement frame.
Aspect 22: The method of aspect 21, wherein the NPCA announcement frame comprises one or more of a contention-free end frame, a CTS-to-self frame comprising a value of zero for at least one of a duration field or an identity field, a multi-station block acknowledgment, an a-control element in a MAC header of a QoS null frame, a null management frame, an action frame, or a frame including an end of service period field comprising a value of one.
Aspect 23: The method of any of aspects 17-22, further comprising: receiving, while operating via the second channel, one or more frames from the first wireless communication device, wherein at least one frame of the one or more frames comprises the indication.
Aspect 24: The method of aspect 23, wherein the at least one frame comprising the indication solicits a response from the second wireless communication device.
Aspect 25: The method of aspect 24, further comprising: transmitting a message comprising the response, wherein the operation of the second wireless communication device is switched from the second channel to the first channel in accordance with a duration starting at an end of the message.
Aspect 26: The method of aspect 23, wherein the at least one frame comprising the indication is unassociated with a response from the second wireless communication device.
Aspect 27: The method of aspect 26, wherein the operation of the second wireless communication device is switched from the second channel to the first channel in accordance with a duration starting at an end of a frame comprising the indication.
Aspect 28: The method of any of aspects 17-27, wherein the operation of the second wireless communication device is switched from the second channel to the first channel in accordance with a buffer period extending from an end of a frame comprising the indication.
Aspect 29: The method of any of aspects 17-28, further comprising: receiving, via the first channel and after the operation of the second wireless communication device is switched from the second channel to the first channel, a PPDU using a first set of one or more parameters different than a second set of one or more parameters used to receive one or more frames via the second channel.
Aspect 30: The method of any of aspects 17-29, further comprising: receiving a RTS frame via the first channel in accordance with the operation of the second wireless communication device being switched from the second channel to the first channel; transmitting a CTS frame via the first channel in response to the RTS frame; and receiving a PPDU via the first channel in response to transmitting the CTS frame.
Aspect 31: The method of any of aspects 17-30, further comprising: receiving a PPDU from the first wireless communication device via the first channel in accordance with the operation of the second wireless communication device being switched from the second channel to the first channel; and transmitting a message comprising a response to the PPDU to the first wireless communication device via the first channel, wherein the response indicates that a reason for the operation of the second wireless communication device being switched from the second channel to the first channel is the indication, an expiration of a NAV for the first channel associated with the second BSS, or both.
Aspect 32: The method of aspect 31, wherein the response comprises one or more of a multi-TID block acknowledgment frame that includes an AID-TID field that indicates the reason, a data frame that includes an a-control field that indicates the reason, or a management frame that includes an a-control field that indicates the reason.
Aspect 33: The method of any of aspects 17-32, further comprising: transmitting a capability report to the first wireless communication device indicating a capability of the second wireless communication device to switch the operation of the second wireless communication device from the second channel to the first channel in response to the indication.
Aspect 34: The method of any of aspects 17-33, further comprising: receiving, from the first wireless communication device, a control message indicating an activation of the indication, wherein the indication is received in accordance with the control message.
Aspect 35: The method of any of aspects 17-34, wherein the first wireless communication device comprises an AP, and the second wireless communication device comprises a STA.
Aspect 36: A method for wireless communication at a first wireless communication device, comprising: switching operation of the first wireless communication device from a first channel to a second channel in response to detection of one or more PPDUs via the first channel, the first wireless communication device being associated with a first BSS, the one or more PPDUs being associated with a second BSS different than the first BSS; transmitting, via the second channel and after the operation of the first wireless communication device is switched from the first channel to the second channel, one or more frames indicating a time at which the first wireless communication device will switch from the second channel to the first channel; and switching the operation of the first wireless communication device from the second channel to the first channel in accordance with the time indicated by the one or more frames.
Aspect 37: The method of aspect 36, wherein the one or more frames comprise an initial control frame or an initial control response transmitted via the second channel.
Aspect 38: The method of any of aspects 36-37, wherein the one or more frames comprise each frame transmitted by the first wireless communication device via the second channel after the operation of the first wireless communication device is switched from the first channel to the second channel.
Aspect 39: The method of any of aspects 36-38, wherein the one or more frames comprise one or more of a trigger frame that includes a special user information field that indicates the time, a multi-TID block acknowledgment frame that includes an AID-TID field that indicates the time, or a frame comprising a MAC header that includes a duration field, an identifier field, or an a-control field of that indicates the time.
Aspect 40: The method of any of aspects 36-39, wherein the one or more frames each indicate the time via a value associated with a time synchronization function.
Aspect 41: The method of aspect 40, wherein the time synchronization function is associated with a plurality of bits, and the value associated with the time synchronization function is for a subset of the plurality of bits.
Aspect 42: The method of any of aspects 36-41, wherein the one or more frames each indicate the time as a remaining quantity of time from an end of a PPDU transmitted via the second channel in accordance with the operation of the first wireless communication device being switched from the first channel to the second channel.
Aspect 43: The method of any of aspects 36-42, wherein the operation of the first wireless communication device is switched from the second channel to the first channel within a duration starting at the time at which the first wireless communication device will switch from the second channel to the first channel.
Aspect 44: The method of any of aspects 36-43, wherein the time is associated with an expiration of a NAV of the one or more PPDUs associated with the second BSS.
Aspect 45: The method of any of aspects 36-44, further comprising: transmitting, via the first channel and after the operation of the first wireless communication device is switched from the second channel to the first channel, a PPDU using a first set of one or more parameters different than a second set of one or more parameters used to transmit one or more frames via the second channel.
Aspect 46: The method of any of aspects 36-45, further comprising: transmitting a RTS frame via the first channel in accordance with the operation of the first wireless communication device being switched from the second channel to the first channel; receiving a CTS frame via the first channel in response to the RTS frame; and transmitting a PPDU via the first channel in response to receiving the CTS frame.
Aspect 47: The method of any of aspects 36-46, further comprising: transmitting, via the first channel, a PPDU associated with one or more quality of service parameters that satisfy a threshold in accordance with the operation of the first wireless communication device being switched from the second channel to the first channel.
Aspect 48: The method of any of aspects 36-47, further comprising: transmitting a PPDU to a second wireless communication device via the first channel in accordance with the operation of the first wireless communication device being switched from the second channel to the first channel; and receiving a message comprising a response to the PPDU from the second wireless communication device via the first channel, wherein the response indicates that a reason for the operation of the second wireless communication device being switched from the second channel to the first channel is the time indicated by the one or more frames, an expiration of a NAV detected by the second wireless communication device for the first channel, or both.
Aspect 49: The method of aspect 48, wherein the response comprises a multi-TID block acknowledgment frame that includes an AID-TID field that indicates the reason, a data frame that includes an a-control field that indicates the reason, or a management frame that includes an a-control field that indicates the reason, or any combination thereof.
Aspect 50: The method of any of aspects 48-49, wherein the first wireless communication device comprises an AP, and the second wireless communication device comprises a STA.
Aspect 51: A method for wireless communication at a second wireless communication device, comprising: switching operation of the second wireless communication device from a first channel to a second channel in response to detection of one or more PPDUs via the first channel, the second wireless communication device being associated with a first BSS, the one or more PPDUs being associated with a second BSS different than the first BSS; receiving, via the second channel and from a first wireless communication device, one or more frames indicating a time at which the first wireless communication device will switch from the second channel to the first channel; and switching the operation of the second wireless communication device from the second channel to the first channel in accordance with the time indicated by the one or more frames.
Aspect 52: The method of aspect 51, wherein the one or more frames comprise an initial control frame or an initial control response received via the second channel.
Aspect 53: The method of any of aspects 51-52, wherein the one or more frames comprise each frame received from the first wireless communication device via the second channel after the operation of the second wireless communication device is switched from the first channel to the second channel.
Aspect 54: The method of any of aspects 51-53, wherein the one or more frames comprise one or more of a trigger frame that includes a special user information field that indicates the time, a multi-TID block acknowledgment frame that includes an AID-TID field that indicates the time, or a frame comprising a MAC header that includes a duration field, an identifier field, or an a-control field that indicates the time.
Aspect 55: The method of any of aspects 51-54, wherein the one or more frames each indicate the time via a value associated with a time synchronization function.
Aspect 56: The method of aspect 55, wherein the time synchronization function is associated with a plurality of bits, and the value associated with the time synchronization function is for a subset of the plurality of bits.
Aspect 57: The method of any of aspects 51-56, wherein the one or more frames each indicate the time as a remaining quantity of time from an end of a PPDU received via the second channel in accordance with the operation of the second wireless communication device being switched from the first channel to the second channel.
Aspect 58: The method of any of aspects 51-57, wherein the operation of the second wireless communication device is switched from the second channel to the first channel within a duration starting at the time at which the first wireless communication device will switch from the second channel to the first channel.
Aspect 59: The method of any of aspects 51-58, further comprising: receiving, via the first channel and after the operation of the first wireless communication device is switched from the second channel to the first channel, a PPDU using a first set of one or more parameters different than a second set of one or more parameters used to receive one or more frames via the second channel.
Aspect 60: The method of any of aspects 51-59, further comprising: receiving a RTS frame via the first channel in accordance with the operation of the second wireless communication device being switched from the second channel to the first channel; transmitting a CTS frame via the first channel in response to the RTS frame; and receiving a PPDU via the first channel in response to receiving the CTS frame.
Aspect 61: The method of any of aspects 51-60, further comprising: receiving a PPDU from the first wireless communication device via the first channel in accordance with the operation of the second wireless communication device being switched from the second channel to the first channel; and transmitting a message comprising a response to the PPDU from the first wireless communication device via the first channel, wherein the response indicates that a reason for the operation of the second wireless communication device being switched from the second channel to the first channel is the time indicated by the one or more frames, a NAV for the first channel associated with the second BSS, or both.
Aspect 62: The method of aspect 61, wherein the response comprises a multi-TID block acknowledgment frame that includes an AID-TID field that indicates the reason, a data frame that includes an a-control field that indicates the reason, or of a management frame that includes an a-control field that indicates the reason, or any combination thereof.
Aspect 63: The method of any of aspects 51-62, further comprising: transmitting a capability report to the first wireless communication device indicating a capability of the second wireless communication device to switch the operation of the second wireless communication device from the second channel to the first channel according to the time.
Aspect 64: The method of any of aspects 51-63, further comprising: receiving, from the first wireless communication device, a control message indicating an activation of the time, wherein the one or more frames indicate the time in accordance with the control message.
Aspect 65: The method of any of aspects 51-64, wherein the first wireless communication device comprises an AP, and the second wireless communication device comprises a STA.
Aspect 66: A method for wireless communication at a first wireless communication device, comprising: switching operation of the first wireless communication device from a first channel to a second channel in response to detection of one or more PPDUs via the first channel, the first wireless communication device being associated with a first BSS, the one or more PPDUs being associated with a second BSS different than the first BSS; transmitting, to a second wireless communication device via the second channel and in accordance with a threshold quantity of attempts, one or more NPCA control frames that each indicate a transmission opportunity associated with the second channel; and switching the operation of the first wireless communication device from the second channel to the first channel in accordance with an absence of a response to the one or more NPCA control frames and in accordance with a quantity of the one or more NPCA control frames satisfying the threshold quantity of attempts.
Aspect 67: The method of aspect 66, wherein the one or more NPCA control frames include a first NPCA control frame, the method further comprising: increasing a contention window associated with a second NPCA control frame of the one or more NPCA control frames in accordance with an absence of a response to the first NPCA control frame; and transmitting the second NPCA control frame in accordance with the contention window being increased.
Aspect 68: The method of any of aspects 66-67, further comprising: transmitting, to a third wireless communication device via the second channel and in accordance with a second threshold quantity of attempts, one or more additional NPCA control frames that each indicate a second transmission opportunity associated with the second channel, wherein the operation of the first wireless communication device is switched from the second channel to the first channel further in accordance with an absence of a response to the one or more additional NPCA control frames and in accordance with a quantity of the one or more additional NPCA control frames satisfying the second threshold quantity of attempts.
Aspect 69: The method of aspect 68, wherein the second threshold quantity of attempts associated with the third wireless communication device is different than the threshold quantity of attempts associated with the second wireless communication device.
Aspect 70: The method of any of aspects 66-69, further comprising; receiving a message comprising an indication of the threshold quantity of attempts from an AP of the first BSS, the message comprising one or more of a beacon frame, an association response, or an acknowledgment frame that initiates a non-primary channel access mode of the first wireless communication device.
Aspect 71: The method of any of aspects 66-70, further comprising: selecting the threshold quantity of attempts in accordance with one or more previous attempts to communicate via the second channel.
Aspect 72: The method of any of aspects 66-71, further comprising: transmitting a capability report indicating a capability of the first wireless communication device to switch the operation of the first wireless communication device from the second channel to the first channel in accordance with the threshold quantity of attempts.
Aspect 73: The method of any of aspects 66-72, further comprising: receiving a control message indicating an activation of the threshold quantity of attempts, wherein the operation of the first wireless communication device is switched from the second channel to the first channel in accordance with the control message.
Aspect 74: A method for wireless communication at a first wireless communication device, comprising: switching operation of the first wireless communication device from a first channel to a second channel in response to a detection of one or more PPDUs via the first channel, the first wireless communication device being associated with a first BSS, the one or more PPDUs being associated with a second BSS different than the first BSS; transmitting, to a second wireless communication device via the second channel and in accordance with a timer, one or more NPCA control frames that each indicate a transmission opportunity associated with the second channel; and switching the operation of the first wireless communication device from the second channel to the first channel in response to an expiration of the timer and in accordance with an absence of a response to the one or more NPCA control frames before the expiration of the timer.
Aspect 75: The method of aspect 74, wherein the one or more NPCA control frames are further transmitted in accordance with a threshold quantity of attempts while the timer is running, and the operation of the first wireless communication device is switched from the second channel to the first channel further in accordance with a quantity of the one or more NPCA control frames satisfying the threshold quantity of attempts.
Aspect 76: The method of any of aspects 74-75, wherein the operation of the first wireless communication device is switched from the second channel to the first channel further in accordance with an absence of receiving a non-primary channel access control frame from a third wireless communication device.
Aspect 77: The method of any of aspects 74-76, further comprising: switching operation of the first wireless communication device from the first channel to the second channel in response to a detection of one or more PPDUs associated with the second BSS via the first channel; and receiving, from the second wireless communication device via the second channel and before an expiration of a second timer, a second NPCA control frame associated with a third wireless communication device, wherein the first wireless communication device maintains the operation via the second channel after the expiration of the second timer and in response to receiving the second NPCA control frame associated with the third wireless communication device.
Aspect 78: The method of any of aspects 74-77, further comprising: initializing the timer in response to the operation of the first wireless communication device being switched from the first channel to the second channel.
Aspect 79: The method of any of aspects 74-78, further comprising: transmitting, to a third wireless communication device via the second channel and in accordance with a second timer, one or more additional NPCA control frames that each indicate a second transmission opportunity associated with the second channel, wherein the operation of the first wireless communication device is switched from the second channel to the first channel further in accordance with an absence of a response to the one or more additional NPCA control frames before an expiration of the second timer.
Aspect 80: The method of aspect 79, wherein the second timer associated with the third wireless communication device is initialized to a different value than the timer associated with the second wireless communication device.
Aspect 81: The method of any of aspects 74-80, further comprising; receiving a message comprising an indication of a value for the timer from an AP of the first BSS, the message comprising one or more of a beacon frame that indicates the value for the timer, an association response that indicates the value for the timer, or an acknowledgment frame that indicates the value for the timer and initiates a non-primary channel access mode of the first wireless communication device.
Aspect 82: The method of any of aspects 74-81, further comprising: selecting a value for the timer in accordance with one or more previous attempts to communicate via the second channel.
Aspect 83: The method of any of aspects 74-82, further comprising: transmitting a capability report indicating a capability of the first wireless communication device to switch the operation of the first wireless communication device from the second channel to the first channel in accordance with the absence of a response to the one or more NPCA control frames before the expiration of the timer.
Aspect 84: The method of any of aspects 74-83, further comprising: receiving a control message indicating an activation of the timer, wherein the one or more NPCA control frames are transmitted in accordance with the control message.
Aspect 85: A method for wireless communication at a first wireless communication device, comprising: switching operation of the first wireless communication device from a first channel to a second channel in response to detection of a first set of one or more PPDUs via the first channel, the first wireless communication device being associated with a first BSS, the first set of one or more PPDUs associated with a second BSS different than the first BSS; detecting, via the second channel, a second set of one or more PPDUs from a second wireless communication device of a third BSS different than the first BSS and the second BSS, the second set of one or more PPDUs indicating a second NAV associated with the second set of one or more PPDUs that extends past an expiration of a first NAV associated with the first set of one or more PPDUs; and switching the operation of the first wireless communication device from the second channel to the first channel prior to the expiration of the first NAV in accordance with the second NAV extending past the expiration of the first NAV.
Aspect 86: The method of aspect 85, further comprising: entering a power saving mode until the expiration of the first NAV in accordance with the second NAV extending past the expiration of the first NAV.
Aspect 87: The method of any of aspects 85-86, further comprising: transmitting a capability report indicating a capability of the first wireless communication device to switch the operation of the first wireless communication device from the second channel to the first channel in accordance with the second NAV associated with the second set of one or more PPDUs.
Aspect 88: The method of any of aspects 85-87, further comprising: receiving a control message indicating an activation of switching the operation of the first wireless communication device in accordance with the second NAV, wherein the operation of the first wireless communication device is switched from the second channel to the first channel in accordance with the control message.
Aspect 89: A first wireless communication device for wireless communication, comprising one or more memories storing processor-executable code, and one or more processors coupled with the one or more memories and individually or collectively operable to execute the code to cause the first wireless communication device to perform a method of any of aspects 1-16.
Aspect 90: A first wireless communication device for wireless communication, comprising at least one means for performing a method of any of aspects 1-16.
Aspect 91: A non-transitory computer-readable medium storing code for wireless communication, the code comprising instructions executable by one or more processors to perform a method of any of aspects 1-16.
Aspect 92: A second wireless communication device for wireless communication, comprising one or more memories storing processor-executable code, and one or more processors coupled with the one or more memories and individually or collectively operable to execute the code to cause the second wireless communication device to perform a method of any of aspects 17-35.
Aspect 93: A second wireless communication device for wireless communication, comprising at least one means for performing a method of any of aspects 17-35.
Aspect 94: A non-transitory computer-readable medium storing code for wireless communication, the code comprising instructions executable by one or more processors to perform a method of any of aspects 17-35.
Aspect 95: A first wireless communication device for wireless communication, comprising one or more memories storing processor-executable code, and one or more processors coupled with the one or more memories and individually or collectively operable to execute the code to cause the first wireless communication device to perform a method of any of aspects 36-50.
Aspect 96: A first wireless communication device for wireless communication, comprising at least one means for performing a method of any of aspects 36-50.
Aspect 97: A non-transitory computer-readable medium storing code for wireless communication, the code comprising instructions executable by one or more processors to perform a method of any of aspects 36-50.
Aspect 98: A second wireless communication device for wireless communication, comprising one or more memories storing processor-executable code, and one or more processors coupled with the one or more memories and individually or collectively operable to execute the code to cause the second wireless communication device to perform a method of any of aspects 51-65.
Aspect 99: A second wireless communication device for wireless communication, comprising at least one means for performing a method of any of aspects 51-65.
Aspect 100: A non-transitory computer-readable medium storing code for wireless communication, the code comprising instructions executable by one or more processors to perform a method of any of aspects 51-65.
Aspect 101: A first wireless communication device for wireless communication, comprising one or more memories storing processor-executable code, and one or more processors coupled with the one or more memories and individually or collectively operable to execute the code to cause the first wireless communication device to perform a method of any of aspects 66-73.
Aspect 102: A first wireless communication device for wireless communication, comprising at least one means for performing a method of any of aspects 66-73.
Aspect 103: A non-transitory computer-readable medium storing code for wireless communication, the code comprising instructions executable by one or more processors to perform a method of any of aspects 66-73.
Aspect 104: A first wireless communication device for wireless communication, comprising one or more memories storing processor-executable code, and one or more processors coupled with the one or more memories and individually or collectively operable to execute the code to cause the first wireless communication device to perform a method of any of aspects 74-84.
Aspect 105: A first wireless communication device for wireless communication, comprising at least one means for performing a method of any of aspects 74-84.
Aspect 106: A non-transitory computer-readable medium storing code for wireless communication, the code comprising instructions executable by one or more processors to perform a method of any of aspects 74-84.
Aspect 107: A first wireless communication device for wireless communication, comprising one or more memories storing processor-executable code, and one or more processors coupled with the one or more memories and individually or collectively operable to execute the code to cause the first wireless communication device to perform a method of any of aspects 85-88.
Aspect 108: A first wireless communication device for wireless communication, comprising at least one means for performing a method of any of aspects 85-88.
Aspect 109: A non-transitory computer-readable medium storing code for wireless communication, the code comprising instructions executable by one or more processors to perform a method of any of aspects 85-88.
Aspect 110: A method for wireless communication at a first wireless communication device, comprising: switching operation of the first wireless communication device from a first channel to a second channel in response to detection of one or more PPDUs via the first channel, the first wireless communication device being associated with a first BSS, the one or more PPDUs being associated with a second BSS different than the first BSS; and broadcasting, via the second channel and after the operation of the first wireless communication device is switched from the first channel to the second channel, a frame indicating one or more parameters associated with the first channel or associated with communication via the second channel, or both.
Aspect 111: The method of aspect 110, further comprising: transmitting, while operating via the second channel, one or more frames to a second wireless communication device in accordance with the one or more parameters, wherein the one or more frames are transmitted within a duration parameter of the one or more parameters and occupy a bandwidth that is less than a bandwidth parameter of the one or more parameters.
Aspect 112: The method of any of aspects 110-111, further comprising: receiving, while operating via the second channel, one or more frames from at least one wireless communication device, wherein each frame of the one or more frames is received in accordance with a bandwidth parameter of the one or more parameters, and wherein the one or more frames are received within a duration parameter of the one or more parameters.
Aspect 113: The method of any of aspects 110-112, wherein the frame is broadcast in accordance with an availability of downlink data or one or more triggers for uplink data.
Aspect 114: The method of any of aspects 110-113, further comprising: receiving an ICF from a second wireless communication device via the second channel, wherein the ICF indicates one or more requested parameters for communication via the second channel.
Aspect 115: The method of aspect 114, further comprising: transmitting, in accordance with the ICF, an ICR frame to the second wireless communication device, wherein the ICR frame is transmitted in accordance with the one or more requested parameters being accepted by the first wireless communication device.
Aspect 116: The method of aspect 115, further comprising: determining that the one or more requested parameters are accepted in accordance with a first duration parameter of the one or more requested parameters being less than or equal to a second duration parameter of the one or more parameters, or in accordance with a first bandwidth parameter of the one or more requested parameters being less than or equal to a second bandwidth parameter of the one or more parameters, or both.
Aspect 117: The method of aspect 114, further comprising: refraining from transmitting an ICR frame to the second wireless communication device in accordance with the one or more requested parameters failing acceptance by the first wireless communication device.
Aspect 118: The method of any of aspects 114-117, wherein the one or more requested parameters comprise at least one of a duration parameter or a bandwidth parameter.
Aspect 119: The method of any of aspects 110-118, wherein the frame comprises a broadcast ICF.
Aspect 120: The method of any of aspects 110-119, wherein the one or more parameters comprise at least one of a duration parameter or a bandwidth parameter.
Aspect 121: The method of aspect 120, wherein the bandwidth parameter comprises a threshold bandwidth available for communicating frames via the second channel, and the duration parameter comprises a threshold duration indicative of a time at which the first wireless communication device will switch from the second channel to the first channel.
Aspect 122: The method of any of aspects 110-121, wherein the frame comprises a user information field (for example, an NPCA special user information field, a user information field associated with non-primary channel access) that includes respective fields for the one or more parameters.
Aspect 123: A method for wireless communication at a second wireless communication device, comprising: switching operation of the second wireless communication device from a first channel to a second channel in response to detection of one or more PPDUs via the first channel, the second wireless communication device being associated with a first BSS, the one or more PPDUs being associated with a second BSS different than the first BSS; and receiving, via the second channel and from a first wireless communication device, a broadcast frame indicating one or more parameters associated with the first channel or associated with communication via the second channel, or both.
Aspect 124: The method of aspect 123, further comprising: transmitting, while operating via the second channel, one or more frames to the first wireless communication device, wherein each frame of the one or more frames is transmitted in accordance with the one or more parameters, and wherein the one or more frames are transmitted within a duration parameter of the one or more parameters and occupy a bandwidth that is less than a bandwidth parameter of the one or more parameters.
Aspect 125: The method of any of aspects 123-124, further comprising: receiving, while operating via the second channel, one or more frames from the first wireless communication device in accordance with a bandwidth parameter of the one or more parameters, wherein the one or more frames are received within a duration parameter of the one or more parameters.
Aspect 126: The method of any of aspects 123-125, further comprising: transmitting an ICF to the first wireless communication device via the second channel, wherein the ICF is transmitted after a first ICF is received from the first wireless communication device or after a timer expires, wherein the ICF comprises an indication of one or more requested parameters for communication via the second channel.
Aspect 127: The method of aspect 126, further comprising: receiving an ICR frame from the first wireless communication device, wherein the ICR frame is received in accordance with the one or more requested parameters being accepted by the first wireless communication device.
Aspect 128: The method of aspect 127, wherein the one or more requested parameters are accepted in accordance with a first duration parameter of the one or more requested parameters being less than or equal to a second duration parameter of the one or more parameters, or in accordance with a first bandwidth parameter of the one or more requested parameters being less than or equal to a second bandwidth parameter of the one or more parameters, or both.
Aspect 129: The method of any of aspects 126-128, wherein the one or more requested parameters comprise at least one of a duration parameter or a bandwidth parameter.
Aspect 130: The method of any of aspects 123-129, wherein the one or more parameters comprise at least one of a duration parameter or a bandwidth parameter.
Aspect 131: The method of aspect 130, wherein the bandwidth parameter comprises a threshold bandwidth available for communicating frames via the second channel, and the duration parameter comprises a threshold duration indicative of a time at which the first wireless communication device will switch from the second channel to the first channel.
Aspect 132: The method of any of aspects 123-131, wherein the broadcast frame comprises an ICF received via the second channel.
Aspect 133: The method of any of aspects 123-132, wherein the broadcast frame comprises a user information field (for example, an NPCA special user information field, a user information field associated with non-primary channel access) that includes respective fields for the one or more parameters.
Aspect 134: A method for wireless communication at a first wireless communication device, comprising: switching operation of the first wireless communication device from a first channel to a second channel in response to detection of one or more PPDUs via the first channel, the first wireless communication device being associated with a first BSS, the one or more PPDUs being associated with a second BSS different than the first BSS; receiving, via the second channel and from a second wireless communication device, a frame indicating one or more requested parameters for communication via the second channel.
Aspect 135: The method of aspect 134, further comprising: determining whether the one or more requested parameters are accepted in accordance with a comparison between the one or more requested parameters and one or more parameters associated with the first channel or associated with communication via the second channel, or both.
Aspect 136: The method of aspect 135, further comprising: transmitting, while operating via the second channel, a response frame to the second wireless communication device, wherein the response frame is transmitted in accordance with the one or more requested parameters being accepted by the first wireless communication device.
Aspect 137: The method of aspect 135, further comprising: refraining from transmitting a response frame to the second wireless communication device in accordance with at least one of the one or more requested parameters failing acceptance by the first wireless communication device.
Aspect 138: The method of any of aspects 135 and 27, wherein the one or more requested parameters are accepted in accordance with a first duration parameter of the one or more requested parameters being less than or equal to a second duration parameter of the one or more parameters, or in accordance with a first bandwidth parameter of the one or more requested parameters being less than or equal to a second bandwidth parameter of the one or more parameters, or both.
Aspect 139: The method of any of aspects 134-138, wherein the one or more requested parameters comprise at least one of a requested TXOP duration or a bandwidth parameter.
Aspect 140: The method of any of aspects 134-139, wherein the frame comprises an initial control frame.
Aspect 141: The method of any of aspects 134-140, wherein the one or more requested parameters correspond to requested non-primary channel access (NPCA) parameters.
Aspect 142: The method of any of aspects 134-141, wherein the frame comprises a user information field associated with non-primary channel access that includes respective fields for the one or more requested parameters.
Aspect 143: A method for wireless communication at a second wireless communication device, comprising: switching operation of the second wireless communication device from a first channel to a second channel in response to detection of one or more PPDUs via the first channel, the second wireless communication device being associated with a first BSS, the one or more PPDUs being associated with a second BSS different than the first BSS; transmitting, via the second channel and after the operation of the second wireless communication device is switched from the first channel to the second channel, a frame indicating one or more requested parameters for communication via the second channel.
Aspect 144: The method of aspect 143, further comprising: receiving, while operating via the second channel, a response frame from a first wireless communication device, wherein the response frame is received in accordance with the one or more requested parameters; and transmitting at least one PPDU via the second channel to the first wireless communication device in accordance with the one or more requested parameters.
Aspect 145: The method of any of aspects 143-144, wherein the one or more requested parameters comprise at least one of a requested TXOP duration or a bandwidth parameter.
Aspect 146: The method of any of aspects 143-145, wherein the frame comprises an initial control frame transmitted via the second channel.
Aspect 147: The method of any of aspects 143-146, wherein the frame comprises a user information field associated with non-primary channel access that includes respective fields for the one or more requested parameters.
Aspect 148: A method for wireless communication at a first wireless communication device, comprising: switching operation of the first wireless communication device from a first channel to a second channel in response to detection of one or more PPDUs via the first channel, the first wireless communication device being associated with a first BSS, the one or more PPDUs being associated with a second BSS different than the first BSS; and transmitting, via the second channel and to a second wireless communication device is switched from the first channel to the second channel, a frame indicating one or more requested parameters for communication via the second channel; receiving, via the second channel and from the second wireless communication device, a response frame indicating one or more allowed parameters for communication via the second channel; and transmitting one or more frames to the second wireless communication device in accordance with the one or more allowed parameters.
Aspect 149: The method of aspect 148, further comprising: modifying at least one of a communication bandwidth or a TXOP duration for transmitting the one or more frames in accordance with the one or more allowed parameters.
Aspect 150: The method of any of aspects 148-149, wherein the one or more allowed parameters comprise at least one of an allowed TXOP duration or an allowed bandwidth parameter.
Aspect 151: The method of aspect 150, wherein the allowed TXOP duration comprises a threshold duration in accordance with a first comparison between a requested TXOP duration of the one or more requested parameters and a duration associated with at least one PPDU detected via the first channel by the second wireless communication device, and the allowed bandwidth parameter comprises a threshold bandwidth in accordance with a second comparison between a requested bandwidth parameter of the one or more requested parameters and an available bandwidth of the second channel for the second wireless communication device.
Aspect 152: The method of any of aspects 148-151, wherein the frame comprises a ICF that includes a user information field (for example, an NPCA special user information field, a user information field associated with non-primary channel access) that includes respective fields for the one or more requested parameters.
Aspect 153: The method of any of aspects 148-152, wherein the response frame comprises a multi-station BA frame that includes a bitmap indicating the one or more allowed parameters.
Aspect 154: A method for wireless communication at a second wireless communication device, comprising: switching operation of the second wireless communication device from a first channel to a second channel in response to detection of one or more PPDUs via the first channel, the second wireless communication device being associated with a first BSS, the one or more PPDUs being associated with a second BSS different than the first BSS; and receiving, via the second channel and from a first wireless communication device, a frame indicating one or more requested parameters for communication via the second channel; transmitting, via the second channel and to the first wireless communication device, a response frame indicating one or more allowed parameters for communication via the second channel; and receiving one or more frames to the second wireless communication device in accordance with the one or more allowed parameters.
Aspect 155: The method of aspect 154, wherein the one or more allowed parameters are in accordance with the one or more PPDUs detected via the first channel by the second wireless communication device.
Aspect 156: The method of any of aspects 154-155, wherein the one or more allowed parameters comprise at least one of an allowed TXOP duration or an allowed bandwidth parameter.
Aspect 157: The method of aspect 156, wherein the allowed TXOP duration comprises a threshold duration in accordance with a first comparison between a requested TXOP duration of the one or more requested parameters and a duration associated with at least one PPDU detected via the first channel by the second wireless communication device, and the allowed bandwidth parameter comprises a threshold bandwidth in accordance with a second comparison between a requested bandwidth parameter of the one or more requested parameters and an available bandwidth of the second channel for the second wireless communication device.
Aspect 158: The method of any of aspects 154-157, wherein the frame comprises a ICF that includes a user information field (for example, an NPCA special user information field, a user information field associated with non-primary channel access) that includes respective fields for the one or more requested parameters.
Aspect 159: The method of any of aspects 154-158, wherein the response frame comprises a multi-station BA frame that includes a bitmap indicating the one or more allowed parameters.
Aspect 160: A first wireless communication device for wireless communication, comprising one or more memories storing processor-executable code, and one or more processors coupled with the one or more memories and individually or collectively operable to execute the code to cause the first wireless communication device to perform a method of any of aspects 110-122.
Aspect 161: A first wireless communication device for wireless communication, comprising at least one means for performing a method of any of aspects 110-122.
Aspect 162: A non-transitory computer-readable medium storing code for wireless communication, the code comprising instructions executable by one or more processors to perform a method of any of aspects 110-122.
Aspect 163: A second wireless communication device for wireless communication, comprising one or more memories storing processor-executable code, and one or more processors coupled with the one or more memories and individually or collectively operable to execute the code to cause the second wireless communication device to perform a method of any of aspects 123-133.
Aspect 164: A second wireless communication device for wireless communication, comprising at least one means for performing a method of any of aspects 123-133.
Aspect 165: A non-transitory computer-readable medium storing code for wireless communication, the code comprising instructions executable by one or more processors to perform a method of any of aspects 123-133.
Aspect 166: A first wireless communication device for wireless communication, comprising one or more memories storing processor-executable code, and one or more processors coupled with the one or more memories and individually or collectively operable to execute the code to cause the first wireless communication device to perform a method of any of aspects 134-142.
Aspect 167: A first wireless communication device for wireless communication, comprising at least one means for performing a method of any of aspects 134-142.
Aspect 168: A non-transitory computer-readable medium storing code for wireless communication, the code comprising instructions executable by one or more processors to perform a method of any of aspects 134-142.
Aspect 169: A second wireless communication device for wireless communication, comprising one or more memories storing processor-executable code, and one or more processors coupled with the one or more memories and individually or collectively operable to execute the code to cause the second wireless communication device to perform a method of any of aspects 143-147.
Aspect 170: A second wireless communication device for wireless communication, comprising at least one means for performing a method of any of aspects 143-147.
Aspect 171: A non-transitory computer-readable medium storing code for wireless communication, the code comprising instructions executable by one or more processors to perform a method of any of aspects 143-147.
Aspect 172: A first wireless communication device for wireless communication, comprising one or more memories storing processor-executable code, and one or more processors coupled with the one or more memories and individually or collectively operable to execute the code to cause the first wireless communication device to perform a method of any of aspects 148-153.
Aspect 173: A first wireless communication device for wireless communication, comprising at least one means for performing a method of any of aspects 148-153.
Aspect 174: A non-transitory computer-readable medium storing code for wireless communication, the code comprising instructions executable by one or more processors to perform a method of any of aspects 148-153.
Aspect 175: A second wireless communication device for wireless communication, comprising one or more memories storing processor-executable code, and one or more processors coupled with the one or more memories and individually or collectively operable to execute the code to cause the second wireless communication device to perform a method of any of aspects 154-159.
Aspect 176: A second wireless communication device for wireless communication, comprising at least one means for performing a method of any of aspects 154-159.
Aspect 177: A non-transitory computer-readable medium storing code for wireless communication, the code comprising instructions executable by one or more processors to perform a method of any of aspects 154-159.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset”refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

What is claimed is:

1. A first wireless communication device, comprising:
a processing system that includes processor circuitry and memory circuitry that stores code, the processing system configured to cause the first wireless communication device to:
switch operation of the first wireless communication device from a first channel to a second channel in response to detection of one or more physical layer (PHY) protocol data units (PPDUs) via the first channel, the first wireless communication device being associated with a first basic service set, the one or more PPDUs being associated with a second basic service set different than the first basic service set; and
receive, via the second channel and from a second wireless communication device, a frame indicating one or more requested parameters for communication via the second channel.

2. The first wireless communication device of claim 1, wherein the processing system is further configured to cause the first wireless communication device to determine whether the one or more requested parameters are accepted in accordance with a comparison between the one or more requested parameters and one or more parameters associated with the first channel or associated with communication via the second channel, or both.

3. The first wireless communication device of claim 2, wherein the processing system is further configured to cause the first wireless communication device to transmit, while operating via the second channel, a response frame to the second wireless communication device, wherein the response frame is transmitted in accordance with the one or more requested parameters being accepted by the first wireless communication device.

4. The first wireless communication device of claim 2, wherein the processing system is further configured to cause the first wireless communication device to refrain from transmitting a response frame to the second wireless communication device in accordance with at least one of the one or more requested parameters failing acceptance by the first wireless communication device.

5. The first wireless communication device of claim 2, wherein the one or more requested parameters are accepted in accordance with a first duration parameter of the one or more requested parameters being less than or equal to a second duration parameter of the one or more parameters, or in accordance with a first bandwidth parameter of the one or more requested parameters being less than or equal to a second bandwidth parameter of the one or more parameters, or both.

6. The first wireless communication device of claim 1, wherein the one or more requested parameters comprise at least one of a requested transmission opportunity duration or a bandwidth parameter.

7. The first wireless communication device of claim 1, wherein the frame comprises an initial control frame.

8. The first wireless communication device of claim 1, wherein the one or more requested parameters correspond to requested non-primary channel access (NPCA) parameters.

9. The first wireless communication device of claim 1, wherein the frame comprises a user information field associated with non-primary channel access that includes respective fields for the one or more requested parameters.

10. A second wireless communication device, comprising:
a processing system that includes processor circuitry and memory circuitry that stores code, the processing system configured to cause the second wireless communication device to:
switch operation of the second wireless communication device from a first channel to a second channel in response to detection of one or more physical layer (PHY) protocol data units (PPDUs) via the first channel, the second wireless communication device being associated with a first basic service set, the one or more PPDUs being associated with a second basic service set different than the first basic service set; and
transmit, via the second channel and after the operation of the second wireless communication device is switched from the first channel to the second channel, a frame indicating one or more requested parameters for communication via the second channel.

11. The second wireless communication device of claim 10, wherein the processing system is further configured to cause the second wireless communication device to:
receive, while operating via the second channel, a response frame from a first wireless communication device, wherein the response frame is received in accordance with the one or more requested parameters; and
transmit at least one PPDU via the second channel to the first wireless communication device in accordance with the one or more requested parameters.

12. The second wireless communication device of claim 10, wherein the one or more requested parameters comprise at least one of a requested transmission opportunity duration or a bandwidth parameter.

13. The second wireless communication device of claim 10, wherein the frame comprises an initial control frame transmitted via the second channel.

14. The second wireless communication device of claim 10, wherein the frame comprises a user information field associated with non-primary channel access that includes respective fields for the one or more requested parameters.

15. A first wireless communication device, comprising:
a processing system that includes processor circuitry and memory circuitry that stores code, the processing system configured to cause the first wireless communication device to:
switch operation of the first wireless communication device from a first channel to a second channel in response to detection of one or more physical layer (PHY) protocol data units (PPDUs) via the first channel, the first wireless communication device being associated with a first basic service set, the one or more PPDUs being associated with a second basic service set different than the first basic service set;
transmit, via the second channel and to a second wireless communication device is switched from the first channel to the second channel, a frame indicating one or more requested parameters for communication via the second channel;
receive, via the second channel and from the second wireless communication device, a response frame indicating one or more allowed parameters for communication via the second channel; and
transmit one or more frames to the second wireless communication device in accordance with the one or more allowed parameters.

16. The first wireless communication device of claim 15, wherein the processing system is further configured to cause the first wireless communication device to modify at least one of a communication bandwidth or a transmission opportunity duration for transmitting the one or more frames in accordance with the one or more allowed parameters.

17. The first wireless communication device of claim 15, wherein the one or more allowed parameters comprise at least one of an allowed transmission opportunity duration or an allowed bandwidth parameter.

18. The first wireless communication device of claim 17, wherein:
the allowed transmission opportunity duration comprises a threshold duration in accordance with a first comparison between a requested transmission opportunity duration of the one or more requested parameters and a duration associated with at least one PPDU detected via the first channel by the second wireless communication device, and
the allowed bandwidth parameter comprises a threshold bandwidth in accordance with a second comparison between a requested bandwidth parameter of the one or more requested parameters and an available bandwidth of the second channel for the second wireless communication device.

19. The first wireless communication device of claim 15, wherein the frame comprises an initial control frame that includes a user information field associated with non-primary channel access that includes respective fields for the one or more requested parameters.

20. The first wireless communication device of claim 15, wherein the response frame comprises a multi-station block acknowledgment frame that includes a bitmap indicating the one or more allowed parameters.
